(19) United States
(12) Patent Application Publication
(10) Pub. No.: US 2002/0143655 A1
(43) Pub. Date: Oct. 3, 2002

(54) Remote ordering system for mobile commerce

(76) Inventors: Stephen Elston, Seattle, WA (US); Barry Smith, Kirkland, WA (US); David H. Edelstein, Seattle, WA (US); Carman R. Wenkoff, Kirkland, WA (US); Kevin G. Brown, Seattle, WA (US); Brandon W. Lonac, Seattle, WA (US); Jeffrey S. Nemecek, Bothell, WA (US); Eugene Brownell, Redmond, WA (US); Brent Bolleman, Redmond, WA (US); Jason Strashek, Kirkland, WA (US)

Correspondence Address: Carman Wenkoff, ONTAIN CORPORATION, Suite C-245, 1750 - 112th Avenue NE, Bellevue, WA, 98004, US

(21) Appl. No.: 10/082,057

(22) Filed: Feb. 26, 2002

Related U.S. Application Data
(60) Provisional application No. 60/280,105, filed on Apr. 2, 2001.
(60) Provisional application No. 60/281,287, filed on Apr. 3, 2001.

(51) Int. Cl. G06F 17/60

(52) U.S. Cl. 705/26

(57) ABSTRACT

A remote ordering system particularly suited to mobile customers placing remote orders with any one of a group of affiliated merchants for pick up by the customer at a specific merchant location. The system includes a database or store information directory that contains information characterizing order-processing features for each location. The information is preferably organized according to a schema corresponding to the organizational structure of the group of merchants. The information may include order fulfillment capability, menus, prices, payment features, taxes, security protocols and system administration privileges specific to each merchant location or sub-groups of merchant locations. The system of the invention allows the remote ordering system to effectively pre-clear, pre-process and pre-pay remote orders and to effect post-sale settlement and reporting according to guidelines applicable to each specific location in the merchant group, leaving the specific location to complete only the actual order fulfillment.

### CROSS-REFERENCE TO RELATED APPLICATIONS

This application claims the benefit under 35 U.S.C. 119(e) of earlier filed U.S. Provisional Application No. 60/280,105, filed Apr. 2, 2001 and U.S. Provisional Application No. 60/287,287, filed Apr. 30, 2001.

### FIELD OF THE INVENTION

This invention relates to electronic shopping systems. In particular the invention relates to a system enabling mobile customers to remotely place orders with any one of a group of affiliated merchants for pick up by the customer at a specific merchant location.

### BACKGROUND OF THE INVENTION

The components and subsystems required to implement electronic commerce systems are relatively well known, particularly in the field of Internet-based electronic commerce. An example of such prior art systems is disclosed in Chelliah et al., U.S. Pat. No. 5,710,887.

However, most of such Internet-based electronic commerce relies on the concept of the virtual store or electronic storefront rather than specific physical store locations to service the customer. Typically, the customer places an order through the electronic storefront, effects payment and the product or service is eventually shipped to the customer, without the customer being concerned with the physical location from which the product or service is supplied.

In at least one case, grocery orders may be placed through a browser for either delivery or pick up at a physical store location. Albertson's Inc. provides a web site (www.albertsons.com) wherein the customer identifies a geographic region (e.g. Seattle or San Diego) in which the customer is located. The order is fulfilled from a central warehouse in that region, although the customer may specify that the order is to be delivered to a physical store location for pick up by the customer.

Unlike such systems, the present invention relates specifically to mobile commerce and in particular to the ability of a mobile customer to place an order at a specific physical store location for both fulfillment and nearly immediate pick up by the customer at that physical location. It will be appreciated that a pick-up sales model will be of particular interest to mobile customers.

Various prior art systems have addressed specific aspects of product ordering for pick up by mobile customers.

Djupsjobacka et al. PCT/IB00/01358 (WO 01/25985) discloses a method for facilitating shopping with a mobile device to obtain a plurality of goods or services from a group of merchants at the same physical location. The system produces an itinerary for the customer to shop more efficiently at that location.

Hall et al. U.S. Pat. No. 6,026,375 discloses a system for accurately scheduling the completion of a mobile customer's order to coincide with the arrival of the customer at the physical store location.

Some prior art systems locate additional facilities at the merchant's physical location to accommodate remote orders. For example, Dodson et al. PCT/US00/21943 (WO 01/13298 A2) discloses a mobile commerce platform wherein a mobile customer is provided with a menu and places an order, the vendor at a specific physical location accepts or declines the order through a merchant terminal, and the customer picks up the goods or services. A merchant terminal in accordance with the invention includes buttons for displaying a current order, a log of orders received, and for accepting a received order.

The case of affiliated groups of merchants, such as in national store chains or franchises, presents specific problems not addressed in the prior art. In such cases, it is not practical to have mobile commerce systems that are effectively separate for each physical store location. A single chain-wide mobile commerce platform would be desirable for customer convenience, to ensure consistency across the chain, and to minimize the administrative effort required by the merchant(s). However, providing a single mobile commerce platform for a chain of merchants presents its own difficulties. Chains of merchants often offer a minimum menu of products carried by all outlets in the chain, as well as regional or location specific product offerings. In addition, different entities with group of affiliated merchants may have varying levels of authority to modify features such as menus, times during which certain menu items are available, prices and promotions. A regional master franchiser may have authority to alter these features but only within its region. In addition individual franchisees may be entitled to modify their outlet offerings, but not for nationally or regionally mandated menu items, but yet may have final authority on pricing at their own location. In geographically distributed chains, varying tax and regulatory considerations may also apply. There may be more or less access to information from associated merchants depending on the types of relationships between them. For example, a chain operator may have access to detailed sales reports from company-owned stores, but may not have the right to receive the same detailed information from franchises.

It is therefore an object of the present invention to provide a complete mobile commerce system that is particularly suited to facilitating mobile commerce with groups of affiliated merchants.

It is a further object of the invention to provide such a system that is well suited to a pick up sales model for mobile customers.

It is a further object of the invention to provide a mobile commerce platform that is easily and effectively integrated with the physical merchant's existing systems, store processes and procedures.

Other objects of the invention will be appreciated by reference to the disclosure that follows.

### SUMMARY OF THE INVENTION

The invention consists of a complete remote ordering platform and method particularly suited for mobile or wireless commerce wherein a customer places an order with one physical outlet among a group of affiliated merchants for fulfillment and pick up by the customer at a specific merchant location.

The preferred embodiment of the system of the invention includes merchant and customer gateways, transaction management functionality, security management, order fulfillment capability assessment, payment systems, order delivery to a customer-selected location, and post-sale functionality including settlement, data warehousing and reporting functions, all tailored to mobile commerce with groups of affiliated merchants, such as store or restaurant chains and franchises.

In order to minimize the transaction processing burden on the local merchant's systems, the remote ordering system of the invention is capable of handling substantially all steps in the sales transaction save for actual order fulfillment, and delivers to the merchant's location a complete, paid-up order for direct fulfillment.

The ability to assess order fulfillment capability and to complete orders is achieved in part by maintaining a database or store information directory of order fulfillment capability indicia for the plurality of specific merchant locations. The directory includes a menu of product offerings, prices, times available, store hours and other such features, all organized into a schema or organizational structure that accommodates the different offering from the various affiliated merchant locations and that is synchronized to the merchants' systems. The directory information is organized according to the organization or hierarchy of the specific outlet locations in the group of affiliated merchants.

The invention includes the necessary information and capacity to calculate pricing, promotional features and taxes without requiring real-time input from the merchant systems.

The invention also comprises system administration capability which relies on a security manager to selectively authorize the setting or modification of system features and information, including menu offering, price and other features, based on the individual merchant location's status within the group of merchants and based on individual employee status at the specific merchant locations. Access to and modification of customer account information is also a function of the authorities and relationships within the group of associated merchants.

The reporting of information is also regulated by reference to the authorities and relationships within the group.

Settlement functions for both cash and promotional accounts are governed so as to also accommodate the settlement protocols within the group.

The invention provides the mobile customer with immediate response as to availability, price, payment authorization and other features of the sales transaction for approval without requiring input from the merchant location, thereby improving the speed and responsiveness of the system to the customer.

The merchant benefits from a reduced transaction processing burden in that the merchant's systems are limited to receiving a completed, confirmed and paid-up order for immediate fulfillment, as well as an effective mobile commerce system that takes into account the particular situation and requirements of the individual merchant locations and their relationship to the group of affiliated merchants.

The owner or manager of the group, and the group as a whole, benefits from a common mobile commerce platform, and consolidated reporting and settlement for the entire group of merchants.

The remote ordering system of the invention therefore significantly improves the attractiveness of remote ordering systems for both the customer and the merchant and provides a means of encouraging the expansion of mobile electronic commerce, to the benefit of both customers and merchants.

In one aspect, the invention comprises a remote ordering system for use by at least one customer in placing an order for fulfillment at one of a plurality of affiliated merchants operating a plurality of different merchant locations. One or more servers is adapted to receive and process an order that identifies a specific merchant location for fulfillment by that location, and to transmit the order to the specific merchant location for fulfillment.

In a more particular aspect of the invention, the remote ordering system comprises a database comprising information specific to each of the merchant locations. The information may be organized in a hierarchy corresponding to a hierarchy of said merchant locations within said plurality of merchant locations.

The information may be selected from the group comprising: product or service prices, order fulfillment capability criteria, payment criteria. The information may also include product or service prices, and/or order fulfillment capability criteria, such as times at which specific products are offered, and/or an identification of specific products that are not offered at a given merchant location.

According to another aspect of the invention, the remote ordering system includes information and parameters for operating the system, to enable personnel at each merchant location may modify certain of such information and parameters. A database contains information specific to each of the merchant locations identifying levels of authority for personnel of the merchant location for effecting modifications to the information or parameters.

The database may comprise information identifying levels of authority for personnel administering the servers for effecting modifications to the information or parameters.

The information and parameters that may be selectively modified may include product or service price, applicable taxes, promotions, identification of employees, times at which specific products are available, refund processing, payment information, financial information or types of reports.

The information identifying levels of authority is organized according to a schema corresponding to a schema of the merchants' locations within the chain of merchants.

In another aspect of the invention, the remote ordering system comprises:

a plurality of affiliated merchants, said merchants operating a plurality of different merchant locations;

one or more servers for receiving and processing an order from a customer, said order identifying a specific one of said merchant locations for fulfillment of said order, and for transmitting said order to said specific one of said merchant locations for fulfillment by said specific merchant location;

a database associated with said one or more servers, said database comprising information specific to each of said merchant locations, said information being organized in a hierarchy corresponding to a hierarchy of said merchant locations within said plurality of merchant locations.

In yet another of its aspects, the invention comprises a method for processing a product or service order from a wireless device for fulfillment at a specific outlet location in a chain of associated outlets. There is provided a database of products or services offered at each outlet in the chain. The database includes information identifying items as being offered by several pluralities of outlets in the chain, the characterization of the pluralities corresponding to the organizational structure of the chain. The system communicates to the wireless device a list of items available at the specific outlet location.

The database may comprise order fulfillment capability criteria referable to each of the associated outlets, including criteria such as time of day or products offered.

A method according to the invention consists of a method for processing a product or service order from a wireless device for fulfillment at a specific outlet location in a chain of associated outlets. The method comprises maintaining a database of products or services offered at each outlet in the chain. The database includes product or service availability criteria associated with the outlets according to each outlet's relationship or status in the chain, and communicating to the wireless device a list of items available at the specific outlet location.

The database may comprise order fulfillment capability criteria that is associated with each outlet according to its relationship with or status in the chain. The criteria may include such criteria as time of day or products offered at said specific outlet. The criteria are associated with each outlet according to a schema corresponding to a schema of the merchant locations in the chain.

In another aspect of the method of the invention, the database comprises security information for selectively authorizing certain aspects of the processing of an order and the security information includes criteria that may be associated with each outlet according to a schema of the outlets in the chain.

In yet another of its aspects, the invention is a method for a specific merchant outlet location in a chain of associated outlets to fulfill a product or service order from a mobile customer. The method involves communicating to a remote ordering system a plurality of criteria governing order fulfillment at the specific outlet location prior to receiving the order. The order is received and fulfilled by the specific outlet, and the outlet dispatches to the remote ordering system an acknowledgement of fulfillment of the order. According to the method, the specific outlet location does not engage in the delivery of order fulfillment capability information directly to the customer or in the processing of payment from the customer.

The foregoing statements of the features of the invention are not intended as exhaustive or limiting, the proper scope thereof being appreciated by reference to this entire disclosure and to the substance of the claims.

### BRIEF DESCRIPTION OF THE DRAWINGS

The invention will be described by reference to the preferred and alternative embodiments thereof in conjunction with the drawings in which:

FIG. 1 is an overall diagrammatic view of the system of the preferred embodiment of the invention;

FIG. 2 is a block diagram of the transaction manager and database;

FIGS. 3A, 3B, 3C, 3D, 3E and 3F are a basic order transaction flow diagram;

FIG. 4 is an order call routing and processing flow chart;

FIGS. 5A, 5B and 5C are an order transmission process flow chart;

FIGS. 6A and 6B are a stored value account funding flow chart;

FIGS. 7A and 7B are a curb/drive-up service process flow chart;

FIGS. 8A, 8B and 8C are a typical flow chart for issuing a refund through the POS system or terminal to a consumer remote order account;

FIGS. 9A and 9B are a chart of the security store structure;

FIGS. 10A, 10B, 10C, 10D and 10E are a chart of the customer account structure;

FIGS. 11A and 11B are a chart of the merchant account structure; and,

FIGS. 12A, 12B, 12C, 12D, 12E, 12F, 12G, 12H, 12I, 12J, 12K and 12L are a chart of the store information directory structure.

### DETAILED DESCRIPTION OF THE PREFERRED AND ALTERNATIVE EMBODIMENTS

The preferred embodiment of the invention is used to facilitate transactions between mobile customers wishing to place orders for fulfillment and pick up at one of several affiliated merchant locations. The mobile customer interfaces with the system of the invention, implemented through one or more servers, and places the order with the system by means of a mobile wireless device. The affiliated merchant locations of the preferred embodiment are members of a franchise network of vendor locations where speed of service is of importance, such as for example a fast food dispensing restaurant, a chain of video rental stores, a chain of convenience stores, etc.

System Overview

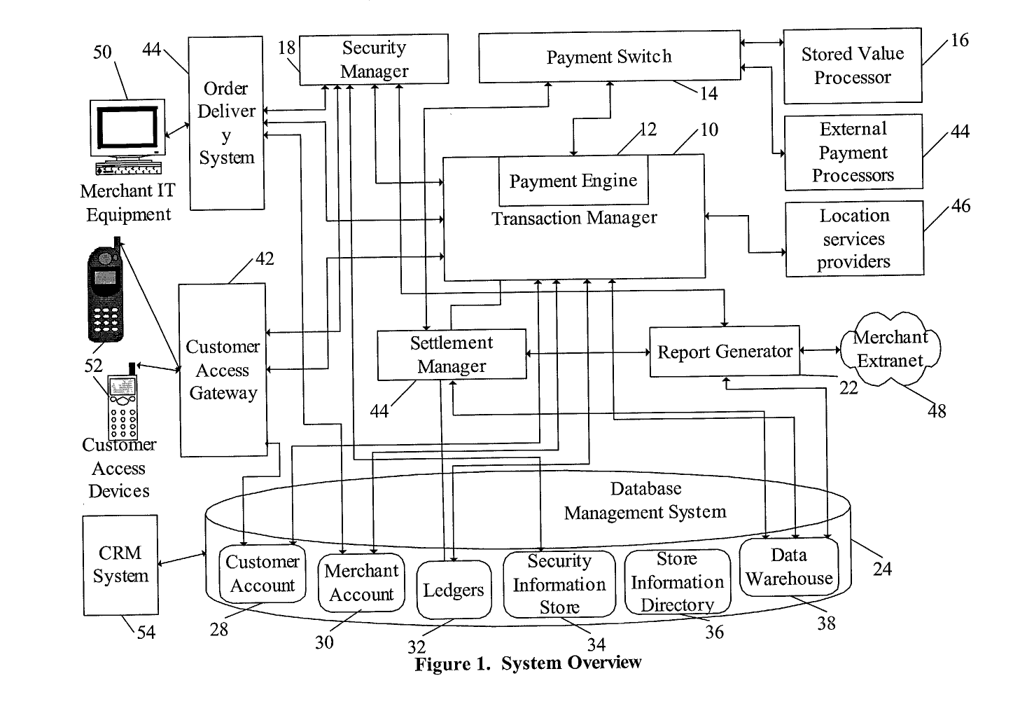

The major system components of the Remote Order (RO) system of the preferred embodiment of the invention are illustrated in FIG. 1. Interactions between the tables in the database are not shown for simplicity, but are discussed in detail elsewhere. The major system components of the preferred embodiment include:

Transaction manager 10

Payment engine 12

Payment switch 14

Stored value processor 16

Security manager 18

Settlement manager 20

Report generator 22

Database 24 and a database management system

Order delivery system 40

Customer access gateway 42

Merchant access gateway (not shown in FIG. 1)

The database 24 includes:

Customer accounts 28

Merchant accounts 30

Transaction ledgers 32

Security information store 34

Store information directory 36

A data warehouse 38

Not all of the components are necessary to the functioning of the invention. For example, a stored value processor 16 is desirable to facilitate payment, but such a payment option is not critical to the operation of the invention.

The principal components identified above are preferably housed and executed on one or more servers dedicated to the RO system of the invention and remote from the merchant store locations. As noted below, many of the components may be implemented as distributed sub-systems.

External components interfaced to the RO system include:

External payment processors 44

Location service providers 46

Merchant extranet 48

Merchant IT equipment 50

Customer access devices 52

CRM system 54.

The internal and external components identified above are described in more detail below. A summary of the interaction between these components is first presented in this section.

The database 24 of the invention includes information specific to each merchant location, and organized in a structure that reflects the organizational structure and hierarchy of the merchant organization. This allows merchant-location specific functionality to be implemented in the RO system, which in turn allows customers to place orders with any one of the group of affiliated merchants serviced by the RO system.

Each merchant location is further associated with a merchant account 30 allowing the RO system to tailor various remote ordering and post-sale processes to the rules and conditions applicable to that merchant location.

Summary of Interaction of Components

The following is an overview of the functions of the main components or sub-systems of the RO system. Each component will be discussed in more detail in the following sections of this disclosure.

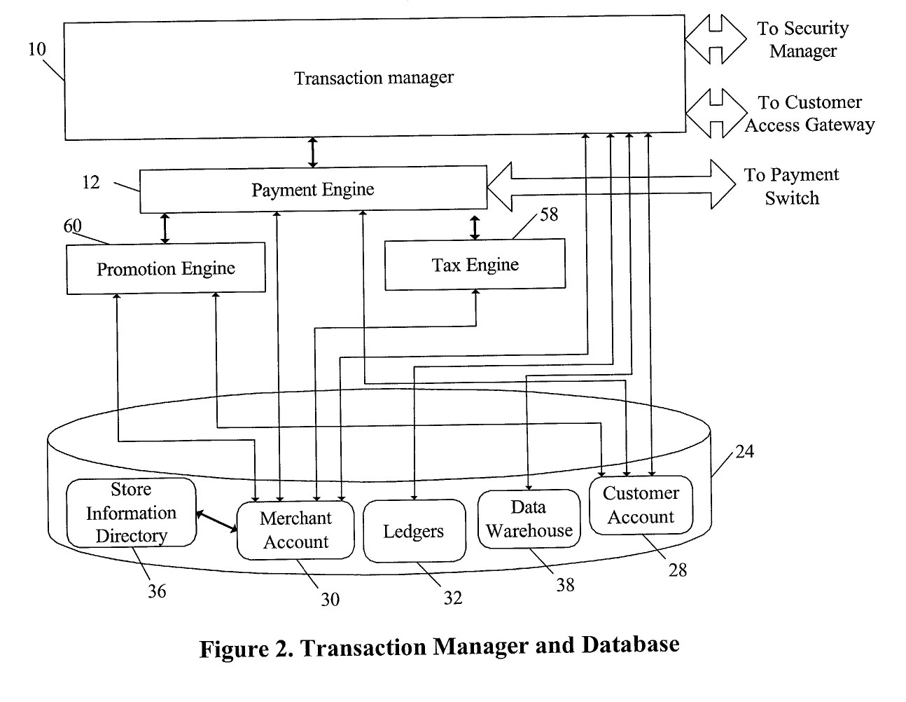

The transaction manager 10 controls the overall transaction flow and executes the required business logic. The transaction manager uses the services of the other components of the RO system, including the security manager 18, the payment engine 12, the order delivery system 40, the tax engine 58, the promotion engine 60 and other sub-systems as required, as illustrated in FIG. 2.

The payment engine 12 computes the price, promotional value, tip, fees and taxes under the control of the transaction manager 10. The payment engine receives payment authorization from either the internal stored value processor 16 or external payment processors 44 through the use of a payment switch 14.

The security manager 18 controls all access to data, reports and system services for the RO system, including access for both merchant employees and customers. The report generator 22 provides merchant personnel with reports on RO transactions from the data warehouse 38 and under the control of the security manager 18.

The transaction manager 10, payment engine 12 and security manager 18 each make use of the records maintained in the database 24. This information includes the customer and merchant account information, store information directory 36 for each store location and for groups of locations, security access and authentication information. Certain transaction records are maintained in ledgers 32 and an archive of transaction details is maintained in the data warehouse 38.

The settlement processor 20 creates financial settlement files for each store location using the service.

The order delivery system 40 transmits and confirms orders to the merchant IT equipment at each individual store location.

Customers using various types of wireless and fixed wired devices access the services of the RO system through the customer access gateway.

The CRM system 54 is used to perform customer support and relationship management functions using the records in the database, including the customer account 28 and data warehouse 38. The CRM system can be operated by a variety of entities including the RO system service provider, a financial institution or the merchants themselves.

External Components

The RO system can use one or more external payment providers. The services of these providers can include multiple payment types including credit, debit, and stored value.

One or more location service providers are used to provide store location services and location directions for customers.

The merchant employees use the merchant extranet to access reports and administer the RO system.

IT equipment at individual store locations in the retail chain is used to deliver and confirm orders though the order delivery system 40.

Customers can access the services of the RO system using a wide variety of wireless and fixed wired devices, including telephones, text messaging devices and Internet terminals.

Distributed Components

The RO system may be distributed between multiple locations and entities. Even individual components, including those shown in FIG. 1, may themselves be partitioned and distributed. For example, the customer access gateway may be partitioned between any combination of telecommunications carriers and Internet Service Providers (ISPs). In another example, the security manager 18 may be under the control of and reside within a number of entities such as telecom carriers, ISPs and merchant or third party data centers. The database 24 may also be distributed such that different data tables (customer account 28, merchant account 30, store information directory 36) are under the control of various entities supporting the remote ordering service, such as ISPs, telecommunication carriers, banks, etc. In some cases, it might also be desirable to have, for example a directory of product offerings, that resides on some combination of merchant IT systems 50 at individual stores, centralized merchant data centers and the RO system service contractor.

Remote Order Transaction Flow

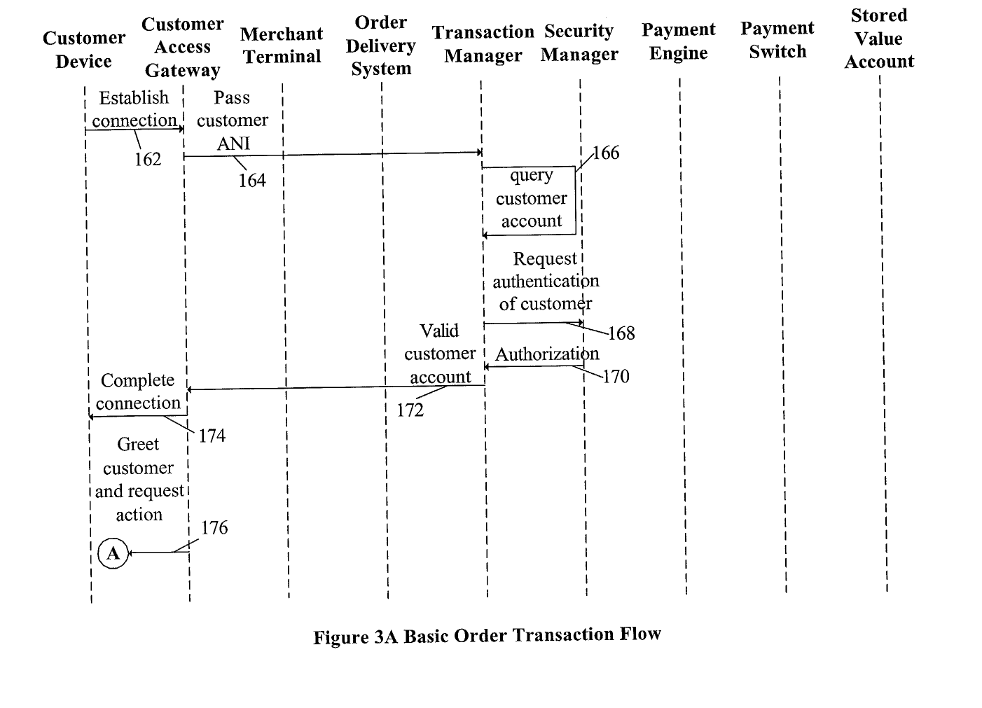

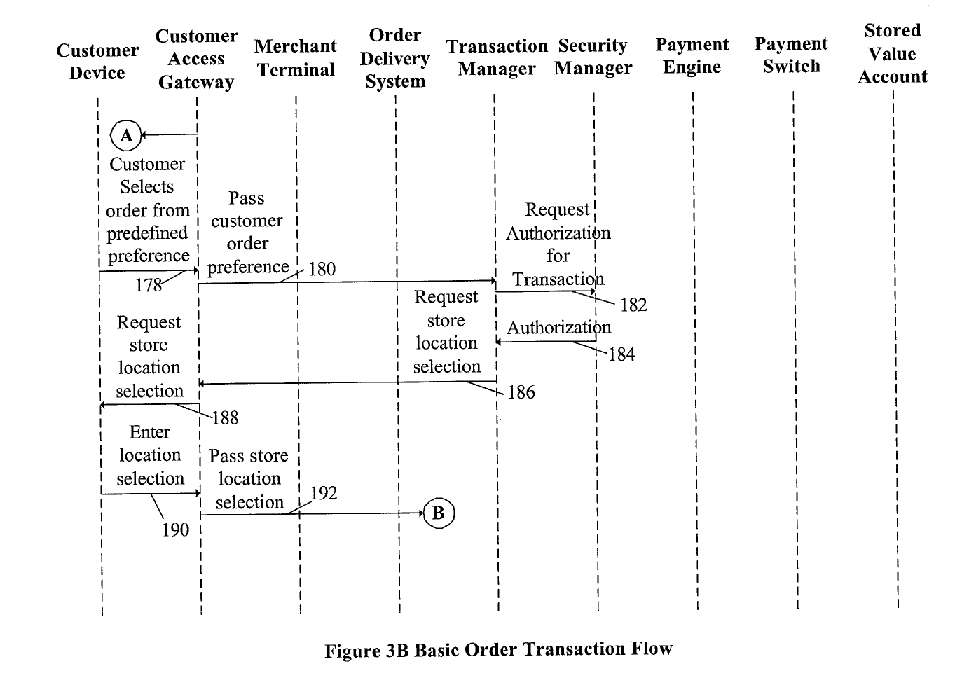

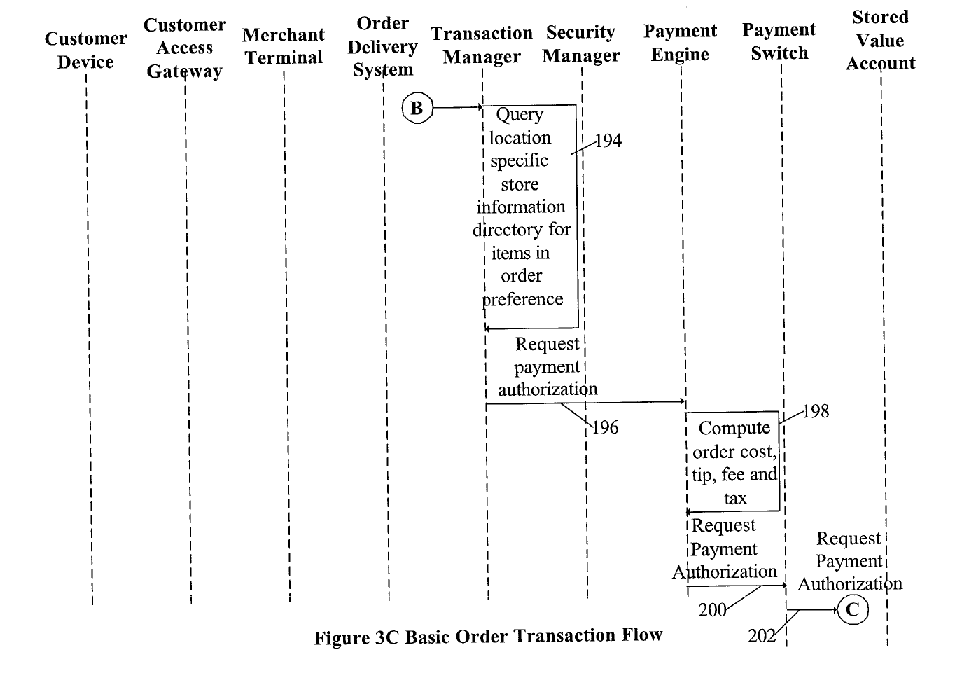

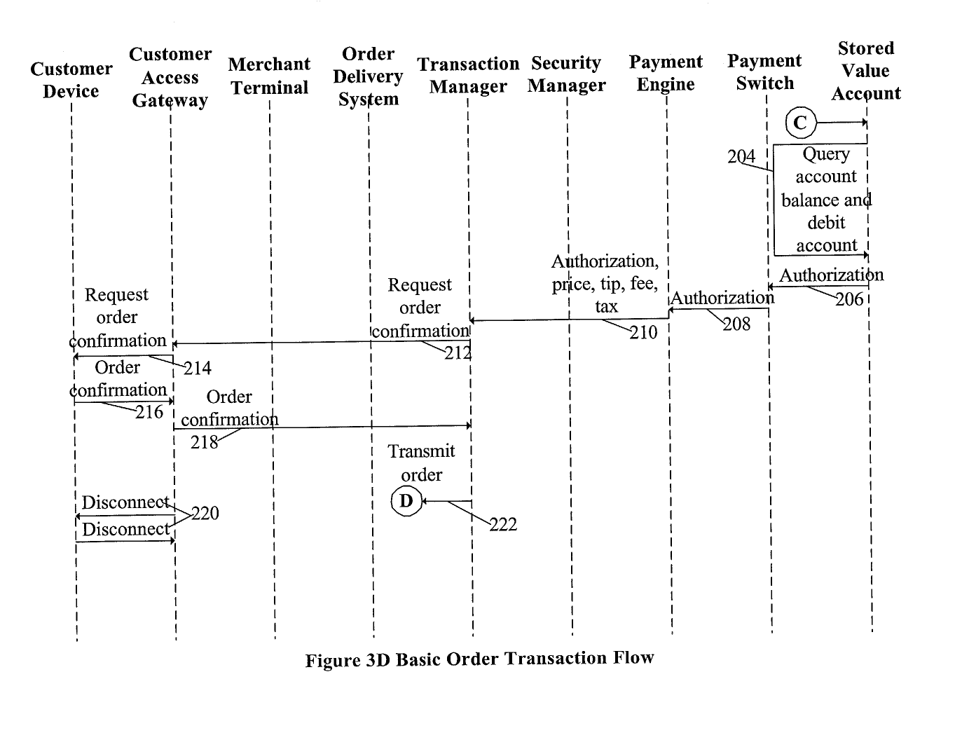

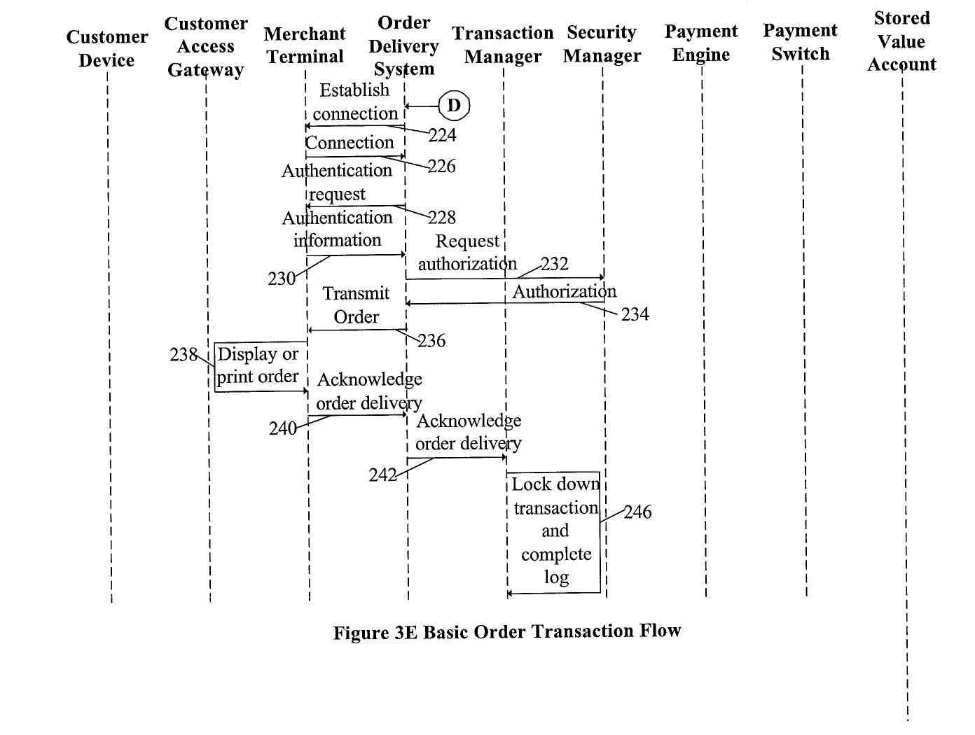

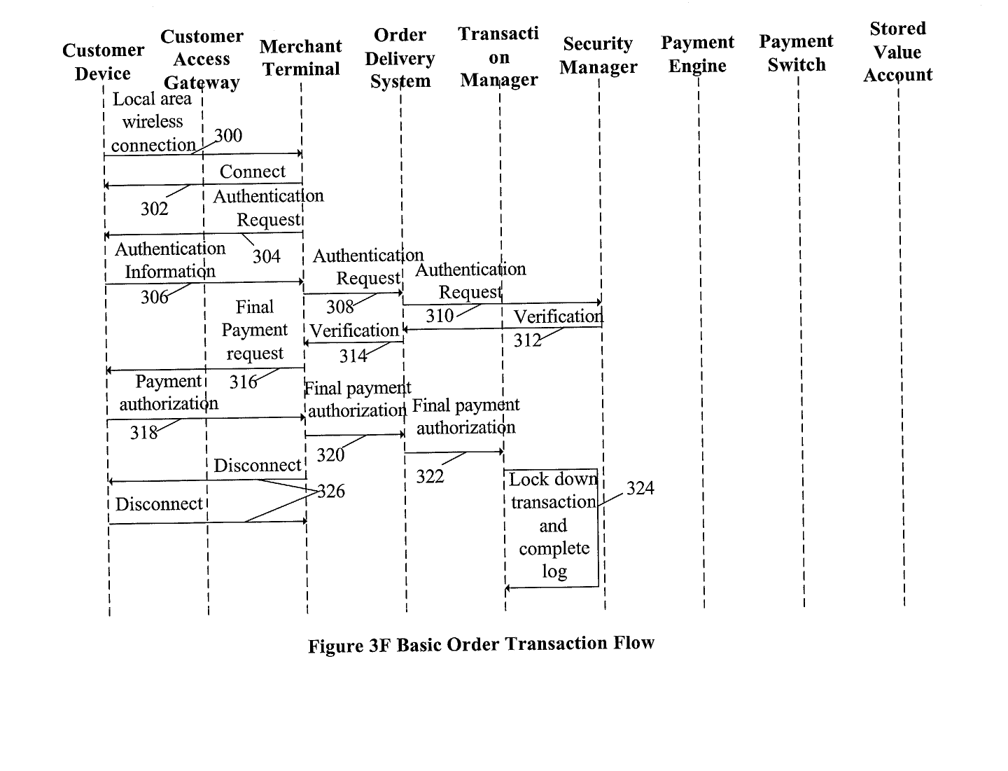

The basic flow of an order and payment transaction is illustrated in FIGS. 3A, 3B, 3C, 3D, 3E and 3F. The process flow shown assumes that the customer uses a telephone as a connection device and pays using a stored value account (SSVA). It will be obvious to those skilled in the art that the same basic process flow would be used regardless of the connection device (telephone, Internet, SMS, etc.) used by the customer or regardless of whether payment is made using an SSVA or an externally managed payment account (with appropriate modifications). It will be appreciated that the order of the steps in this process flow may be varied and some steps might be omitted in certain cases.

Establishing the Connection

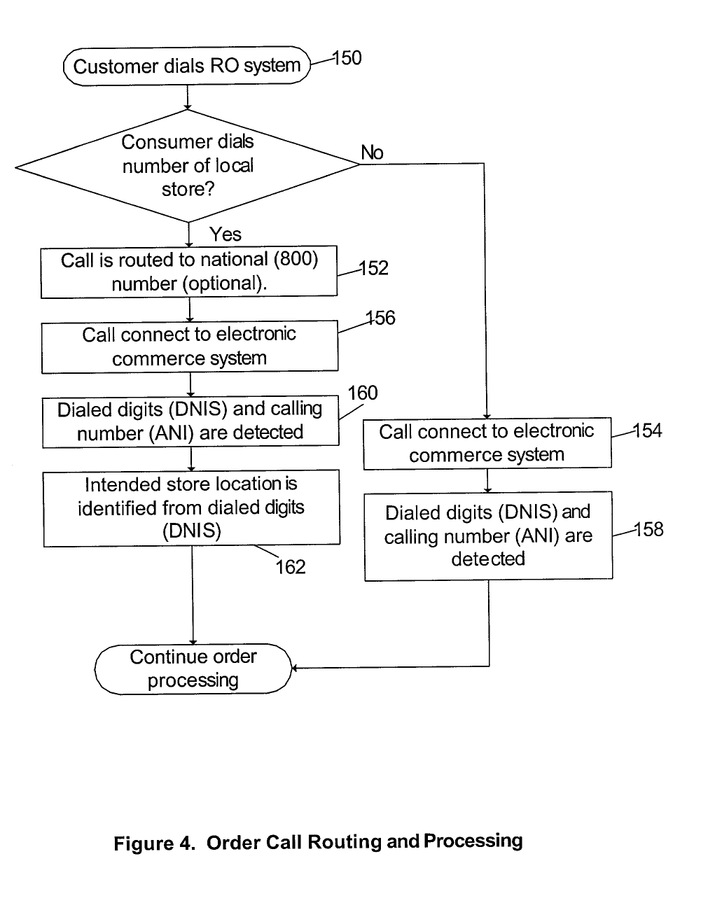

The process of connecting a customer call to the RO system (162) is shown in greater detail in FIG. 4. The customer initiates the transaction by dialing the number for the RO system (150). A customer can dial either a national, presumably using a toll free or 800 number (154), or a local number and the call is then rerouted to a national number used to receive calls for the RO system (152). In either case, the telecommunications carrier routes the call to the RO system. The customer access gateway receives the Dialed Number Indication System (DNIS) information and the Automatic Number Identification (ANI) information from the telecom carrier (160, 158). If a local number has been dialed, the dialed digits (DNIS) are used to determine the store location from which the customer wishes to order (162). This capability is used in the case where established locations with established telephone numbers, known to regular customers, are being migrated to the electronic remote ordering process. Established customers can continue to use the local number they are familiar with to reach their store of choice. It will be appreciated that the order of steps in the process flow may be varied or some steps may be omitted in certain cases.

Referring again to FIG. 3A, once the call has been connected the customer access gateway 42 passes the ANI (164) to the transaction manager 10, which queries the customer's account (166). The transaction manager 10 queries the security manager 18 to determine if the connection can proceed (168). The security manager 18, passes the result back (170) to the transaction manager 10, which allows the customer access gateway to complete the connection (172).

In an alternative embodiment, the customer access gateway 42 connects any call with a valid account associated with an ANI pointing to a valid customer account. In this case, the transaction manager 10 makes this determination and passes the authorization to the security manager, without the involvement of the security manager 18. The security manager would only be queried for authorization once a transaction is selected by the customer.

It will be understood by those skilled in the art that other methods of determining number dialed by the customer and customer telephone number, referred to in this section and throughout this document, can be employed as a substitute to DNIS and ANI without any change in the overall result. Alternative methods can be advantageous depending on the telecom carrier interface used. For example, the Calling Party Number and the Called Party Number from the Integrated Digital Services Network (ISDN) User Part (ISDN User Part or ISUP) of Signaling System 7 (SS7) can be used for as a high reliability alternative to receiving ANI and DNIS. In this embodiment, the customer access gateway would have connections allowing it to query Signaling Control Points (SCP), or other appropriate node, to retrieve this information. Further, the customer access gateway is connected to Signal Switching Points (SSP), or other appropriate node, allowing the gateway to setup and tear down calls, as provided for in the SS7 ISUP protocols, and saving the operator of the RO system telecommunications fees.

Ordering

The customer access gateway 42 completes (174) the connection, greets the customer and requests an action (176). In this example, the customer selects (178) an order from a pre-selected preference maintained by the RO server or a list of previous orders by number.

In the alternative to ordering from a pre-set preference, the customer might use the Interactive Voice Response (IVR) and Automatic Speech Recognition (ASR) capabilities of the gateway to select an order ad hoc. Menu items will be selected from the store information directory 36 specific to the time and location of interest and preferably presented in a hierarchical manner organized by product groups and sub-groups. Special instructions can be added to the order as short text strings.

The customer access gateway 42, passes the customer order preference (180) to the transaction manager 10. The transaction manager requests (182) and receives (184) authorization from the security manager 18 for the purchase. In alternative embodiments, the authorization from the security manager can be requested and received when the customer first establishes a connection to the RO system or during the payment processing, or at several steps in the RO process.

The system allows a customer to create an order by selecting and concatenating multiple ordering preferences or previous orders in one session. The algorithm to compute transaction fees can treat this order as a single order or multiple orders depending on merchant and service provider policy.

Under control (186) of the transaction manager 10, the customer access gateway 42 then requests (188) that the customer select a location if it has not already been determined by the dialed digits, or is not included in the customer's preference. The customer can select (190) the location from a preface list, or from a list of choices presented by the RO system. The list of location choices can be derived using a number of methods including:

1. Knowledge of the customer's location provided by the wireless carrier or another location service provider,

2. Determining the customer's street address through use of a reverse telephone number look up database,

3. By requesting and receiving the street address, intersection or town name of the customer's location, and

4. A list of locations at which the customer has previously ordered, presented in order of frequency of use.

Optionally, once the order and location have been selected, the customer is given the option to select a time for fulfillment of the order (this can be included in an order preference). This time can be a delay from the time the order is placed, or may be a specified time and date. The RO system holds delayed orders and transmits them as required (based on service times). Alternatively, delayed orders can be held in the order terminal or POS system at the store.

Once the location is determined and passed (192) to the transaction manager 10, the transaction manager tests (194) the store information directory 36 to verify that the items order are available at that specific location at the time desired, the availability of network and store IT equipment to process the order (checking the availability flags for that location in the store information directory) and possibly an inventory list to ensure that the items in the order (or order preference) are available at the location chosen and at the time chosen. In an alternative embodiment, the location can be chosen before the order choices are presented to ensure the order can be fulfilled at the location chosen.

Payment Processing

Once the order and location are known, the transaction manager 10 requests payment authorization (196) from the payment engine 12. The payment engine determines the price of each item in the order, by referring to the prices in the store information directory 36 for each item for the specific store location chosen. Applicable total cost of goods and services, along with service fees and tip are computed and added to the order price (198). Tips can be preset by the customer either as a fixed amount or a percentage of the order value. Likewise, transaction fees can be a fixed amount, a percentage of the order value or a combination of both.

The payment engine 12 presents the order and payment information to the promotion engine 60. The promotion engine tests promotional rules, for the products ordered, and determines which product promotions have precedence for the order. The promotional engine also tests the customer's promotional purses that are maintained by the RO system in the customer account 28 to determine if any of the value stored can be applied to the order, and if so the promotional account is debited and the order price discounted. The promotion engine also credits earned value (i.e. loyalty or bonus points) to the appropriate customer promotional stored value purse. Applicable discounts and promotional value are passed back to the payment engine 12 that applies them to the order price.

Once the total cost of the order, including items that are offered at no cost as part of a promotion, has been computed, the payment engine 12 passes this information to the tax engine 58. The tax engine looks up the tax codes for each priced item in the store information directory 36. The tax code rules are applied and the total tax is computed and passed back to the payment engine 12.

Once the total price, tip, fee and tax have been computed the payment engine 12 requests authorization (200) from either the stored value processor 16 or an external payment provider through the payment switch 14. The choice of payment instrument depends the payment types allowed by the merchant and the customer's choice. If the stored value processor 16 is used, it checks the customer's account balance (204) to determine if there are sufficient funds for the order. If there are sufficient funds, the stored value processor debits the customer's account and passes an authorization (206, 208) to the payment engine 12 via the payment switch 14. Alternatively, if and external payment provider is to be used, the payment engine requests and receives an authorization through the payment switch 14. In either case, the payment engine sends the authorization (210) to the transaction manager 10.

Once the payment engine 12 receives the payment authorization it logs the payment transaction into the merchant account 30, the customer account 28 and makes entries in the ledgers 32. These records are used to compute the net settlement into the merchant's Demand Deposit Account (DDA).

Order Confirmation

Once the transaction manager 10 determines that the items ordered at the location requested are available at the desired time and that the payment has been authorized by the payment engine 12, the transaction manager requests confirmation (212, 214) of the order to the customer, via the customer access gateway 42. The confirmation message may not only verify the goods or services ordered, but just as importantly, inform the customer of the final price and verify that the location selected is the intended one. In addition, the RO system may give the customers a code word or number to identify themselves at order fulfillment time. Once the customer confirms the order (216, 218) the transaction manager 10 will initiate the transmission of the order (222 to the desired store location. Customer confirmation can be as simple as hanging up the telephone or may require the customer to enter or acknowledge a confirmation code. If the customer does not acknowledge the order for any reason, the entire transaction is canceled and rolled back. In any event the customer disconnects (220) from the customer access gateway following order confirmation.

The transaction manager 10 checks for duplicate orders during the confirmation process. In a basic verification method, the transaction manager checks that the customer did not place an identical order within a certain period of time (typically 5 min) for the same items. If this is the case, the transaction manager instructs the customer access gateway to query the customer if they really intend a second identical order. This verification process is used to prevent inadvertent duplication in the case of the connection between the customer access gateway and the customer being prematurely terminated. Premature termination of a connection is common in wireless networks and Internet Connections.

Order Transmission

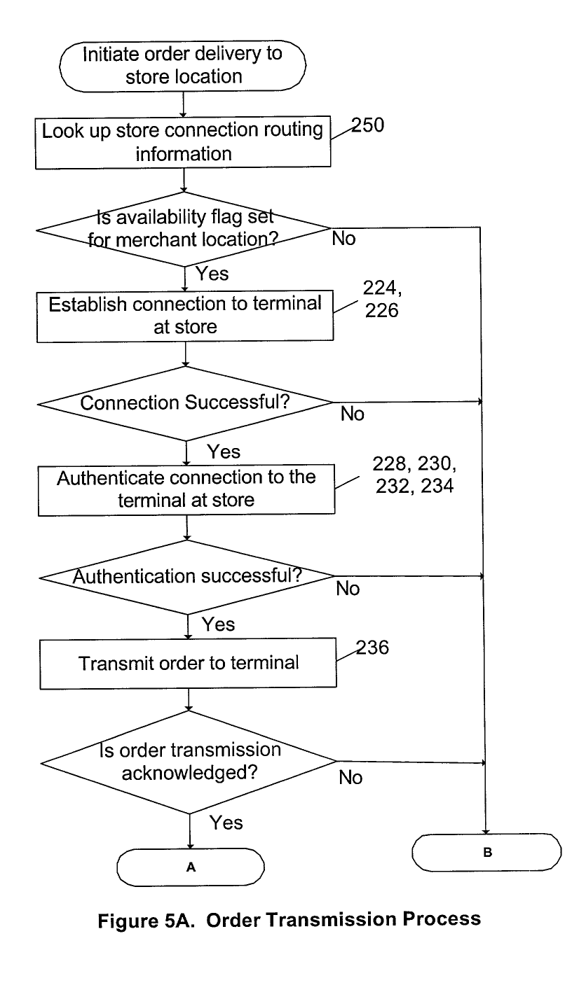

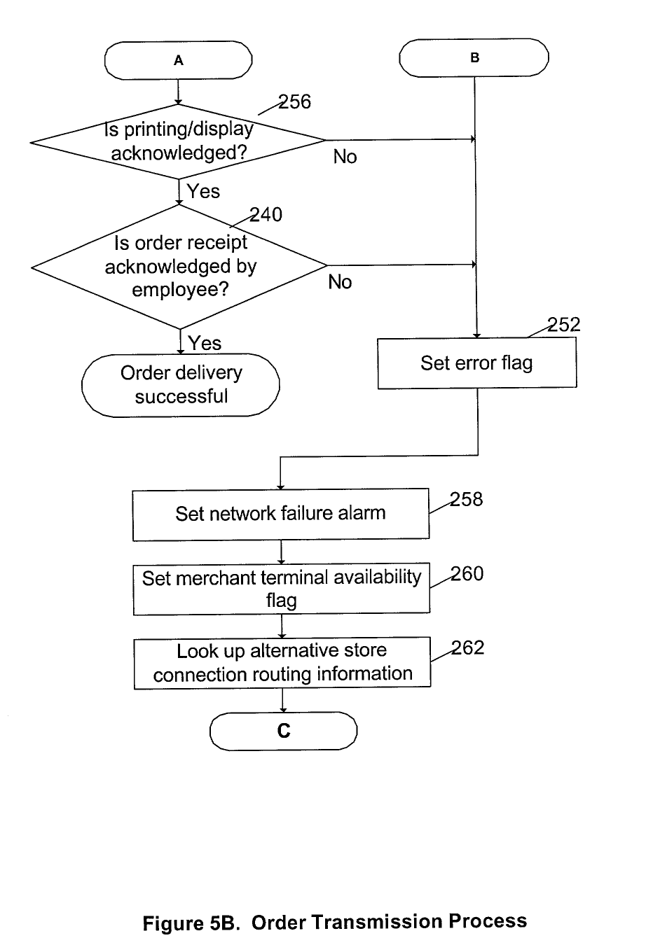

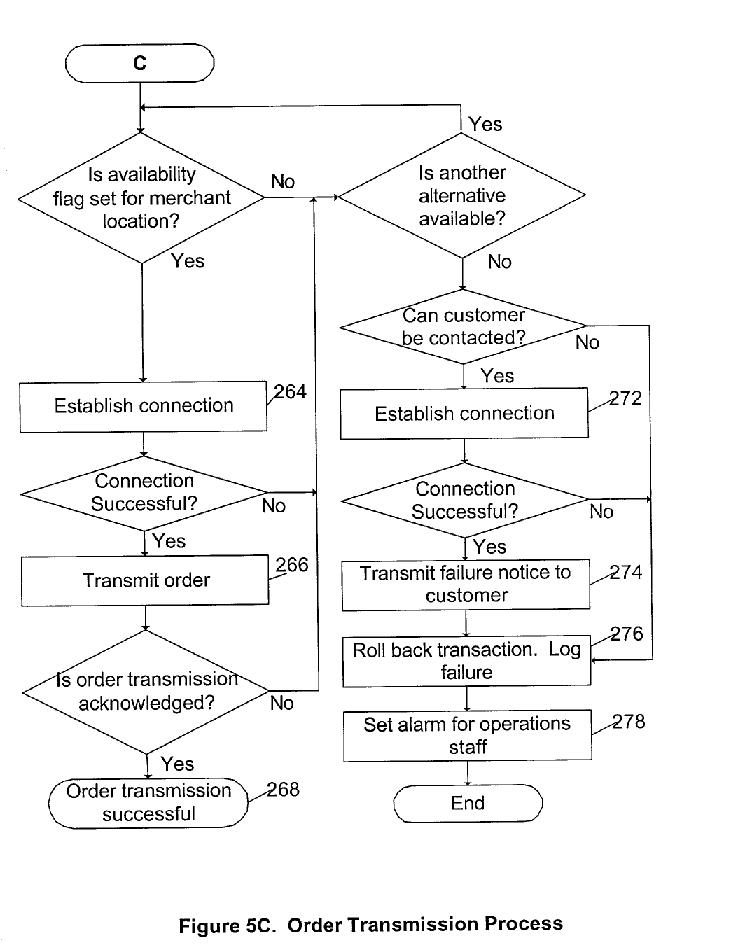

Once the customer has confirmed the order, the transaction manager 10 initiates the transmission of the order to the store (222) through the order delivery system 40, which connects to the merchant terminal 50 (224, 226). A flow chart showing more detail of this process is shown in FIGS. 5A, 5B and 5C. It will be understood by those skilled in the art that depending on the type of terminal or POS equipment used, the network options selected, and merchant processes and procedures, not every step shown will be required and the order of the steps shown will be different. It should also be understood that any type of suitable device can be used for the terminal at the store location including a payment terminal, the store's POS system, or a dedicated computing device.

The order delivery system 40 looks up (250) the routing, network characteristics and merchant terminal type in the routing table (generally associated with the store information directory 36). The order delivery system 40 then checks the system availability flag for that order delivery path, establishes a connection 224, 226) to the terminal and authenticates the connection. The order delivery system requests authentication information (228) from the merchant terminal 50. The merchant terminal returns the authentication information (230) to the order delivery system which requests authorization (232) from the security manager 18. If the authorization information can be validated the security manager returns the authorization (234) to the order delivery system. It will be understood that is many cases, a continuously available connection will be available which will only need to be established and authenticated periodically.

The terminal used at the merchant store location to receive orders from the RO system may also be used for other functions, particularly payments. In this case, the terminal or the line (especially if a demand dial connection is used) may be busy at the time the RO system attempt to transmit the order. The RO system will wait a period of time and then attempt to retransmit the order. However in the preferred embodiment, payment is effected without interaction with the merchant systems.

Once a connection has been established and authenticated, the order delivery system 40 transmits the order (236) to the terminal 50, which acknowledges the transmission back to the order delivery system (238). The terminal displays or prints the order (238) and acknowledges this (256) to the order delivery system. This display includes descriptions of items in the order and any special instructions included by the customer. The terminal will create an audible or visual signal to attract the attention of employees. At store locations where employees were audio headsets for communications, the alarm can sound through this audio system. The audible or visible alarm may get more intense as time goes by if the order has not been acknowledged. For example, the audible alarm gets louder and higher in pitch and the visible alarm gets brighter and blinks with an increasing frequency. The employees must acknowledge the receipt of the order within a specified time. This acknowledgement is transmitted (240, 242) back to the RO system. The terminal will print or display items in the order in the sequence used by employees to fulfill the order and using product designations familiar to the employees. The displayed or printed order will indicate how the customer wishes to receive it (walk-in, curbside, delivery, drive-though). For delivery orders, the customer's address, desired delivery time and driving instructions are displayed. As an optional security step, a merchant employee can verify a code word or number given to the customer by the RO system at the time the order was made.

If the terminal produces a printed receipt, one copy can be presented to the customer with their order and the other copy can be kept for the merchant's records (perhaps signed by the customer). One or both copies of the receipt can be printed on sticking label stock for easy attachment to the customer's order. If the printing fails or the receipt is lost or damaged, the merchant employee can retrieve the transaction from the terminal (generally by looking at a scrolling list) and instruct the terminal to reprint the receipts.

Depending on the merchant's rules and procedures the employee may be required to acknowledge the fulfillment of the order through the terminal. The employee's identity may be tracked in this process to provide data on response times. The employee can enter an identification code when acknowledging the, receipt of the order and again when the order has been fulfilled. In one embodiment the employee enters an identification code by swiping a magnetic card or smart card containing their identity information. Information on order fulfillment time is transmitted from the terminal to the RO system for logging and reporting. If a demand or dial connection is being used, this timing information can be saved in the terminal until there is another connection (another order or a reporting event). In an alternative embodiment (not shown on the flow chart), the real-time transmission of the fulfillment time (or lack thereof is used to determine if RO system needs to take action to ensure order transmission and fulfillment.

Acknowledgement (before or after fulfillment) of the order by an employee causes the RO system to lock down the entire transaction (246). In alternative embodiments, the transaction is locked down upon successful transmission or closing of an open payment authorization.

During the normal order delivery process a number of check steps are taken to trap and process errors. At each of these steps, if a failure occurs the order delivery system 40 sets error flags (252) and initiates an alternative order delivery process (shown in FIG. 5C) if one is available. The error flags are used to indicate to the order delivery system that the remote order service is not available via that delivery path. Further, setting the error flag sets alarms for operations staff to take corrective action. Once the problem has been corrected, the error flag is reset.

Referring to FIGS. 5B and 5C, if an order transmission fails for any reason, the order delivery system 40 will attempt to transmit the order by an alternative path. The order delivery system will set one or more network failure alarms (258) to alert operator personnel of the problem. At the same time the order delivery system sets the merchant terminal availability flag (260) to the unavailable state.

One or more alternative paths can be employed and can include fax, one-way or two-way pager, telephone call to the store, or email or instant message. These possibilities are looked up (262) in the store information directory 36. The process followed for order delivery via an alternative path is essentially the same as that used by a primary path. The exact steps taken depend on the capabilities of the alternative network and device employed at the store. The order delivery system establishes a connection (264) by the alternate path and will attach a message to the order transmission (266) indicating that there is a problem and suggesting one or more corrective actions if the error appears to be at the store. If the transmission is not acknowledged for any reason the order delivery system will attempt to determine the cause and look to see if there is yet another alternative delivery path. Errors can occur in the order delivery system, the network or at the store. If an alternate delivery path is available store personnel can be alerted of errors at the store. Examples of store errors include:

1. Telephone line or network disconnected,

2. Terminal turned off or power disconnected,

3. Printer out of paper or jammed, and

4. No acknowledgement of the order by an employee.

If all available alternate delivery paths are exhausted the RO system attempts to contact the customer (272) through the customer access gateway 42 and inform them that the order delivery failed (274). In the event of an order delivery failure, the RO system rolls back (276) the transaction and sets an alarm for operations staff (278) to take corrective action.

Alternative Remote Order Process Flows

Depending on circumstances and merchant business rules the RO system supports a large number of alternative and optional processes. These processes are described in this section.

In Store Ordering

Customers can take advantage of “remote” ordering capability while they are in the actual store location. If the employees at the store are busy helping other customers, electronic ordering from within the store can speed service for the customer. This is particularly the case in many retail operations where ability to fulfill orders may exceed the capacity of customer facing staff to take orders and payments.

Once in a store the customer can order ad hoc or from stored preferences or previous orders using a wireless Internet device or telephone, just as they would from a remote location. If so equipped, the wireless Internet device or telephone can optionally connect to a local area wireless base-station at the store location, using this alternative path to connect to the RO system. Alternatively, the customer can use a terminal or kiosk to connect to their account and order, just as they would with any Internet connection. The customer can use an identifier or token to log into this terminal, by means of a magnetic stripe card, an RF ID device, a smart card a biometric method, or a short range wireless device (see next section).

In store product ordering information posted in the store facilitates ordering. The store ID number or other code can be posted or available on printed material to identify the store for order routing. Alternatively, a store specific URL or telephone number can be used (as has already been described). Code numbers for all or frequently ordered items can be placed on menu boards or on shelves used to hold items. This allows a customer to quickly order without reference to the store information directory 36. Alternatively orders can be placed using Universal Product Codes (UPC), which can be scanned or manually entered, and which are resolved to product orders through the store information directory.

Payment for in-store orders though the RO system can be made with any payment instrument (cash, check, credit card, debit card) accepted at the store, or using the payment accounts managed by the RO system. In the latter case, the payment authorization is transmitted with the order by the RO system, just as in the case of a remote order.

In Store Payment and Identification

In an alternative embodiment, the customers pays for their order or identifies themselves using a local area wireless connection. An example of this process, in which the customer provides a final payment authorization, is shown in FIG. 3F.

When the customer arrives at the merchant's store location they initiate a connection (300, 302) between their wireless device 52 and the merchant terminal 50. The merchant terminal then requests authentication information (304) from the wireless device, which responds with the information (306). The merchant terminal then requests authentication verification (308, 310) from the security manager 18 through the order delivery system 40. The verification of authentication (312, 314) is transmitted from the security manager to the merchant terminal through the order delivery system.

With the connection established, the merchant terminal 50 requests a final payment authorization (316) from the customer through their wireless device 52. The customer returns the authorization (318) to the merchant terminal, which passes (320, 322) it to the transaction manager 10 through the order delivery system 40. At the same time the merchant terminal disconnects (326) from the customer's wireless device. The transaction manager locks down the transaction (324) once the final authorization is received.

Stored Value Account Funding

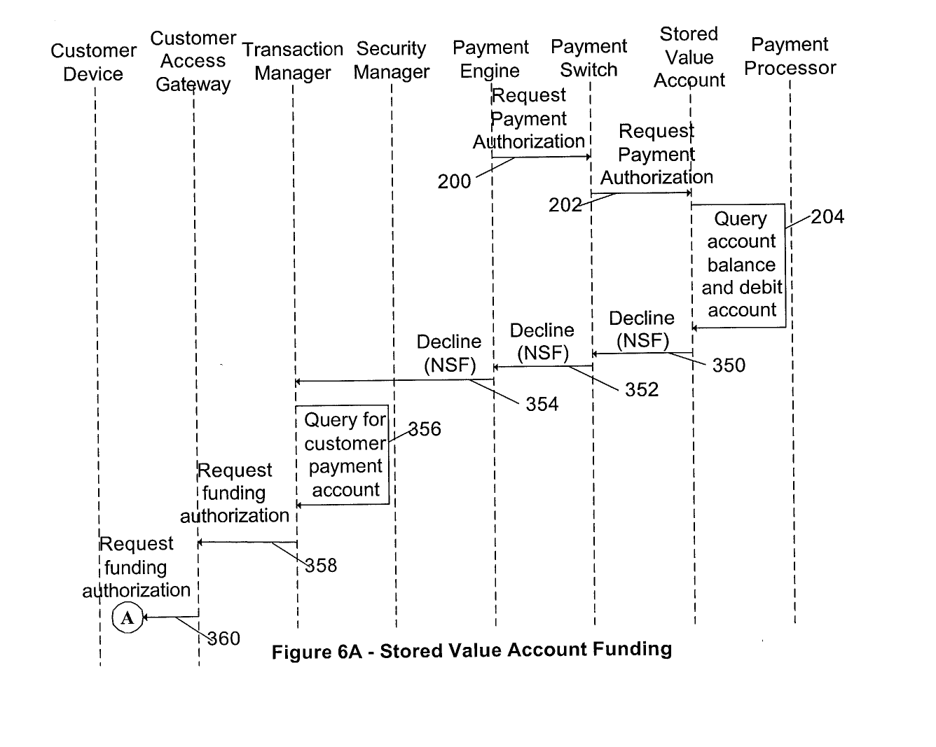

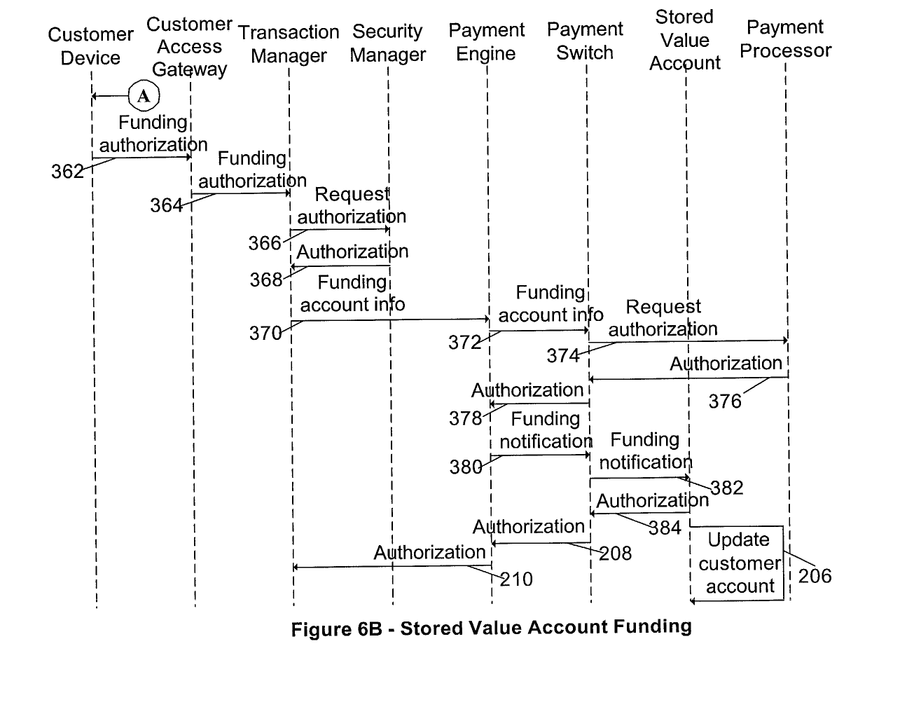

If a Stored Value Account (SVA) payment is used and there are not sufficient funds in that account, additional funds may be added to the account electronically during the ordering session. It should be noted that depending on the merchant's business rules, the customer might be allowed to have a temporary stored value balance of less than zero. In other words a short term “over draft” may be allowed. A typical process flow for funding a stored value account is shown in FIGS. 6A and 6B. It will be understood by those skilled in the art that the details of the process depend on the type of funding account used, the security methods employed and the merchant's business rules.

The payment engine 12 requests (200, 202) an SVA authorization from the stored value processor 16, via the payment switch 14. The stored value processor queries the customer's account to determine the balance (204), determines insufficient funds are available, and returns (350, 352) an authorization decline for Non-Sufficient Funds (NSF), which the payment engine passes (354) to the transaction manager 10. The transaction manager queries (356) the customer's account 28 to determine the funding account and requests (358, 360) an authorization from the customer for use of the funding account through the customer access gateway 42. The customer returns (362, 364) the authorization to the transaction manager 10. The authorization may contain authentication information such as a PIN code. The transaction manager requests and receives (366, 368) authorization from the security manager 18.

The funding account information is passed (370) from the transaction manager 10 to the payment engine 12. The payment engine requests (372, 374) and receives (376, 378) an authorization from the payment provider through the payment switch 14. Once funding authorization is received the payment engine passes the funding notification (380, 382) through the payment switch to the stored value processor 16, which updates (384) the customer account 28 and passes the authorization (206, 208) to the payment engine and on to (210) the transaction manager. The transaction manager can now complete the transaction.

If the funding account has expired or is not authorized for some other reason, the RO system will request information on another account or updated information for the account originally specified. Once new account information is available the RO system repeats the funding process as described above. If the customer declines to provide other account information or if no account is accepted by the available payment processors, the RO systems terminates the process and rolls-back the entire transaction (not shown in the figure).

The settlement manager 20 will initiate settlement with the payment processor at a later time. If these funds are not transferred or there is a later repudiation of the funding by the customer (customer charge-back), the customer account record will be updated with this information.

It will be understood that some payment types and payment processors do not provide a real-time or on-line authorization. In this case, the merchant can assume the risk that there will be sufficient funds in the account at settlement time. Alternatively, the customer may need to wait until settlement is complete and funds have been deposited into the SVA to complete any transactions. The choice of approach is dependent on the merchant's business rules and appetite for risk.

Following the failure of the SVA funding settlement process the customer account 28 will be suspended. Any already completed or pending settlement transactions with individual store settlement accounts (merchant DDAs) must be reversed. A number of schemes can be used to recover funds from individual merchant accounts. In the preferred embodiment, a debit is entered into each net settlement accounts for the individual stores with orders affected (debited against the funds that have failed to settle) by the settlement failure. Alternatively funds to cover settlement failure risk can be taken from a funds pool, maintained by charging a percentage fee for each individual store's remote order transactions.

In situations where a dispute has been resolved between the merchant and the customer in favor of the customer, funds will be refunded to the customer's SVA. Generally, the merchant corporate authority will be the one resolving the dispute. The net settlement file for the individual store involved in the dispute will be debited for the amount of the refund.

If a customer closes an account the remaining balance in their SVA will be refunded. Generally, the funds will be held for a short period of time to ensure that all settlement obligations to the stores are funded. In this way, the closing of a customer account will not affect settlement with any store. Generally, funds in the SVA are credited only to the account used to fund the SVA in the first place. This measure is taken to prevent account churning fraud schemes.

Promotional Account Management

If promotional value has been either credited or debited in the customer's account corresponding debits or credits are applied to the merchants promotional funds accounts. These promotional accounts are used to attribute the costs and benefits of promotions to individual stores, be they franchise or company-owned or not.

The promotional account allows individual stores to receive the benefits of the promotional value programs while still being able to attribute the costs proportionally. For example, a common bonus based promotional scheme allows customers to accumulate promotional points proportional to the value of their purchase. Each individual store location at which the customer accumulates the promotional value receives the benefit of the promotional program since presumably the customer is attracted to that merchant brand by the promotion. The settlement account for that store location is debited by the proportional average cost for the promotion. Once the customer has accumulated enough promotional value they redeem this value at some particular store location. That store location incurs the cost of providing the free goods or services. The settlement account for that store location is credited for this amount (possibly less a proportion of the value). The debits to the individual store settlement accounts can be increased to include a fee to pay for the management and marketing costs of the promotion. It should be understood that the process described can be used for a wide variety of promotions with only simple modifications.

In an alternative embodiment funds are contributed by each store location to a brand wide or regional promotional pool. These funds may be assessed as a percentage or total remote order value at each individual store over some period of time or simply divided evenly between the number of participating locations. These funds are then used to pay for the goods or services given away under the promotion at the individual store at which the promotion is redeemed.

Group Ordering and Catering

It is often convenient for customers to order as a group to facilitate delivery or pickup of orders. The RO system supports this capability through group ordering lists. One customer is the owner of the list (and usually the creator). The owner has administrative privileges over who is on the list, how orders on the list are paid for and what group orders members of the list place. As will be discussed in greater detail below, the RO system of the invention maintains information identifying group order members and payment information in the customer accounts.

Customers are added to the ordering group list by the owner in a variety of ways including:

1. The owner opens the list to anyone,

2. The owner creates a set of customers who can join the list if they desire to do so, or

3. Customers request to be put on the list and the list owner accepts or declines these applications.

Customer group ordering privileges are controlled though the security manager 18 of the RO system. The security manager allows (or not) customers to participate in a particular ordering group. The security manager also controls the administrative privileges of the owner of the group ordering list.

The list owner can invite the other members of the group to order in a variety of ways including, paging messages, email messages, SMS messages, and voice or voice mail messages. The generation of these messages is facilitated by the RO system, which shows the list owner pre-set lists of users to select from. The owner can add non-users to the list by initiating an invitation message though the RO system that includes instructions (and possibly incentives) for that person to create a new account. These messages can for example contain a link (URL) to an interface (web page) from which the new user can create an account and join the ordering group. The operator of the RO system or the merchant can offer the list owner incentives for successfully inviting a new user to join their ordering group.

Customers participating in the list will create an ID or alias for identification during distribution of the items ordered (which can be the same one used for individual orders). The list owner specifies the payment account options. With a list used for convenience only, each customer participating in the list will use their own payment accounts for their portion of the group order. Group orders placed by an organization such as a company, use a common payment account designated by the list owner.

Depending on the merchant's business rules and the applicable tax jurisdictions, the RO system computes tips, service fees and taxes for each individual suborder or for the entire order. Regardless of the merchant's rules, the price, tax, tips and service fees are computed by the RO system pricing engine under the control of the transaction manager 10.

Once the list is constructed individuals can select their orders and build ordering preferences from the store information directories 36. These processes are similar to those used for individual orders. The list owner can also order or build preferences on behalf of one or more of the list members (typically these will be done when a payment account under the list owner's control is being used). The list owner may create orders and preferences for individuals not on the group list. The list owner can create an identifier for these individuals to aid in the distribution of the items ordered. Since large group orders may strain the merchant's ability to fulfill them, these orders are typically placed in advance and with a pickup or delivery time designed. The group owner can review the order before it is submitted and accept of reject the entire order, an order from one individual or individual items as required.

Once the order is placed, it is transmitted to a particular store location in the usual manner for fulfillment. The RO system transaction manager 10 pools the individual suborders and passes them to the order delivery system 40 for formatting and transmission. The order is displayed and printed at the merchant location. To indicate individual customers placing each part of a group order, the displayed or printed segments contain a designator so that both merchant employees and customers in the ordering group know which person ordered which set of items. The terminal at the store location can produce individual printed receipts corresponding to the portion of the total order for each individual. These segments contain a designator indicating the group ordering as well as the individual and can be attached to each sub-order to aid distribution.

Group ordering lists can themselves include sub-lists, to any depth. Each sub-list has an owner with all list owner privileges for that sub-list. The owner of the sub-list has administrative privileges over who is on the list, how orders on the list are paid (which account used) and what group orders members of the list place. The use of sub-lists can add groups, such as departments within a company, who wish to order together for their members, but have separate lines of control requiring different list owners.

Open Authorizations and Confirmation

In retail operations, adjustments to payment totals are often required. Typical cases in which a payment adjustment is required include the customer adding items to their order while at the store, the merchant being unable to supply an item ordered, the customer presenting a paper coupon or advertisement to the merchant, and the customer adding a tip or gratuity to the total. In these cases, the RO system can provide an open authorization to the merchant according to rules determined by each store operator. The presence of rules requiring an open authorization is determined by the transaction manager 10 and security manager 18 by querying the merchant account prior to engaging the payment switch 14.

The open authorization (or pre-authorization) will generally be for a fixed percentage greater that the initial total or for a specific total value limit. Once the order has been fulfilled and presented to the customer, final payment adjustments are made, the customer approves the total payment and the final total is transmitted from the order terminal to the RO system. The RO system then records the final payment amount and locks down the payment transaction. A number of processes for closing the open authorization can be used. The details of these processes depend on the merchant's business rules and processes, the type of terminal equipment used in the store and the capabilities of the customer's wireless device.

Once the order has been fulfilled payment adjustments can be entered into the order terminal and perhaps printed. Codes for paper coupons or other non-electronic promotions are entered into the terminal, and with the promotional value if required. The terminal computes (perhaps through interaction with the RO system) the adjusted payment amount including adjusted tax. The customer can approve the final payment amount by entering their PIN or other identifier into the terminal, signing a paper receipt or having a signature captured digitally. The approval can occur at any fulfillment location, including a walk-in pickup area, a drive-though line, at curbside, or at a delivery location. In an alternative embodiment, a receipt for the pre-authorized amount can be printed, payment adjustments made manually on the receipt and the receipt signed by the customer. The final adjusted total is entered into the order terminal for transmission to the RO system at a later time.

In yet another embodiment, the customer can use the mobile device to authorize the final payment amount. The customer can connect to either the RO system through a wide area wireless network or directly to the order terminal at the store using a local area wireless base-station as has previously been described. In either case the terminal or the RO system authenticates the mobile device in the usual manner including a PIN or password login or the use of cryptographic methods such as PKI. Once connected and authenticated the RO system or terminal presents the final payment amount to the customer, who sends an approval in response. The authentication of the customer through the mobile device can be used as an additional security measure during order fulfillment.

Curb Service

To optimize customer order pick-up options, many merchants offer a variety of options including walk-in, drive-through and curb service. With walk-in service, the customer will approach a designated pickup order and talk to the employee on duty there. In drive-though service customers can identify themselves and indicate they have ordered remotely either using a sound system, typically used in drive-through lines, or by speaking to an employee at a window. Walk-in service has the disadvantage that it requires the customer to park, leave the vehicle and enter the store to receive their order. Most retail locations offering drive-though service do not have a drive-through line dedicated to remote orders. Thus the customer will likely need to wait in line behind other customers who must order and pay, and defeating the convenience value of the remote order service.

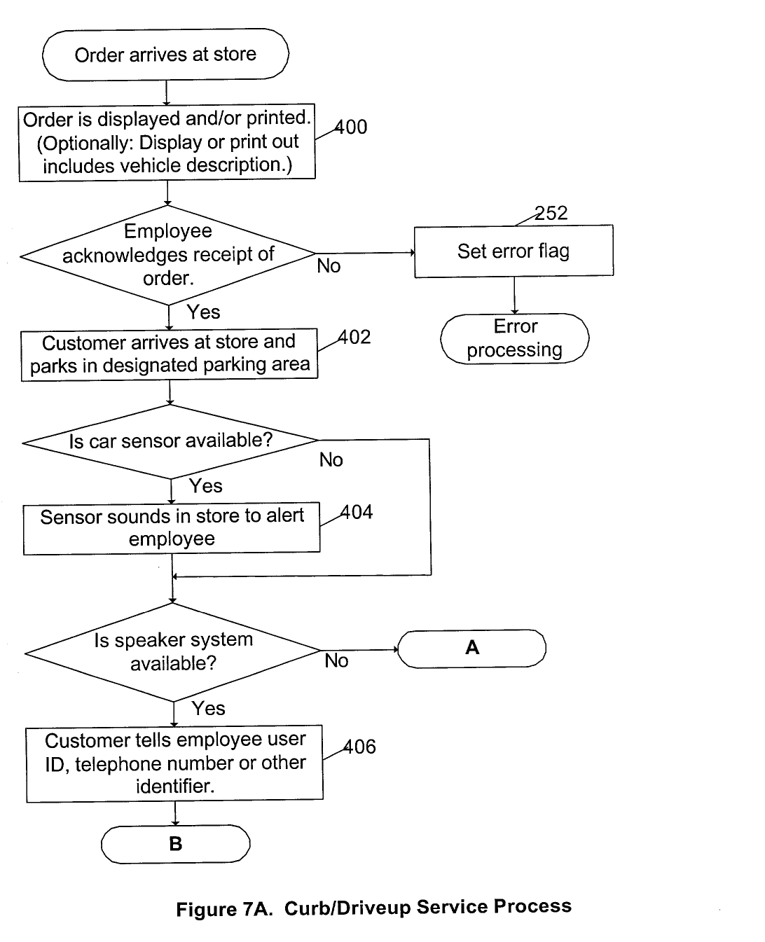

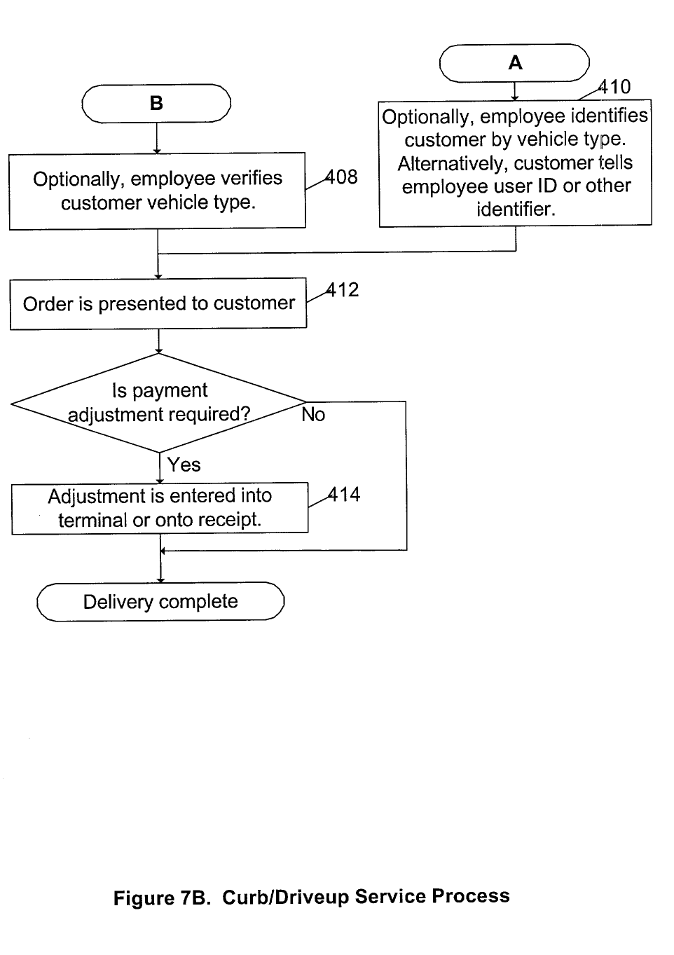

Curbside service maximizes customer convenience since the customer remains in the vehicle and the order is brought to the customer. However, curb service is not without operational problems for the merchant. The customer arriving at the store parks in a designated parking area and expects the merchant's employees to bring the correct order to them in a timely manner. But often the parking space for curbside orders is not easily visible to the merchant's employees and merchant employees are typically occupied with other activities. In most cases, even if the space is visible, the employee has no easy means of determining the identity of the customer or of associating the customer with a given order. This can result is confusion or longer waits for service than is necessary. The RO system of the invention avoids these problems by associating the customer with an order and by retrieving customer-identifying indicia from the RO system database. This information is pushed through to the store location along with delivery of the order. A flow chart of this process according to the invention is shown in FIGS. 7A and 7B. The order of steps shown in the flow chart can be changed or steps omitted to achieve the same purpose depending on the merchant's environment and business processes.

When a customer places an order, selects a store location and indicates they wish to have curbside pickup service, the order is transmitted to the store location in the usual manner. The RO system transaction manager 10 passed the customer's order, including the indication of the desire for curb service, to the order delivery system 40, which transmits the order to the desired store location (400). Depending on the merchant's business processes, the order may be routed by the order delivery system to a specific terminal used to process curb service orders (which may be the only terminal in the store). An employee at the store will acknowledge receipt of the order (240), with appropriate error processing (252), as has been previously described, if this fails. When the order is displayed or printed it will show all the usual information as well as a designation that the customer intends to pick up the order at curbside. Optionally, the order information can contain a description and license number of the customer's vehicle. The order is then prepared in the usual manner.

When the customers arrive at the store they park in designated curbside service parking spaces (402), which may be equipped with a sensor that triggers an audible or visual alert inside the store. Suitable sensor types can include magnetic or electromagnetic sensors sensitive to the metal in the vehicle, an electromechanical or piezoelectric pressure sensors sensitive to the weight of the vehicle, pneumatic sensors sensitive to the weight of the vehicle, light or laser beams that are broken by the presence of a vehicle, a video pattern recognition system that detects the presence of a vehicle, or a push-button operated manually by the customer. Once the customer's vehicle is in a designated parking space, the available sensors are triggered (404) to alert store employees.

If an audio system is available the employee can speak to the customer to determine their user name, alias, telephone number or email address or other identifier (406). Alternatively, the employee can identify the customer by their vehicle type or license number (408, 410). The employee can see the vehicle either through a window or a video camera system. Alternatively, a video pattern recognition system can be employed to identity the vehicle (type, color, etc.) and read the license number. This information can then be displayed on the order terminal or another display. The identification of the customer though vehicle description or license number can also be done as a security step even if an audio speaker system is in use. Once the customer has been identified and perhaps verified, the employee brings the order from the store to the customer's vehicle (412). If required, a payment adjustment can be made and a final receipt presented to the customer (414). Adjustments can be made to add a tip, if additional items are added to the order, or if items in the order cannot be fulfilled.

In an alternative embodiment, the customer order can be transmitted by the order delivery system 40 of the RO system to a portable wireless terminal. The employee carries this terminal with them to the curbside. The terminal can be the one used by the RO system for order delivery or it can be driven from an order delivery terminal in the store or the store's POS system. If an order arrives while the employee is at curbside, they can go into the store, prepare the order and bring it back to the curbside. Payment adjustments can be made and receipts printed on the wireless terminal. Alternatively, the employee with the portable terminal can communicate the order to employees in the store using a wireless head set audio system.

In yet another alternative embodiment, the customer parks in the designated parking spaces as before. Once parked, the customer makes wireless telephone call, or connects to the RO system using a wireless Internet device. The wireless connection can use a wide area or local area wireless network through a wireless base-station at the store. Wireless telephone calls can be automatically processed by the RO system (as orders are) or can be forwarded to the store location allowing the customer to speak to an employee. Notification of the customer's arrival is transmitted by the RO system to the order terminal at the store for connections from a wireless Internet device or an automatically processed telephone call. If the customer's wireless device and the wireless base-station at the store have the capability, the wireless device can be cryptographically authenticated using methods such as PKI.

Refund Processing

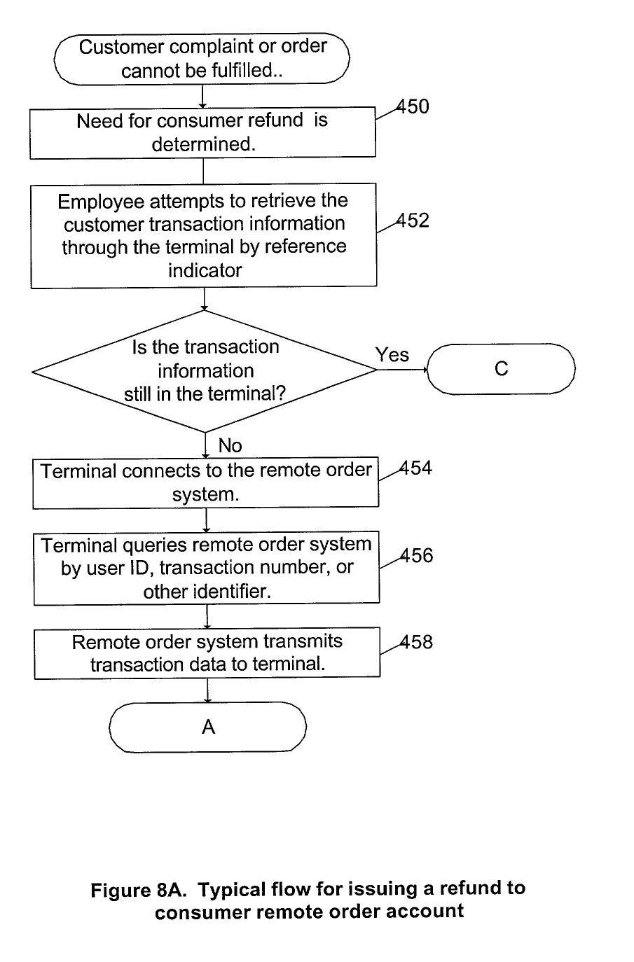

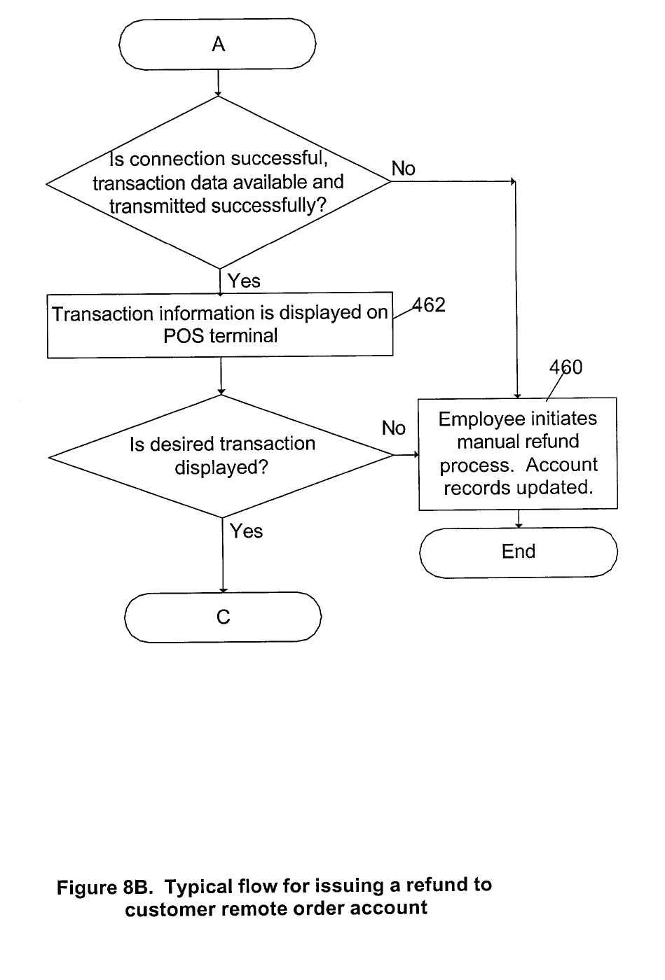

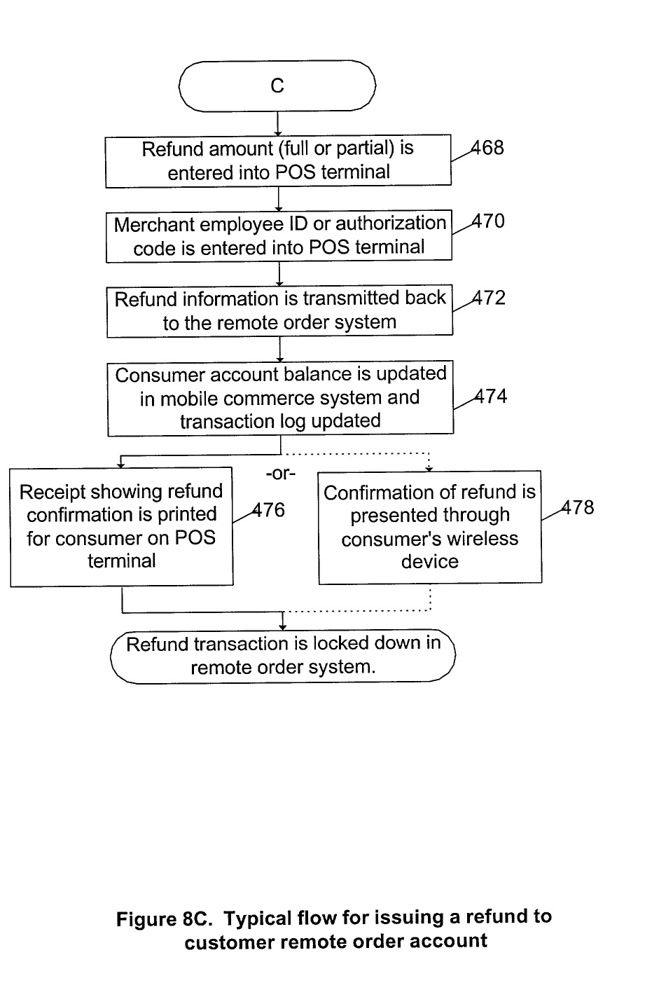

A variety of service problems can result in a merchant needing to issue a full or partial refund to a remote order customer. Examples of situations in which a merchant may need to refund a customer payment include the goods or services ordered by the customer are not available, or the quality of the goods or services delivered are not to the customer or merchant's standards. A flow chart showing a typical refund process according to the preferred embodiment of the invention through a POS system or terminal is shown in FIGS. 8A, 8B and 8C. In a given case, the actual process used will be adjusted to accommodate the capabilities of the POS system or terminal and merchant processes and procedures.

The merchant must post a refund to the correct customer account 28 through the RO system without having direct access to the customer's ordering device. The customer may have used a combination of a stored value cash account, a promotional account or a direct (credit or debit) account. In any case, the refund must be credited to the correct account. Further, beyond the value of the goods or services being refunded, the tax on those products must be refunded to the correct accounts. Partial refunds can be processed by directly processing the proportional credits. Alternatively, the value of the entire order (including promotional value) can be credited to the various accounts and the remaining portion (part not being refunded) debited from the applicable accounts.

It is often expensive, impractical and clearly inconvenient for the customer to contact a service center for a refund. Rather, a method is required that allows merchant personnel to issue full or partial refunds at the point of sale, either in a retail store or at the point of delivery of goods and services.

According to the invention, merchant personnel determine the need for a refund (450). The merchant employee accesses the mobile commerce system payment accounts through the order delivery terminal, or POS system (452). The transaction information is retrieved by a reference indicator, which can include, a transaction or order number printed on the customer's receipt, or the customer's user name, telephone number or other identifier. Alternatively, the employee can retrieve the transaction by scrolling through a list of recent transactions. If the transaction information is not available locally, the terminal connects to the RO system (454), the terminal queries for the transaction information (456), and downloads the requested transaction information (458).

Once the customer's transaction has been retrieved (462), the merchant employee can enter the refund (a full or partial refund, generally up to the full value of the transaction) (468). The merchant employee is typically asked for an authorization or identification code (470). The authorization code (typically an alpha numeric PIN or password) is used as a security measure to ensure that the employee is authorized to issue refunds. The authorization code can either be verified by the terminal or can be authenticated through the RO system. The identification code is a unique code assigned to each merchant employee and is used to create an audit log for the refund transactions. If the code does not correspond to an authorized employee the refund process will be blocked by the security manager 18. Audit logs can be periodically examined by auditing staff to prevent fraud.

Once the refund information is entered into the terminal it is transmitted (472) to the RO system, where the transaction manager 10 updates transaction logs and ledgers 32. Based on the information entered into the terminal the RO system will credit the refund to the customer's payment account (474). Confirmation of the refund can be sent to the terminal, printed and the printed confirmation given to the customer (476). Alternatively, a confirmation can be sent to the customer's mobile or fixed wire device or sent as an email message, or text message (478). The services of the promotion engine 60 and the tax engine 58 are used to apply promotion and tax rules to determine credits for promotional value used to pay for the order and tax applied to the order.

In an alternative embodiment, the refund transactions are stored in the terminal until a later time and are then transmitted in batch to the RO system. This transmission can occur when a connection has been established for another reason (i.e. order transmission) or periodically (usually once a day). In this embodiment, the terminal itself will verify the authorization codes supplied by the merchant employees.

If the automated refund process fails for any reason, the employee can process the refund manually (450) following standard merchant procedures. Account information may need to be updated manually as well in this case.

Store Closure or Service Termination

Unexpected events can cause a merchant location to cease operation or be unable to continue to process remote orders. These events can include an unexpected weather condition, a potentially dangerous situation, failure of critical equipment, or an unexpected number of walk-in orders overwhelming service capacity. In these types of situation the store manager or supervisor can use the order delivery terminal or POS system and network connection to the RO system to send a message indicating that the remote ordering service is temporarily suspended. The RO system will not accept any customer orders for that location during that period. Once the situation has passed or the problem corrected, the store manger or supervisor can again use the terminal or POS system and network connection to the RO system to send a message indicating that the remote ordering service can be resumed, at which time the RO system allows customers to order to that location once again.

Notification of Service Interruption

There are circumstances under which the RO system is unable to deliver the service to merchants and consumers. These situations can arise, for example, it telecommunications, data center or networking facilities suffer large-scale failures. In these situations the RO system must notify both merchants and consumers of the failures and the inability of the RO system to process and delivery orders to merchant locations.

During these conditions, the customer access gateway 42 (if still operational) will notify customers attempting to connect to the RO system of the situation. This notification can be presented in textual, graphical or audio formats, using the adaptors of the customer access gateway. These notifications will be posted until the problems are corrected.

Merchant store locations are notified of RO system failures by the order delivery system 40. This notification can be through the merchant terminal 50, or though an alternative means if the primary delivery method is not operational. Alternative delivery paths of this notification can include one or more of fax, one-way or two-way pager, telephone call to the store, email or instant message.

Store Employee Training Functions

Convenient and reliable service is the primary benefit derived by customers from using a remote ordering system. Failures in store processes or training can spoil the value proposition of the customer. Therefore, it is essential that merchant store personnel be well trained in the processing, preparation and fulfillment or remote orders.

The RO system supports training functions through the order delivery terminal or a store POS interface. Store managers, supervisors or trainers use an interface on the terminal to select a sequence of training functions. A sequence of training transactions can be set on the terminal or POS system in advance so that transactions occur during an employee's shift as they would with real customers, maximizing training effectiveness.

Alternatively a store manager, supervisor or trainer can use a wired or wireless telephone or wired or wireless Internet device to control the training transactions. These transactions can be set up in advance, or created from menus in real time. A Web interface can be used for the Internet connection. An IVR interface is used with telephones.

Training functions include:

1. Sending orders to the store, which the employees must respond to,

2. Simulating system problems, requiring an employee response,

3. Processing refunds,

4. Processing open payment authorizations, and

5. Helping customers with account issues.

Simulated training orders can be actually prepared or not, depending on merchant training policy. Simulated orders can be shown for in-store pickup, drive-through pickup, curbside pickup or delivery. During training, employees can be required to interact with the order delivery terminal upon completion of the simulated order. This response is logged and reported to show employee response time to the simulated orders.

The training functions can be controlled through the RO system or locally on the terminal or POS system. Training orders, refunds or other transactions are logged and reported in the RO system as such. Training orders, refunds and other transactions do not affect settlement files or financial account balances and reports.

Automated On-Line Help

The RO system provides an automated on-line help system to aid merchant employees at all levels. Management employees receive on-line help through the merchant extra-net. Typically these employees use a Web interface. Employees working in individual stores receive on-line help through the order delivery terminal, store POS system, wired or wireless telephone or wired or wireless Internet device.

The help functions on the order delivery are context sensitive. Examples of this context sensitive help include help on processing a refund or other process is offered when the employee chooses those functions, help with terminal problems is offered when an error condition is detected, help assisting customers is displayed when the customer's orders are queried, and help with reporting functions is displayed when the reporting functions are used.

Store employees have the ability to query customer records for lost orders. Lost orders can result from a customer misrouting their order (wrong store location), or possible system failures. Merchant employees can make a query to the RO system through the order delivery terminal to retrieve the customer's recent order and transaction history. As a security measure a manager or supervisor's authorization code may be required to make this query. Customer records can be done by customer telephone number, customer email or text messaging address, customer user name or alias, or customer name. Once the missing order is located, the merchant employee can take action to prepare and fulfill the order and make any refunds or adjustments required.

Payment Switch

The RO system will typically be interfaced through data networks to one or more payment providers. The RO system sends requests for payment authorizations and receives verification or authorization (or denial) of the payment transactions over this interface. The payment switch 14 connects to the desired payment account processor for each transaction, including refunds. The payment switch also makes the connection required to fund a stored value account or pay the balance on a credit account from any other payment account. There are several suitable commercial products that can be used as a basis for constructing the payment switch 14 including those from Clear Commerce.

A RO system may support a variety of payment types and payment providers. Different payment providers (acquiring processors) support different payment types including credit cards, debit cards, direct debit including use of Automatic Clearing House (ACH) networks, stored value, direct billing, inclusion of charges on a telephone bill (including the use of “900” numbers), etc. The use of multiple payment providers with different payment products gives merchants and customers a range of payment choices.

Data Warehouse and CRM System

The transaction data collected by the mobile commerce system is a valuable asset, which provides merchants with a record of unprecedented detail on customer purchases. Financial and business reports can be created on demand from the data warehouse 38 based on queries received through the merchant extranet. The transaction records stored in the data warehouse 38 are stored in flat or de-normalized relational tables. The data warehouse provides an online environment in which analytical processing (OLAP) can take place. OLAP operations can be executed directly in the data warehouse or loaded into a specialized CRM system 54. The records in the data warehouse can be used for financial auditing purposes. The use of a data warehouse repository separate from transaction processing ensures real-time system performance is not affected. Those skilled in the art will be familiar with numerous commercially available data warehouse and CRM applications including those supplied my Microsoft, IBM and Oracle Corporation.

The CRM system 54 uses data in the data warehouse 38 and customer account 28 for a customer care functions and for targeted marketing. Those skilled in the art will be familiar with the typical types of functionality available in a CRM system.

Merchant Reporting and Settlement Management

Merchant personnel access reporting and administration functionality of the RO system through the merchant extranet 48. Access to data (reports) and administration functionality is controlled by the security manager 18, which enforces hierarchical control. The merchant extranet is accessed though the wired or wireless Internet or a private network.

The Report generator 22 supplies transaction reports to both merchants and customers based on the transaction logs generated by the transaction manager 10 and stored in the data warehouse 38. The report generator uses report generation and display tools such as Crystal Reports™.

Among the reports provided to the merchant are settlement reports and invoices. These records are generated by the settlement manager 44 and show all transactions that create a change in account balances. The settlement file or invoice will also show the fees assessed to the merchant by the RO system service provider. Settlement records will show information for all merchant accounts affected by the transaction including promotional accounts.

Location Service Providers

The RO system can use the services of one or more location providers 46. One or more of these service providers interface to the transaction manager 10, which provides the services to customers using the RO system. Telecommunications carriers or other third parties operate these systems. Services provided include geo-localizing the customer, performing reverse number lookups to determine customer address, presenting choices of merchant store locations based on the customer's location, determining the nearest or most convenient merchant store location, and providing driving directions to the nearest merchant store location.

Customer Reporting

Customer reports are requested and displayed through the Customer Access Gateway. These reports can be provided from data in the data warehouse 38, in real-time (immediately following a transaction) or at some later time of the customer's convenience. Reports generated in real-time can be presented using any of the adaptors available in the customer access gateway. Alternatively, text or formatted text reports can be sent periodically to the customer by several means such as email or conventional mail.

Order Delivery System

The Order delivery system 40 (ODS) connects the remote ordering system to terminals and integrated POS systems at the various store locations. These terminals include in-store POS systems, card terminals, wireless base stations and wireless card terminals, such as those used for delivery services. Alternative order delivery methods include fax transmission and IVR over a telephone line, used only as a back up in the preferred embodiment of the invention. The ODS uses a series of adaptors that translates between the RO system internal data formats and the POS or terminal device specific formats. For example, an adaptor can translate the internal XML data schema used in the RO system into flat ASCII text in an ISO 8583 (or Visa I) format for transmission and printing on a stand-alone payment terminal. The adaptors work with the security manager 18 to implement the authentication protocol used by the POS or IT equipment at each store location.

The order delivery system 40 can be implemented using commercial networking equipment available from vendors, including CISCO Systems, 3Com Corporation and Digi Corporation, combined with server software using a suitable programming language (Java, C++, C#), a transaction manager (Microsoft COM+, IBM WebSphere, and Web Logic by BEA Software), and a database management system (SQL. server from Microsoft, DB2 from IBM or Oracle 11i from Oracle Corporation).

Order Queue Management

For many goods and services, an individual store location will only have a limited capacity to fulfill customer orders and will experience times of peak demand. The order delivery system 40 regulates the flow of orders to a given merchant location in a number of ways. Complicating this problem is the fact that the number of employees available to fulfill customer orders varies with time of day, day of week, season of the year and occurrence of holidays. Further, the capacity at each store can vary depending on the delivery). Regulating order flow allows merchants to provide the expected grade of service to remote ordering customers, walk-in customers or conventional telephone or fax customers.

Among the order queue management approaches the order delivery system of the invention can support are:

1. Allowing only a designated number of orders to be transmitted to each store (or even each terminal at specific fulfillment stations within a store) per period of time.

2. Giving customers estimates of fulfillment time when they place their order, with fulfillment time being estimated from the number of orders being placed verses the store's capacity to fulfill the order, or

3. Allowing customers to pick designated time slots or reservations, with the number of reservation slots per period of time set proportionally to the store's fulfillment capability.

The order delivery system 40 can use a variety of data sources to compute the optimum scheduling of orders or computation of wait time for each store (or work station within a store location). These data include:

1. A calculated fulfillment capacity for each product type or group by time of day, day of week, season of the year, and holidays,

2. Historical records on fulfillment time for each product type of group by time of day, day of week, season of the year,

3. Information on fulfillment times for recent orders at the store by product type or group,

4. Information on predicted capacity, staff availability and other variables input to the order terminal by a store manager or supervisor,

5. Information from the merchant's reservation management system, and

6. Information from the merchant's inventory system.

The order delivery system 40 manages an order delivery queue for each terminal at each store. If no connections are available, or the terminal or line at the store is busy, orders are held in this queue until they can be delivered. To optimize connections (especially when demand dial connections are used) the order delivery system checks the order delivery queue for the store location before terminating the connection. In cases where an alternative connection to the store must be used to deliver the order, the order delivery queue is emptied before the connection is relinquished.

Order Routing

Many retail stores and physical service locations have multiple stations or work areas from which customer orders are fulfilled. Customers may place remote orders with items from several of the merchant's departments. A food service outlet may have several work areas (perhaps with corresponding pickup areas; in store, drive-through or curbside) for different types of items or services. Further, merchant employees gather or prepare items for an order in a particular optimal sequence at each fulfillment station.

The order message routing in the ODS is dynamically controlled and depends on the merchant locations, the types of items ordered, the POS or terminal device type and identifier (as a merchant location may have more than one terminal), and type of transaction (e.g. customer pickup or delivery to a customer location). The order delivery system 40 retrieves routing information on store access from the merchant account 30 and store-specific store information directory information (i.e. IP address or telephone number). The ODS uses the services of the security manager 18 to authenticate the connection to each store. Using this method, the information for each transaction can be routed as required by the ODS. The interface adaptors are bi-directional to allow transaction data transmission for operations such as refund processing and reporting.

To accommodate these business processes the RO system supports one or more terminals at each individual store location. Based on the products ordered or services requested the RO system routes the items to the terminals designated by the merchant for that product category or group. Product category or group terminal routing information is stored in the store specific store information directory 36.

Merchant Terminal Equipment and Networking

Merchants use IT systems to facilitate the delivery of goods and services to customers, manage store processes and perform electronic payment operations. These IT systems include integrated Point of Sale (POS) systems and payment (card) terminals. Integrated POS systems are used to print or display a list of goods or services ordered by the customer to the merchant's employees who fulfill the order for the customer. Both integrated POS systems and payment terminals are used to capture payment information, obtain payment authorizations, and print receipts. Merchant POS devices and payment terminals typically are equipped with keypads that allow merchant employees to input identification or authorization codes, transaction codes or references IDs, payment amounts, or refund amounts. Many integrated POS systems and payment terminals maintain sales records and produce reports used by store managers. The merchant IT systems may be distributed between different sites (some not under the control of the merchant, such as at contractor's facility).

Networking to Merchant Locations

Merchant IT systems are connected to the RO system by a secure data network. Many well-known and emerging networking and security technologies can be used. Examples of suitable networking technology include:

1. Dial analog modem connection (on demand)

2. On-demand or continuous ISDN

3. Frame-relay

4. Digital Subscriber Line (DSL)

5. Cable TV modem

6. VSAT connection, and

7. Terrestrial wireless data (usually using IP).

Examples of suitable security technologies include secret key encryption, Public Key Cryptography (PKC), including Public Key Infrastructure (PKI), Virtual Private Networking (VPN), including the IPSEC and related protocols, MAC (Message Authentication Code) and symmetric and asymmetric Secure Socket Layer (SSL). Adaptors in the order delivery system 44 order delivery system accommodate different IT equipment, data protocols, data message formats, networking technology and security technology.

For terminals or POS systems on a dial connection, the RO system connect; to the device when order information needs transmission. The device establishes a dial connection to the RO system when merchant personnel wish to obtain a report or retrieve other information from the RO system. As the system of the invention centralizes in the RO system many of the transaction functions, the use of an on demand connection has the potential to reduce costs as compared to persistent connections.

The RO system accommodates the plurality of merchants serviced by the system by including a designation of the type of protocol in use at each merchant location (and therefore of what type of adaptor is required). This information, which is retained in the system database, is queried by the order delivery system 40 prior to establishing a connection with the store location.

Integrated POS Systems

According to the invention, with an integrated POS system the order process is triggered by the arrival of order and payment authorization information from the RO system. The transmitted order information will include descriptions of the items, options and special instructions. In the preferred embodiment, the data from the RO system is sent in the form of an XML message to a SOAP client on the POS system's server. The transaction data is translated into the POS system's internal formats, and is passed to the POS server software and logged in the POS server database using ODBC or JDBC interfaces. An acknowledgement of transmission is sent to the RO system. The RO system data is formatted to appear to the POS system as coming from a virtual terminal or “till”.

In another embodiment, the RO system transmits the order and authorization messages in a format (XML, flat file, etc.) used internally by the POS system, which initiates the transaction process. Once again, the RO system data is formatted to appear to the POS system as another terminal or “till”. Once the POS transaction has been initiated the transmission is acknowledged to the RO system and the order is displayed or printed in the same manner as a manually entered order. This display or printing can be done for various reasons including display in kitchen management systems, warehouse systems, customer receipts, etc.

It is usual practice to have the payment authorization entered into the POS system as a particular (unique to remote orders) tender type. This procedure allows tills to be balanced and facilitates cash management and sales reporting for the store. Numerous proven and emerging IT techniques can be used to receive order and payment authorization data from the RO system and initiate a POS transaction.

Stand-Alone Terminals and Multifunction Payment Terminals

In an alternative embodiment remote orders and payment authorizations can be transmitted to a stand-alone point of sale device including, a card terminal, a remote printer, a dedicated terminal or thin client device, or an electronic till (non-integrated POS). The order information is transmitted in a printable or displayable format from the RO system to the stand-alone device. Once the order is displayed or printed (FIG. 3E, 238) on the device, a merchant employee can then begin to fulfill the order.

If required by merchant procedures, the order can be manually entered into a POS system. The displayed or printed order information will include descriptions of the items, options and special instructions. A remote order tender type is typically used when the order is entered into a POS system. The device will typically print two receipts, with one copy presented to the customer and one copy kept for the merchant's records.

The same multifunction payment terminal equipment can be used for processing payments with other payment providers including credit card, debit card, gift or loyalty card, and cheque draft capture, authorization or guarantee. In these cases, the device is programmed to use a “split dial” configuration, wherein the outbound number dialed is determined by the host system to be contacted.

In an alternative embodiment, the human-readable customer order information can be supplemented with bar-coded or other information that is scanned by machine. The merchant employee can use this coded information to rapidly enter the order into a POS system with a scanner. This embodiment allows customer order information to be captured in a POS system, or other merchant IT system, without the need for expensive system integration or time consuming, costly and error prone manual entry. The coded information will generally be a retrieved from the store information directory 36, which contains Universal Product Code (UPC) or Stock Keeping Unit (SKU) (1218, 1244, 1250) and the coding for the item, option or modifier (1220, 1242, 1304). In a similar manner promotion identifiers (1402) can be displayed (1430) in both human and machine scanned formats.

Order Display For Employees

Merchant employees will follow a sequence of steps when fulfilling an order. These steps are unique to each merchant (and sometimes merchant location) and have generally been designed to optimize employee productivity. To facilitate these processes the items in the order are printed or displayed in a sequence that optimizes the employees work in fulfillment of the order. To further facilitate the fulfillment of orders, the names, mnemonics and codes used to print or display the lists of items in the order are the same ones used in the merchant's other systems. Terminal display or printing sequence and display name or code for specific product groups or categories are all stored in the store specific store information directory 36. The information displayed may also have time information to add the merchant employees in preparing the order. This information is particularly useful in preparing time critical items, such as hot foods.

Customer Order Display Terminal

An optional display terminal can be used at the merchant's location to show remote order customers the status of their orders upon their arrival at the store. If needed, terminals can be positioned in the store, at the curb service area and at the drive-through line. In the preferred embodiment, the display terminal show order status attributes including:

1. A list showing each order,

2. The customer's mobile user ID, user alias, last 4 digits of telephone number of other identifier,

3. The order status (pending, ready for pickup, problem or error),

4. Summary of items in the order, and

5. The estimated time until fulfillment (if still pending).

This display allows customers to conveniently know their order status without interrupting a vendor employee upon arrival at the vendor's location. If the customer sees a problem with the order as displayed (or does not see the expected order displayed) they can contact a merchant employee or the customer service center for assistance. Optionally, the terminal can display promotional announcements or other messages of interest to customers.

The order status display terminal is preferably driven by information in the POS system or from a stand-alone terminal or order-processing computer. Alternatively, the display terminal can itself be an intelligent network device.

Once the store acknowledges delivery of the order back to the ODS (134), the transaction manager 10 locks down (136) the transaction and completes the log.

Local Area Wireless Connection

A growing number of portable wireless telephones and Internet devices are equipped with local area wireless connection capability. Emerging standards include IEEE 802.11B, Infrared Data Access (IRDA) and Bluetooth. To allow customers to access the RO system while at the merchant location, a local area wireless base station is located at the merchant's attended or unattended (automated) physical locations. The local area wireless base station is used to establish a local wireless connection to properly equipped customer wireless devices. When a customer's wireless device comes within the proximity of the wireless base station, the base station establishes a wireless connection and executes a security protocol for authentication, under the direction of the security manager 18, with the customer's wireless device, or using an automated service discovery protocol. Once the customer has been positively identified, they can then carry out transactions though the customer access gateway without the need to connect to a wide area wireless network.

The local area wireless base station is connected to the mobile commerce system using a secure data or voice network. This connection can use the same network used for connection of merchant IT systems. Once the connection has been established between the customer's wireless device and the RO system, the wireless base-station information can be used by the RO system to determine the customer's store location. This information can be extracted, for example, from the base-station's or router's network ID (i.e. IP address). The RO system can use this information to present the correct menus to the customer or to apply the customer's ordering preferences to that location in an automated manner.

Once connected to the RO system through the local area wireless network, and authenticated though the security manager 18, customer wireless devices have access to the same RO system services as with any other similarly capable connection. The customer can access their account 28 and perform remote order and payment transactions. Orders placed on the customer's wireless device, are processed in the RO system and then transmitted back to the store. If supported by the adaptor on the customer access gateway, the store location is automatically identified for the convenience of the customer.

Alternatively, a public access or general-purpose wireless base-station may be provided by the merchant or a third party service provider. These public access base-stations are generally connected to the Internet, allowing access to the RO system and its services.

Terminal and Service Tests

Terminal and POS equipment and network connections are subject to failures. The terminal can contain a number of built in tests to detect common problems and notify either operations personnel or employees at the store. Typical error conditions that can be tested for include telephone line or network disconnected, terminal turned of or power disconnected, and printer out of paper or jammed. The types of test run and actions taken will depend on the specific characteristics or the terminal or POS equipment and network connections used. Existing and emerging IT industry practices can be used to monitor and verify the operation of merchant terminals and network connections. Products from the Unicenter™ product from Computer Associates, the Openview™ product from Hewlett Packard or the Tivoli™ products from IBM are all suitable.

The RO system may perform periodic tests to ensure the system is operational and notify store personnel or network operations personnel as appropriate if a fault is detected. An example of a periodic test is a Start of Day (SOD) test. A test order is sent to the store and acknowledged by a merchant employee a few minutes before daily service hours are to commence. Once this test has been successfully completed or any problems detected corrected, the store order delivery or availability flags are set to the positive state.

If the terminal or POS equipment detects an error condition it can connect to the RO system and transmit an error or alarm message to operations personnel for corrective action. If the error is one that can be corrected at the store (i.e. printer out of paper) the RO system automatically contacts the store through the terminal (if still possible) or via an alternate path (see the discussion in the order transmission section of this disclosure). If the terminal detects an error and is unable to contact the RO system, or does not need to do so, it can use an audible or visual signal to alert an employee and display an informative error message including suggested corrective actions. Examples of errors that would prevent the terminal from contacting the RO system are a disconnected network or telephone line (failure of a periodic test for dial tone), printer out of paper, or printer paper jam.

In addition to automatic tests, it is useful for operations and store personnel to be able to perform manual tests. For example, operations personnel can transmit a test order to the terminal in the store. Upon the employee selecting a test function on a store terminal, a communication is initiated with the RO system. The security manager 18 will verify that the particular store and the particular employee has the required authority to perform a test by verifying the records maintained in the security information store. If authorized, the transaction manager 10 will push through to the store location a test order, but without value. Associated functions are also omitted such as pricing, payment, settlement and other processes. The order information will state that it is a test order and the acknowledgement will be displayed to the initiator of the test when acknowledged by an employee at the store. If a fault is detected an informative display is presented. Alternatively, the test order message can be transmitted to the terminal and acknowledged electronically but not by an employee so as to minimize distractions and time use for the employees. In a similar manner, store employees can connect to the RO system (generally using a telephone, wireless messaging device or Internet device) and transmit a test order to their terminal. If a fault is detected an informative display, including recommended corrective action is presented on the terminal if possible. If not, an alarm is sent to operations personnel for corrective action.

Terminal Provisioning

In order to allow deployment on a large scale to merchant locations, the RO system must support the provisioning of both stand-alone terminals and client software used on integrated POS systems. Both the provisioning of new installations and updates of installed software are supported.

For a new installation, merchant employees connect the terminal or POS system to the network or telephone line. In the preferred embodiment, newly installed standalone terminals will automatically connect to the order delivery system 44 though the network connection when they are initially turned on, be authenticated using the security manager 18 and have any additional required software loaded onto them. A similar process can be executed when the initial client software is loaded onto an integrated POS system. Merchant personnel may need to respond to a display asking for store location information, telephone line numbers, etc. Alternatively, the merchant employees or network operations personnel can manually initiate the initial connection. In any case the software running on the terminal or RO system servers provides merchant employees and network operations personnel with informative error messages, containing suggested remedies, if a failure in the process is detected.

When required the RO system will automatically update software on stand-alone terminals and integrated POS systems. The software update is staged on the order delivery system 44, by network operations personnel, who then set instructions to load the software to the desired locations automatically. The RO system then connects to groups of terminals or POS systems, verify the identity through the security manager 18, and loading the new software. This order delivery system will cycle though all groups of terminals or POS systems until the entire update process is complete.

Whenever software is updated on a terminal or POS system or a new terminal or POS system is connected to the order delivery system 44 a set of verification tests is initiated by the order delivery system. These tests will exercise the functionality of the software to verify its correct operation and can include the following. The RO system sends a test order to the terminal or POS system and a merchant employee responds to verify the correct operation. The RO system instructs the terminal or POS system to display the store identity, as recorded in the merchant account 30 or store information directory 36. The display will ask the merchant employee to verify that the terminal is in fact at the location recorded. The merchant employee would be asked to enter information to initiate a test connection and exchange of information from the terminal to the order delivery system 44. If faults are detected, the software running on the terminal or RO system servers provides merchant employees and network operations personnel with informative error messages, containing suggested remedies.

Customer Access Gateway

The customer gateway provides customer access to the RO system through many types of electronic fixed wired and wireless access devices and methods. The gateway translates between the transaction data manipulated in the RO system and the specific presentation formats used by customer wireless and fixed wire devices, including telephones and Internet devices. Those skilled in the art will recognize that the customer access gateway can be based on a number of commercial products, including the Web Sphere Translating Transcoder from IBM, or the gateway servers from ViaFone and MobileQ. Generally these products use sets of adaptors or templates to display information in a wide variety of formats to accommodate most fixed wired or wireless telephones and Internet devices. Alternatively, the gateway can be constructed using an HTTP server and sets of XLS and XLST templates. Presentation for telephone devices is in the form of voice (including Automatic Speech Recognition, ASR, or Interactive Voice Response, IVR), or data, such as the World Wide Web. The presentation templates for the various levels of the hierarchical directory 36 that are specific to different device types are kept in the store information directory or linked to the store information directory. The customer gateway works in conjunction with the security adaptors in the security manager to provide a secure (authenticated and encrypted) connection, regardless of the device or method used by the customer.

The preferred transaction data format for the RO system is XML. With an Internet browser interface the internal RO system XML formatted transaction data is transformed to a markup language format such as:

1. Hypertext Markup Language (HTML),

2. Wireless Markup Language (WML),

3. Handheld Device Markup Language (HDML),

4. Clipped HTML (cHTML),

5. Extensible HTML (XHTML),

6. Dynamic HTML (DHTML), etc.

Text interfaces, such as the Sort Message Service (SMS), are supported by transforming the XML formatted internal transaction data into plain text and attaching appropriate headers and trailers.

For the voice interface, the internal XML formatted transaction data is transformed to the appropriate dialog in VoiceXML. A speech processing system transforms the VoiceXML dialog into speech and receives responses in either speech format (for ASR) to Dual Tone Multi-Frequency (MTMF or IVR) format. Suitable speech processing equipment is available form vendors such as Natural Microsystems, Dialogic (a division of Intel), Nuance, IBM (Voice Sphere), or Speech Works.

Existing and emerging IT industry practices can be used to monitor and verify the operation of Internet servers for wired and wireless connections. Products from the Unicenter™ product from Computer Associates, the Openview™ product from Hewlett Packard or the Tivoli™ products from IBM are all suitable. Monitoring of the voice connection for wired and wireless networks can be accomplished by using an automatic dialer that connects to the telecommunications interface in the customer access gateway and executes a test. The test can be accomplished by creating a series of Dual Tone Multi-Frequency (DTMF) signals to test the IVR capability or using recorded or machine generated speech to test ASR interfaces. Equipment and software suitable for this testing function can be obtained from Dialogic (a division of Intel), Cisco Systems or Digi Corporation.

Transaction Manager

The transaction manager 10 mediates the flow of the overall remote order and payment transaction. The transaction manager ensures that each transaction is properly executed or aborted (rolled-back) in a consistent manner and that the required logs and records are maintained regardless of the outcome. The transaction manager 10 works together with the security manager 18 to ensure that transactions are properly authorized. No transaction can be executed unless authorized by the Security Manager.

The transaction manager uses the merchant accounts and customer accounts, which store information specific to merchants and customers. Some or all of these records may be transferred to either party during the transaction if required and if authorized by the security manager 18. The transaction manager 10 enforces the business rules of the merchants for payments and settlement methods they wish to allow for certain types of transactions.

The transaction manager 10 and key associated components are shown in FIG. 2 and can include:

1. The transaction manager 10 which controls the over flow of the transaction.

2. Payment Engine 12, which computes the price of the order and obtains a payment authorization for the required amount,

3. Promotion Engine 60 which computes the value of promotional offers, and

4. Tax Engine 58 which computes sales taxes applicable to the order.

The transaction manager 10 is constructed using a commercially available transaction controller. The Transaction Manager can be implemented using a suitable programming language (Java, C++, C#), a transaction manager (Microsoft COM+, IBM WebSphere, and Web Logic by BEA Software), and a database management system (SQL server from Microsoft, DB2 from IBM or Oracle 11i from Oracle Corporation).

Transaction Manager

The transaction manager controls the overall order and payment transaction. The transaction manager 10 uses the services and data available through the payment engine 12, the security manager 18, the customer account 28, the merchant account 30, the order delivery system 40, the store information directory 36 and the customer access gateway to perform its functions. If the transaction fails or cannot be completed at any point, the transaction manager rolls-back the transaction so that record residue from the aborted transaction is removed from the system. If the transaction is completed successfully, the transaction locks down the record for the transaction (FIG. 3E, 246).

All data logs from a transaction, successful or not, are logged to the data warehouse 38 for reporting and audit purposes. The transaction manager records the value of the transaction, the merchant's account information, customer account information, the time of the transaction, the store location of the transaction, items ordered, time of delivery of goods and services, exceptions associated with the transaction and meta-information associated with the transaction in the transaction log database. These records are used by the report generator 22 to provide transaction information to merchants and customers, and by the settlement manager 44 to determine the net settlement between customer and merchant accounts. The settlement manager 44 also debits the merchant accounts with applicable transaction fees and produces reports or invoice files as required.

Payment Engine

The payment engine 12 computes the total price and manages the payment for a customer's order. When computing the price of the order, the payment engine queries the store information directory 36 to determine the price of the items in the order for the specific store location indicated by the customer and queries the merchant account 30 to verify that the particular store location accepts the type of payment proposed by the customer. The Promotion Engine 60 is then queried to determine if any promotional offers apply to the order and what their promotional value is. The promotional value is then discounted from the total price. This order and payment information is then submitted to the Tax Engine to determine the applicable tax. The payment engine 12 then computes the total payment due. The payment engine uses the payment switch 14 to request and receive payment authorizations. Payment account information is read from the customer account 28. The payment engine uses the services of the payment switch to receive a payment authorization from the internal stored value processor 16 or an external payment processor. The Payment Engine then posts the payment transaction records to the merchant and customer account records.

Promotion Engine

The promotion engine 60 computes the applicability of promotions and the value of any applicable promotions. The promotional engine evaluates available promotions to determine which ones apply to a given purchase, determines which applicable promotional offer has precedence for each purchase, and determines if promotional value needs to be added to or subtracted from a promotional purse.

There are at least two distinct types of promotions managed by the promotional engine: product-oriented promotions and customer-oriented promotions. Certain promotions involve both product and customer data. The promotion engine queries the store information directory 36 for the specific store location and the customer account 28 to obtain the required parameters to evaluate the applicability, value and precedence of promotions. The promotion engine uses the services of the stored value processor 16 to manage promotional purses.

The rules and parameters used to evaluate which promotions apply to a given purchase use a wide range of parameters which include:

1. Date, time of day and day of week of order,

2. Store location of order,

3. The customer's buying habits and frequency,

4. Item or combinations of items ordered,

5. Value in promotional purses,

6. Value of each possible promotion for the order,

7. Exclusivity of promotions,

8. Merchant business rules on encouraging certain purchasing behaviors.

The RO system accommodates promotions across a chain of merchants by maintaining the customer promotional purses for use in any customer transaction within the chain, as well as by effecting promotional pool settlement according to the particular store locations used by the customer in exercising the promotional options.

Tax Engine

The tax engine 58 computes the sales taxes applicable to the order. It should be understood that sales tax can be interpreted in a very broad sense to include state, county and local taxes, Value Added Tax (VAT), Goods and Services Tax (GST), surtaxes, etc. The tax engine queries the Store information directory 36 for the tax codes (which include tax rates and rules for applying the tax rate) applicable to the items in the order. The rules and parameters used for determining which tax rate applies and the tax amount are found in the store information directory Tax computation information, including the tax codes applied, is passed to the payment engine 12 for logging and reporting.

When promotional value is used for some or all of the payment, tax is computed for the balance of the cost of the order on an item (or category) specific basis. Alternatively, tax can be computed for the entire value of the order and then tax credits computed for the item (or category) specific promotional value. In some jurisdictions and for some types of items, it may be required to compute the tax on the item ordered based on the listed price, regardless of the promotional value applied.

Stored Value Processor

The stored value processor 16 manages multiple purses. These purses can contain cash value or promotional value. Thus, value (cash and non-cash) in one or more purses can be applied to a given purchase. Alternatively, an external stored value system can manage one or more purses and be accessed by the payment engine 12 through the payment switch 14.

The stored value processor 16 manages central cash and promotional SVAs on behalf of a group of stores for one or more chains or brands. The customers place funds into their cash SVA upon creating a RO account (28) and as needed when the funds are depleted. The stored value processor 16 debits these funds from the SVA when customers order goods or services. At the same time, credits are entered in the ledgers for the individual store merchant accounts. For non-cash or promotional SVAs, a credit for the customer is created under control of the promotional engine. A corresponding debit (liability) can be entered into the merchant's ledger. When the promotion value is used for payment a debit is created in the customer's ledger for that purse. A credit can be entered into the merchant's ledger. These debits and credits are logged to the data warehouse 38 or ledgers 32 where they are used by the settlement processor 44 to create settlement files and which are used to transfer funds from the SVA to the individual store DDA.

Processes performed by the stored value processor 16 include:

1. Ledger management,

2. Account funding,

3. Purchase authorization,

4. Reversals and refunds,

5. Settlement, and

6. Escheatment management.

Account funding, purchase authorization, reversals and refunds and settlement are discussed elsewhere.

The stored value processor 16 can be implemented using a suitable programming language (Java, C++, C#), a transaction manager (Microsoft COM+, IBM WebSphere™, and Web Logic™ by BEA Software), and a database management system (SQL server from Microsoft, DB2 from IBM or Oracle 11i from Oracle Corporation). Optionally, an integrated accounting system such as Oracle Financials can be used to construct the stored value processor.

Ledger Management

The stored value processor 16 manages a double entry ledger system. A set of ledgers is maintained for each stored value purse (cash or promotional). Entries are maintained in this ledger system for all customer and merchant accounts within the chain. When a customer adds cash funds or promotional value to their account a credit is entered into the customer account 28. When the customer makes a purchase a debit is entered into the customer's account (corresponding to the purse being used) and a debit is entered into the specific merchant account 30 for the location chosen. Following each transaction, the stored value processor 16 logs all credits and debits to the data warehouse 38 where they can be used for settlement and reporting purposes. The total cash funds (float) in the SVA is the sum of all customer debits and credits. Likewise, the value of non-cash or promotional liabilities is the sum or all credits and debits in the customer accounts.

Reversals and Refunds

In some cases a cash or non-cash stored value transaction will need to be reversed or refunded. If the transaction has not been completed by the transaction manager (the transaction is being rolled-back) the SVA ledger entries will be backed out (in effect removed) reversing the transaction. In the case of a refund after the initial transaction has been completed credit entries are made in the customer account ledgers and debit entries are made in the appropriate merchant account ledgers. The services of the promotion engine 60 and the tax engine 58 are used to create the correct credits for promotional value used to pay for the transaction and taxes applied to the transaction. The refund amount can be for the full amount of the purchase or a partial amount.

Escheatment Management

Depending on the local laws in force in the customer's home jurisdiction, cash funds in inactive accounts need to be returned to the customer if the account remains inactive for a certain period of time. This process is known as escheatment. The stored value processor 16 contains a table of escheatment times for each jurisdiction in which customers live. No entry is required in these tables for jurisdictions without escheatment laws. Periodically the stored value processor 16 computes the time each account has been inactive and compares this to the escheatment time in the table. As the escheatment time is approached the account is listed in an escheatment report. The escheatment report is used in either an automated or manual refund process to return the funds to the customer.

Security Manager

The security manager 18 authorizes transactions and controls access to customer and merchant account information (data) and system services. The security manager uses the security information store 34 and is composed of a number of components, including:

1. Security administration interface,

2. Merchant account security controller, and

3. Customer account security controller.

The security manager 18 executes a wide range of security protocols. Depending on the identification and authorization capabilities of each customer's electronic device (wireless or fixed) and the level of security required for the transaction, adaptors are used to execute each specific protocol. The adaptors operate under the direction of the merchant account security controller or customer account security controller. Examples of adaptors include adaptors:

1. For magnetically or optically coded cards,

2. For Radio Frequency (RFID) identity tokens,

3. For biometric devices,

4. For smart card protocols,

5. That execute the Bluetooth link security protocol,

6. That perform a Public Key Infrastructure (PKI) or X.509 security protocol,

7. That execute the SSL protocol for Internet connections,

8. Using combinations of telephone number (ANI) or device ID and PIN code or password,

9. Using combinations of spoken PIN, spoken password and voice print for fixed or wireless voice telephony,

10. That produce a printed receipt for the customer's signature on a POS terminal (and may provide facilities for electronic signature capture from the POS terminal),

11. That require a merchant employee to input a verification code on a POS terminal (for example, name or numbers from a customer's photo ID that has been verified),

12. That initiate a voice call or data connection to the customers fixed or wireless telephone or fixed or wireless Internet device,

13. That accept an authorization from a merchant employee looking at a picture of the customer or other “watermark” image displayed on the customers wireless device,

14. The customer's telephone number or other electronic device identifier, and

15. Connections to telephone “out of band” network information, including that available on SS7, IS-41 and GSM systems, on wireless or fixed wire telephone identification and authentication.

The Customer Account Security Controller can include adaptors that work with authentication services external to the RO system. These services, such as Microsoft Passport™, pass a security token to the external commerce system that is used to authenticate the customer during a given session. For PKI protocols the security controller can work in conjunction with an external Certificate Authority (CA). It should be clear to those skilled in the art that the creation of new adaptors to accommodate improved security technology is to be expected over time. The authentication data required to execute these protocols is held in the security information store.

Many existing and emerging technologies can be used to implement a security manager as described here. Baltimore Technologies and Tivoli Software (a division of IBM) offer role-based security management directories and management tools that provide a suitable basis for implementation.

Security Information Store

The security information store 34 contains data required for authentication of merchants and customers, as well as access permission information for merchant employees. Almost all authentication protocols require the storage of specific information. Further, merchant and customer access privileges must be stored and retrieved on an individual person basis. Customers may use multiple access devices each with its own authentication data, which must be stored and retrieved from the security information store. In the preferred embodiment, the security information store 34 is implemented using a relational database. In an alternative embodiment a Lightweight Directory Access Protocol (LDAP) standard directory, object-relational database, or object oriented database can be used. In any case the security information store is kept on a hard disk or other non-volatile media and is queried by the server or servers running the security manager 18. This directory can work in conjunction with authentication information stored in external sources. Examples of external sources for authentication information include PKI Certificate Authorities (CA) such as those offered by Verisign and Baltimore Technologies or an authentication service provider, such as Microsoft Passport™.

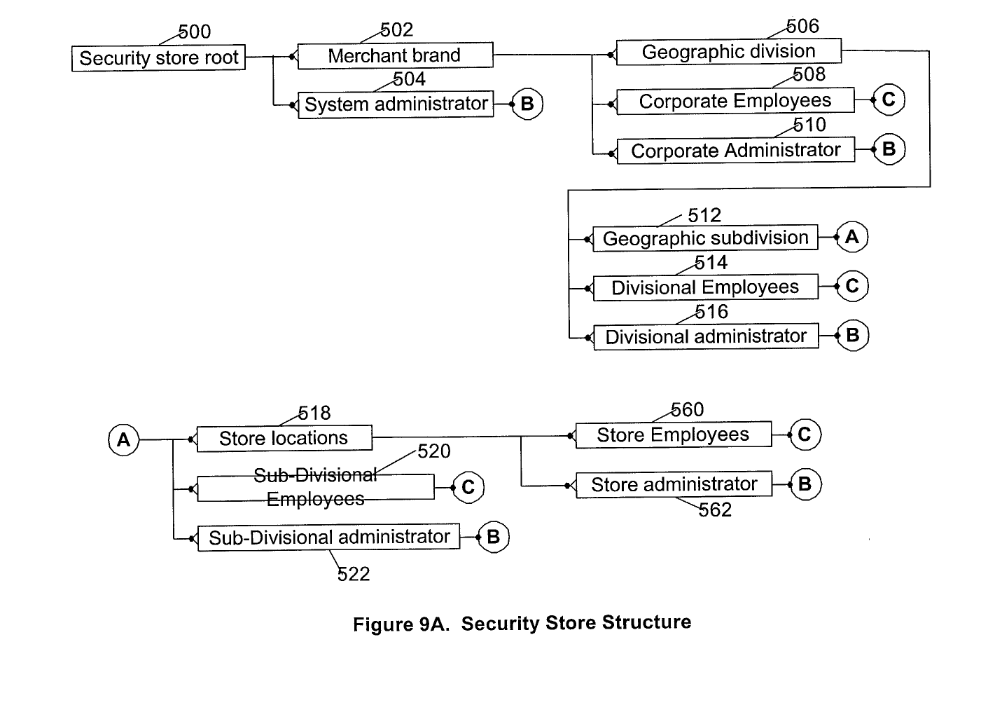

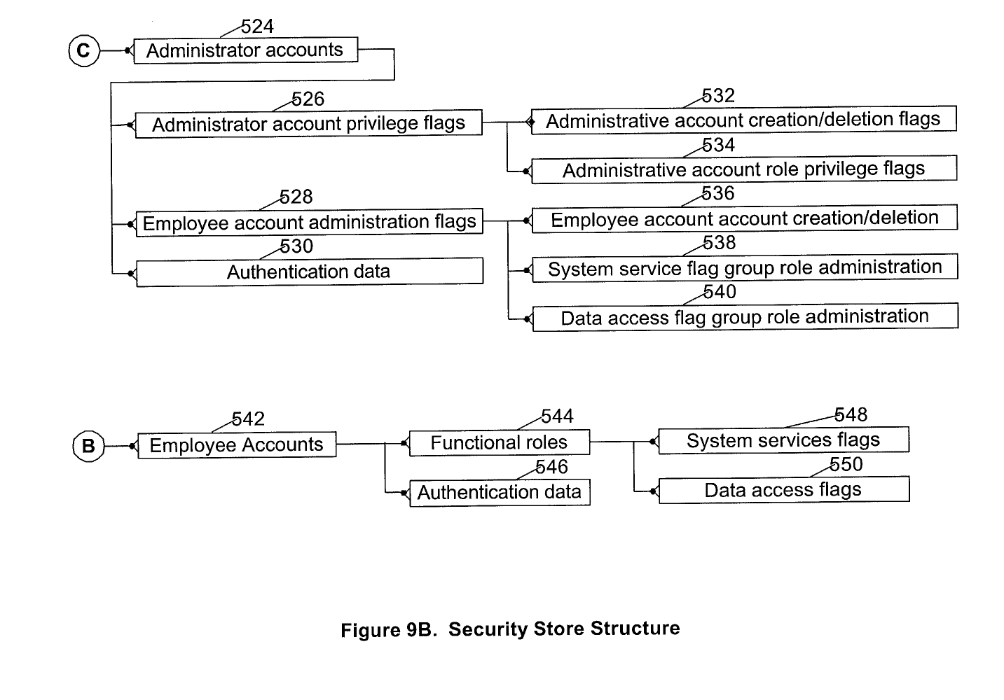

An example of a security information store structure for merchant accounts is shown in FIGS. 9A and 9B. Security information for all merchant brands (502) and system administrators (“super users”) (504) are all tied together at the root (500) of the structure.

Merchant brands are divided into administrative groups that are generally organized along corporate organizational lines. A merchant brand (502) can be divided into one or more geographic divisions (506) and the geographic divisions divided into one or more geographic subdivisions (512). These subdivisions can include the territory of an individual franchise operator. There can be multiple levels of geographic subdivisions as required by corporate organizational structure. Geographic divisions or subdivisions are divided into individual store locations (518).

Account and security information for both employees and security administrators are maintained at each level of the corporate hierarchy. This structure allows efficient administration of employee roles at each level of the organization. Further, this structure allows the burden of security administration functions to be distributed to the various levels within the organization. Accounts for employees (508) and security administrators (510) at the corporate level are organized under the merchant brand (502). Accounts for geographical division (514) and subdivision (520) employees and geographical division (516) and subdivision (522) security administrators are organized under the geographic division (506) and subdivisions (512). Store employee accounts (560) and security administrators (562) are organized under each individual store location (518).

Security administrator accounts (524) contain a set of administrator account privilege flags (526). These flags are either administrative account creation or deletion flags (532) that define the privileges of the administrator to create or delete other administration accounts, and administrative account role privilege flags (534) that define the authorities of the administrator to assign specific administrative privileges to other administrators. The security administrator account (524) contain employee account administration flags (528) that allow the administrator to add and delete employee accounts (536), set system service privileges for different employee roles (538), and set data access privileges for different employee roles (540). In general security administrator privileges for both other security administration accounts and employee accounts are granted over those accounts at the same or lower level within the corporate hierarchy. The security administrator accounts (524) contain authentication data (530) for each administrator and for each access method that these administrators may use.

Employee accounts (542) contain the employee functional roles (544). Within each role there are defined set of system service flags (548) and data access flags (550). An employee can have several roles. For example, a single person can be a store manager, a shift administrator and a store service employee. Each employee account (542) contains authentication information (546) for each access method used by that employee.

Merchant employees and RO system administrators are organized into functions or “roles” that are used to simplify administration of permissions (for example to authorize refunds or to change merchant account information). These permissions are set through an administrative interface. Merchant employee permissions and roles are organized hierarchically in a manner that reflects corporate and ownership structure. Examples of levels in this hierarchy may include:

1. Corporate,

2. Geographic division or region,

3. Group of store or franchise group,

4. Store employees.

Roles within these levels include:

1. Financial manager,

2. Marketing or product manager,

3. Operations manager,

4. Franchise owner,

5. Store manager, and

6. Store employee.

Security Administration Interface

RO system administrators set and manage access rules for data and system services for both customers and merchant personnel (542) using the security administration interfaces. Rules and parameters set with the security administration interface are held in the security information store 34 (532, 534, 536, 538, 540, 548, 550).

The security administration interfaces are used to set authentication parameters for store POS and IT equipment. This information is used by the RO system to authenticate this equipment when a network connection is made.

Using the security administration interfaces, RO system administrators can set the levels of authentication required for customers for different types and values of transactions. Typical rules set through this interface would include transaction value limits for a given level of authentication, types of authentication acceptable for each category of wireless device used by customers, etc. Other rules that can be invoked include requiring a signature or verification of a picture identification to pickup an order, or activate a new account.

The security administration interface contains a hierarchy of security administration authority (see FIGS. 9A and 9B). Different levels within an organization (502, 506, 512, 518) can set the permissions and create accounts for personnel within their part of the company. Generally, security administrators can create or delete accounts for their level in the hierarchy or below. Thus, control of the administrative function is itself hierarchical. As an example, administrators at a corporate level can set permissions for corporate employees at the corporate, regional or divisional level. Administrators at the regional or divisional level can set permissions for personnel within that division or region including store managers, franchisees or store owners. Administrators at the store or franchisee level can set permission for personnel directly associated with that store or stores. Levels and authorities for company-owned stores within a chain are generally structured differently than for franchisee-owned stores. The security administration interface is used to create or delete new merchant employee and store location accounts.

Merchant Account Security Controller

The security manager 18 manages RO system security for 1) merchant employee login and authentication, 2) data access and service access, and 3) authentication of store POS or other IT systems. The security manager 18 makes use of the security information store 34 for authentication and access permission information (546, 548, 550). Permissions, access levels, and store system authentication parameters are set using the security administration interfaces.

For data or system service access for personnel the merchant account security controller authenticates (546) the person and determines the permissions for data (550) and service access (548). Authentication is done when personnel access the RO system over the merchant extranet 48 or through terminal or POS equipment at a store location. If personnel attempt to access data or services for which they are not authorized the merchant account security manager 18 will prevent them from doing so.

RO system administrators set merchant personnel data access privileges (550) and system service privileges (548) through the security administration interface. These permissions are set for groups of personnel generally by job function or role. As an example, corporate managers may have access to financial and sales reports for the entire chain of stores. Regional managers may be allowed similar access, but only for the stores they are responsible for. Corporate or regional marketing managers are able to introduce or remove products from the store information directory 36 or manage promotions. Customer Service Representatives have the capability to assist customers with account problems and issue refunds. Managers and owners of individual stores can typically only see reports for the stores they have authority over. Store managers, store owners or franchisees may have the final authority on which items are sold in their stores, the exact price to charge for each item and which promotions their stores will accept. Store managers, store owners or franchisees have the responsibility to enter and verify tax codes for the items sold in their stores. Supervisors are given authority to process refunds and adjustments to customer accounts. Both corporate and regional managers may be excluded from seeing detailed records of individual purchase transactions at stores owned by franchisees who are the only ones typically allowed to see such information.

A wide variety of POS and IT equipment needs to be automatically authenticated by the RO system. In addition data transmitted between the RO system and the IT equipment in the store is encrypted using a variety of means. The merchant account security controller uses a series of adaptors to accommodate the variety of authentication and encryption protocols encountered.

Customer Account Security Controller

The security manager 18 provides the transaction manager 10 with authorization (or not) for each customer-initiated transaction (including queries for information). The security manager authenticates the customer to a level required for each requested transaction. The security manager interfaces to the specific transport and security protocols used by the customer wireless or fixed wired electronic devices through the security protocol adaptors. Once the customer has been identified (and authenticated), they can perform a number of transactions using either the RO system or over the counter (generally by speaking to an employee or using a self-service kiosk). The security manager determines if the level of authentication is appropriate for the requested transaction. For example, a low value order and payment transaction may only rely on device identification for authentication, whereas a higher value transaction would require the customer to enter shared secret information (e.g. PIN or password). The customer account security controller can enforce limits on transaction values depending on merchant business rules. Once authorized by the security manager 18, transactions (orders and payments) are performed under the control of the transaction manager 10.

Customer Account

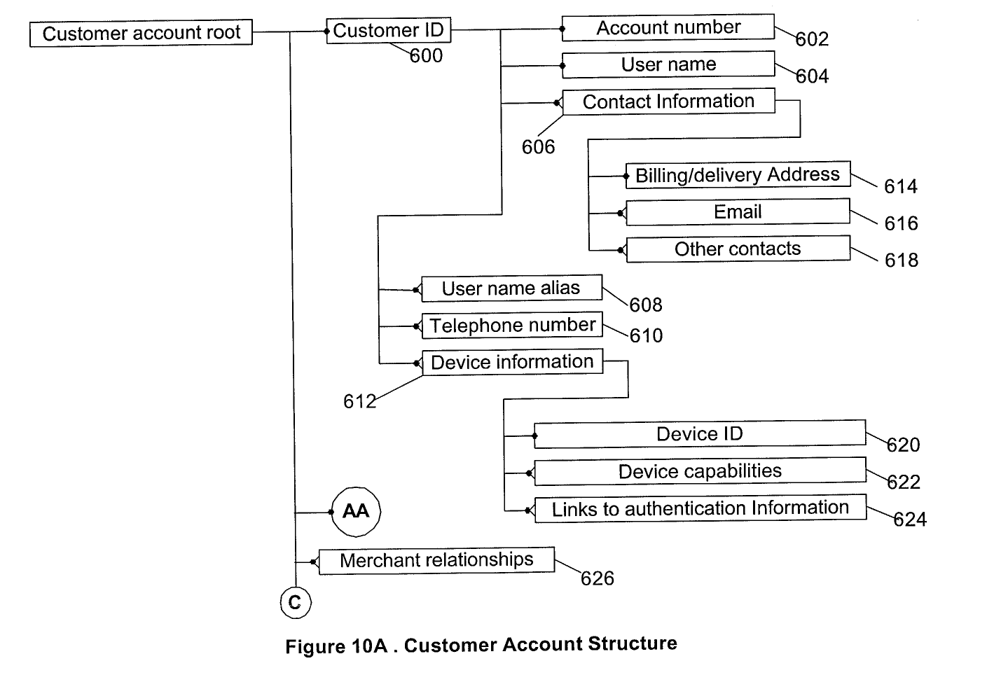

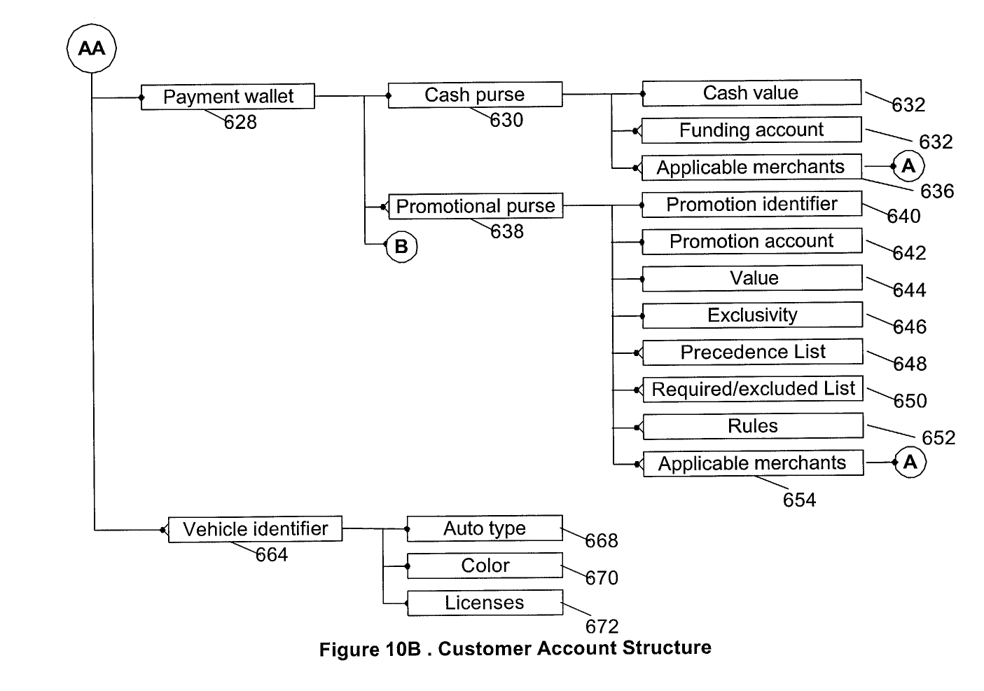

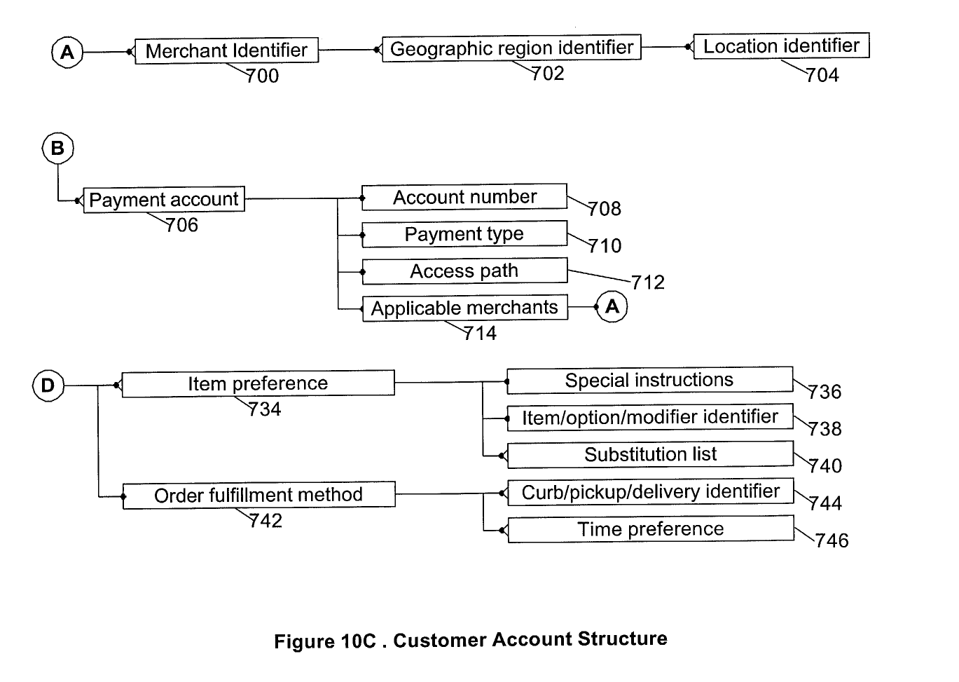

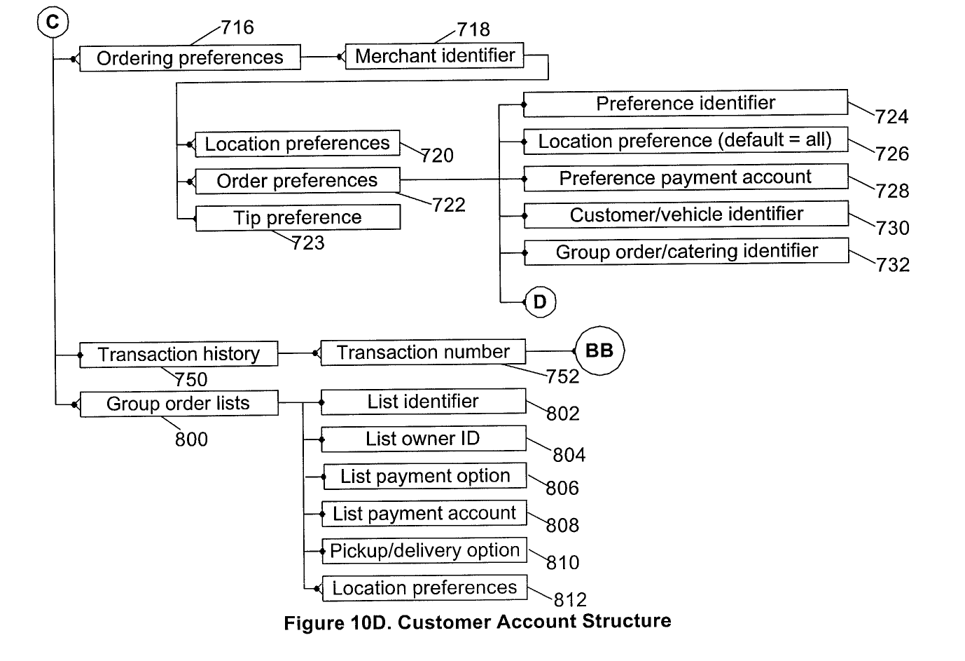

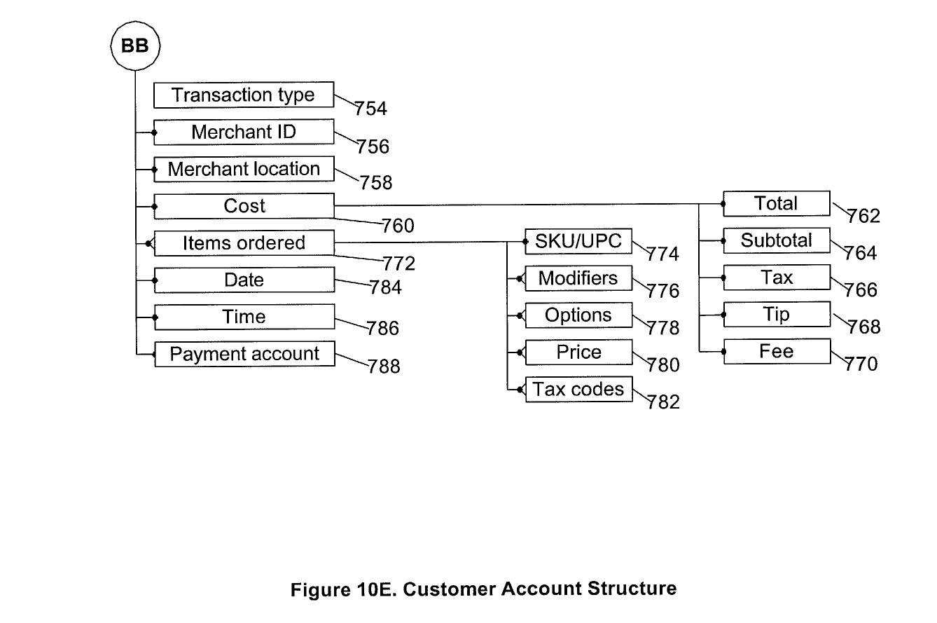

The customer account 28 contains information (or links to the information) required for customer remote order and payment transactions. The customer account is preferably stored in a relational database on a hard disk or other non-volatile memory. The customer account data in the non-volatile memory is accessed from the servers running the payment engine 12, the promotion engine 60, the transaction manager 10 and the customer access gateway 42. A schematic view of the customer account 28 is shown in FIGS. 10A, 10B, 10C, 10D and 10E. Data is either contained directly in the customer account table structures or is accessible via a link from the customer account. A single customer account can be used across multiple merchants. The customer account 28 includes a list of the merchants (626) with whom the customer has registered for service or who will allow the customer to perform transactions.

The customer account 28 includes information (or links to information in other database records) to identify (ID) the customer (600), and their access devices. Preferably, these data include:

1. A unique account number (602),

2. User name (604) used for account access,

3. Contact information (606) used to contact the customer and verify customer identity and which can include a billing and delivery address (614), an email addresses (616) and alternative contact information (618),

4. An alias name (608) used to identify the customer for order fulfillment,

5. Telephone number or other device identifiers (610), and

6. Device type or capability information (612) including device ID (620) such as IP address, device capabilities (622) for display, security, etc, and links to security information (624) stored in the security information store (34).

The customer account 28 includes a payment wallet (628) that contains all payment information in one or more purses. This payment information can include stored cash value purses (154) (i.e. a prepaid account), promotional value purses (638) or direct and payment account data (706).

One or more cash purses (630) (if present), contain information on the value in the account (632), the account used to electronically add funds to the stored value purse (634) and the merchants accepting the account (636).

One or more promotional purses (638) (if present), can contain:

1. Information identifying the promotion (640),

2. The merchant promotional account (642) against which the value of the promotion is debited (642),

3. The value of the promotion (644) to the customer,

4. The precedence (646) and exclusivity (648) rules and parameters for the promotion with respect to other promotions,

5. Lists of required or excluded items (650) in the order for the promotion to apply,

6. Rules for the application of the promotion (652) to the order, and

7. Merchants participating in the promotion (654).

The wallet (628) contains direct payment accounts (706). This account information includes the account number (708), the payment type (710), such as credit, debit, etc., the access path (712) or processor information, and the list of applicable merchants (714) who accept the payment type.

Each payment type has a list of applicable merchants (636, 654, 714) who accept that form of payment. This list contains a set of identifiers for merchants accepting the payment type, including a list of applicable merchant identifiers (700), a list of applicable geographic regions (702), and a list of applicable individual store locations (704).

For facilitating fulfillment of orders the customer account 28 contains data used to specify fulfillment method and identification of the customer. In the preferred embodiment, the customer account includes a delivery address (614), a customer vehicle description (664), including the auto type (668), color (670) and license number (672), for curb or drive-through service and an alias name identifier (602) used for anonymous identification of the customer. Order preferences can include the desired method of fulfillment (in-store pickup, delivery to home, office or other location, and curb pickup), and desired time for fulfillment (as a delay time from order or an absolute time and date).

The customer account 28 includes information to facilitate group and catering orders. For customers participating in an ordering group, the customer account 28 includes one or more ordering group lists (800), each with an identifier (802) to aid in selecting the group list to be used. The customer ID of the list owner (804) indicates the customer with the administrative or management authority over the list. The type of payment allowed (806) (i.e. corporate account for catering orders, or an account of the individual customer) and the payment account (808) to be used are indicated. Fulfillment options for pickup, curb service, drive-through, delivery (810) and store location preference (812) are indicated. The customer account 28 can include ordering preferences (716) for group or catered orders.

Customer preferences (716) are stored in the customer account 28. Each ordering preference contains an identifier for the applicable merchant brand (718). The preferences contain a list of locations for that merchant (720) at which the customer does significant business. The customer can choose to have a tip preference (723). Ordering preferences (772) contain all the information needed to place a complete order, which may include:

1. An identifier (724) for the preference used by the customer to conveniently select the preference,

2. A location preference (726) for the order if is one is desired,

3. The payment account (728), including cash purses, used for the order,

4. An optional vehicle or customer identifier (730),

5. An identifier linking the order preference to an ordering group (732),

6. A list of items to be ordered (734), generally identified by SKU, UPC or other product code, and including special instructions (736) for the item, a list of options and modifiers (738) for the item and a list of acceptable substitutes (740) for the item, and

7. Order fulfillment directions (742), including an identifier (744) indicating the type of fulfillment (curb, pickup, delivery) desired, and the time preference (746) (in terms of delay or absolute time) for order fulfillment.

The customer account tables contain customer transaction history data (750) (or links to this history, in for example the ledger system). A full record of all transactions is maintained. The report generator 22 uses this history to create reports for merchants and customers as allowed by the security manager 18. Each transaction is indexed by a transaction number (752) and includes all required information, which may include:

1. An indicator of the type of transaction (754), such as a refund or sale,

2. The ID of the merchant brand (756),

3. An indicator of the merchant store location (758) at which the transaction took place,

4. The cost of the transaction (760), including, as appropriate, parameters for the total cost (762), a subtotal (764) of the goods and services ordered, the applicable taxes (766), tip (768) and remote order or service fee (770),

5. A list of the items ordered (772), including, as appropriate, parameters for the SKU, UPC or other product identifier (774), modifiers for the item (776), options for the item (778), the unit price (780) of the item, and the applicable tax codes (782) for the item,

6. The date (784) of the transaction,

7. The time (786) of the transaction, and

8. The payment account (788) used by the customer.

The customer creates an account during a signup processes either before or during the first order. The customer can add new information or edit existing information at any time. Account creation can follow many paths, largely depending on the information requirements of the transaction desired and the customer's desires. Accounts can be created using a variety of user interface technologies including, graphical, text and telephone interfaces. A typical sequence of steps followed by the customer to set up an account would include the following; 1) establish a connection with the RO system, 2) select a user name, 3) select a password or PIN, 4) enter payment account information, 5) enter contact information, 6) fund SVA if one is to be used, 7) enter telephone number or device identifier, 8) select store location preferences, 9) select menu items for order preferences, and 10) place initial order. The RO system provides “wizards” and step-by-step indicators to guide the customer through the signup and initial order process. In one embodiment, these tools consist of set of instructions presented for each step and an indicator of which step of the total process the customer is at. When customers build orders or ordering preferences or a location preference list using text or graphical user interface technology, the RO system provides an indicator of the items and options or locations already selected. This aid allows the customer to quickly refer to the items, options or locations already selected.

Merchant Account

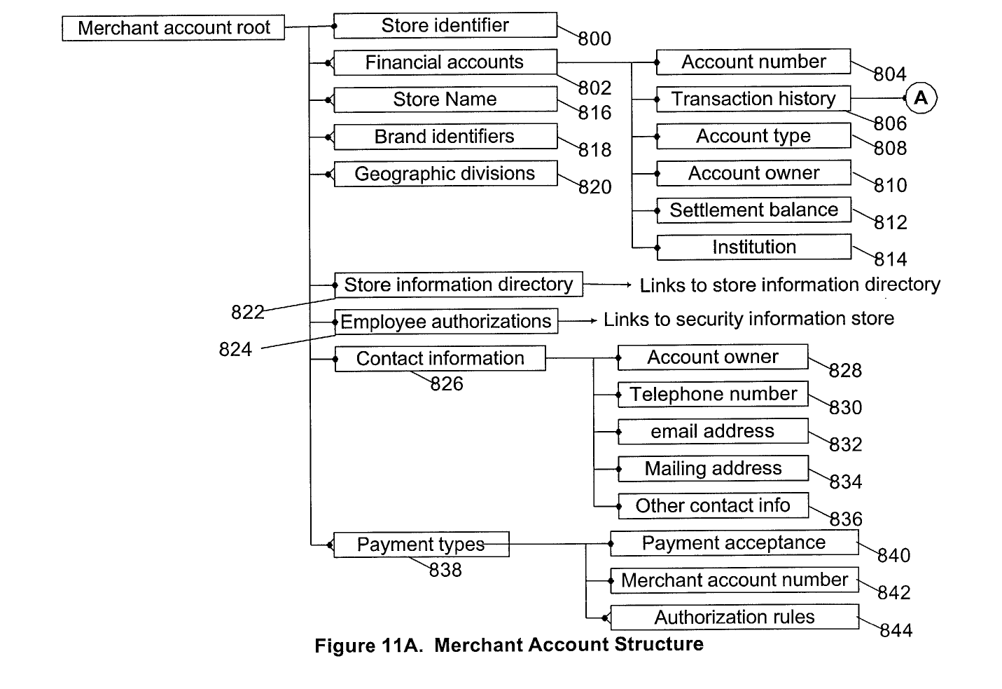

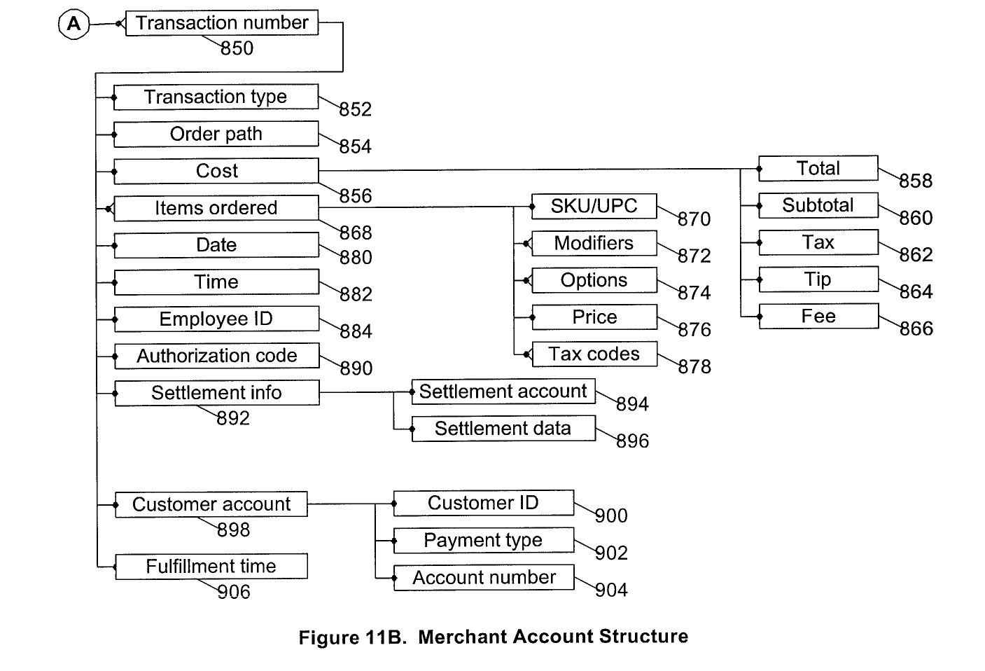

The merchant account 30 contains all information, or links to other data storage, required for a store location to accept remote order and payment transactions and perform settlement through the RO system. A separate merchant account is required for each store. The merchant account is preferably stored in a relational database on a hard disk or other non-volatile memory. The merchant account data in the non-volatile memory is accessed from the servers running the payment engine 12, the promotion engine 60, the tax engine 58, the transaction manager 10, the security manager 18, and the order delivery system 40. An example schematic diagram of a merchant account structure is shown in FIGS. 11A and 11B.

The merchant account 30 contains basic store information including a store number of other identifier (800), the store name or location name (816), geographic or other company divisions (820) the store is associated with, and one or more brand identifiers associated with the store (818). The merchant account contains (or has links to) one or more financial account records (802) showing all transactions at that store location, which may include:

1. The merchant account number (804) for that account,

2. The type (settlement, promotional, etc) of account (808),

3. The account owner (810), or merchant of record,

4. The current settlement balance (812) for that account,

5. The financial institution (814) holding the Demand Deposit Account, and

6. The transaction history (806) (or links to the ledger system) for that account, which may include,

a. the transaction number (850) for each transaction,

b. the transaction type (852) (refund, sale, etc.),

c. the order path (854) (telephone, call center, Internet, POS, etc.) for the transaction,

d. the cost of the transaction (856), including, as appropriate, parameters for the total cost (858), a subtotal (860) of the goods and services ordered, the applicable taxes (862), tip (864), which may include a shift identifier or identifier for individual employees, and remote order or service fee (866),

e. a list of the items ordered (868), including, as appropriate, parameters for the SKU, UPC or other product identifier (870), modifiers for the item (872), options for the item (874), the unit price (876) of the item, and the applicable tax codes (878) for the item,

f. the date (880) of the transaction,

g. the time (882) of the transaction,

h. the ID (884) of the employee handling the transaction,

i. employee authorization code (890) if required for the transaction,

j. the fulfillment and service time for the order (906),

k. settlement account (892) information including, the settlement account or DDA number (894), and settlement date (896), and

l. the customer account (898) used for the transaction including, the customer ID (900), the payment type (902) used, and the account number (904),

7. Links to the specific store information directory (822),

8. Links to the security information store (824) for the employees at the store location,

9. Account contact information (826), including the name of the account owner (828) or primary contact, the contact telephone number (830), the contact's email address (832), the mailing address (834), and alternative contact information (836) as may be required, and

10. The payment types accepted (838) by the merchant location, including a flag indicating acceptance (840), the merchant account number (842) for that payment type, and any authorization rules (844), such as value limits, need for signature capture, etc, for that payment type.

Store Information Directory

To allow customers to accurately remotely order and pay for goods and services agreement is required between the items, prices, promotional offers, service fees, and taxes offered at each specific store location and those shown in the RO system store information directory 36. The benefits of remote ordering are defeated if items shown in the store information directory are not actually available at the store, or items desired by the customer are not listed in the store information directory. To ensure the store information directory has the desired content for each store location from time to time it can either be automatically synchronized with the store's POS system or administered manually or some combination of both.

Nonetheless, the prices posted for the mobile commerce system need not necessarily be the same as those available in the store, but in general they are based on those prices. For example, the merchant may assess a surcharge or service fee. Alternatively, the merchant may offer discounts to encourage potentially lower cost electronic orders.

Merchants in chains of associated stores are generally organized into an overall brand or brands (a corporate entity can own more than one brand), geographic regions or sub-regions, groups of stores (including franchisee-owned groups) and individual stores. As discussed below, the store information directory 36 and the administration authority reflects such organizational structures.

The store information directory 36 is implemented using a suitable database management system (SQL Server from Microsoft, DB2 from IBM or Oracle 11i from Oracle Corporation). Servers running the order delivery system 40, the security manager 18, the transaction manager 10, the payment engine 12, the promotion engine 60 and the tax engine 58 may access the store information directory.

Directory Structure

Maintenance of an accurate database of items (goods and services) available and prices across locations of a chain of merchants can be a significant problem. Prices and items offered can vary from location to location, and each location can offer different promotional pricing, service fees, etc. The times of day that specific goods and services are available also vary from location to location.

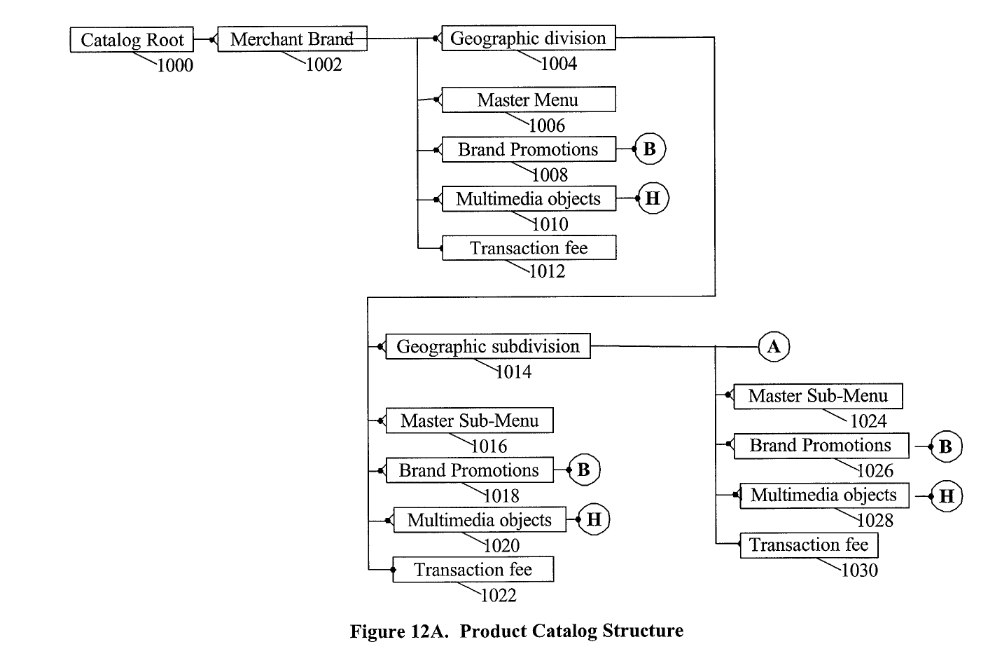

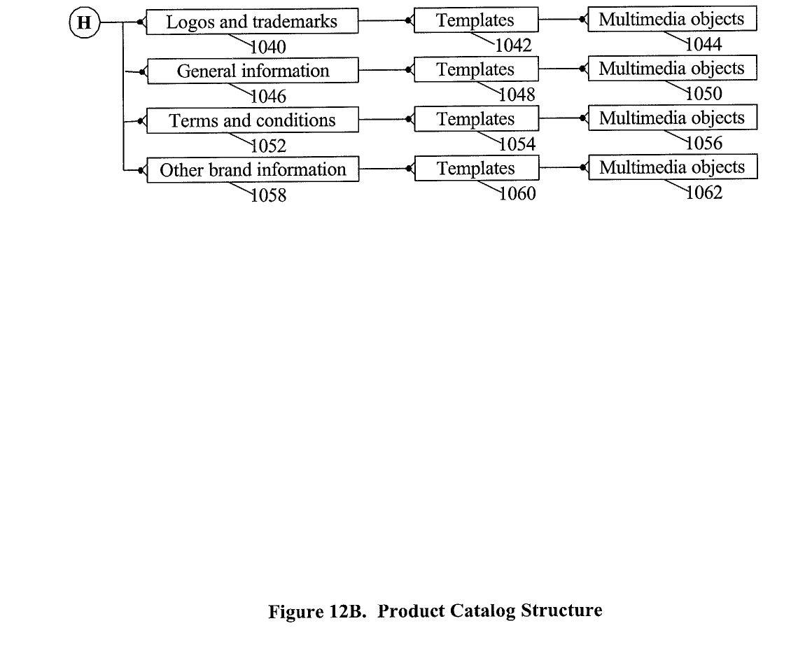

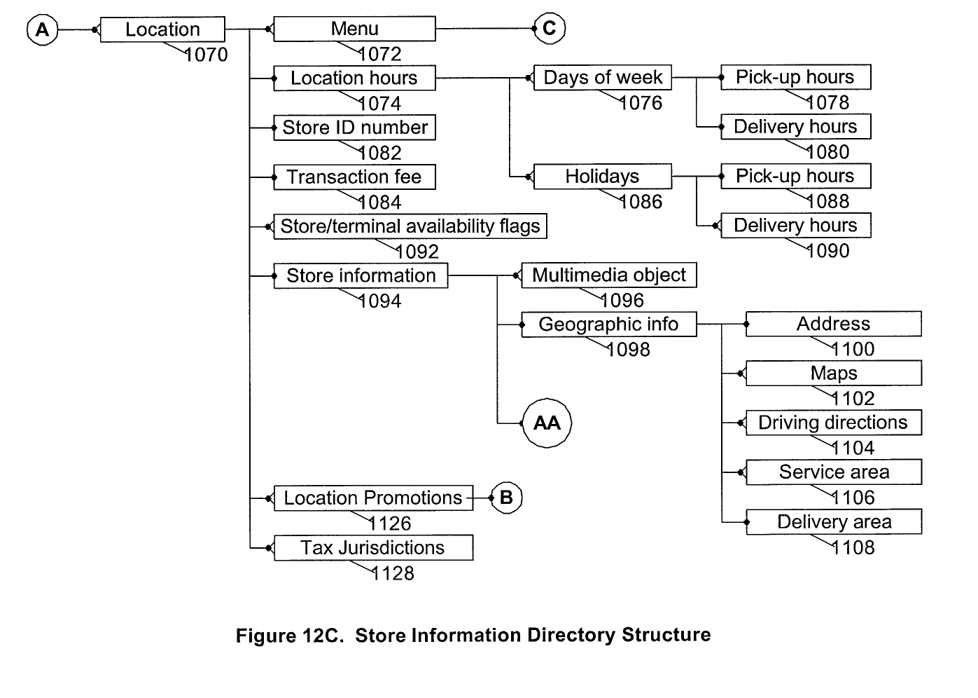

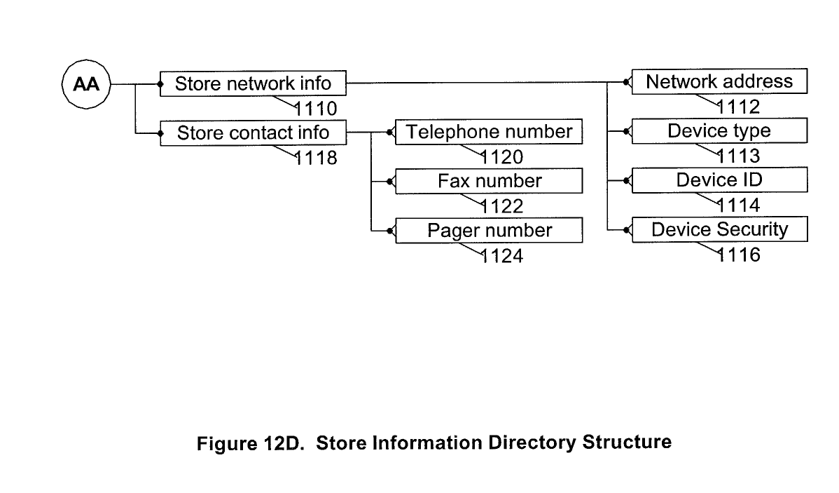

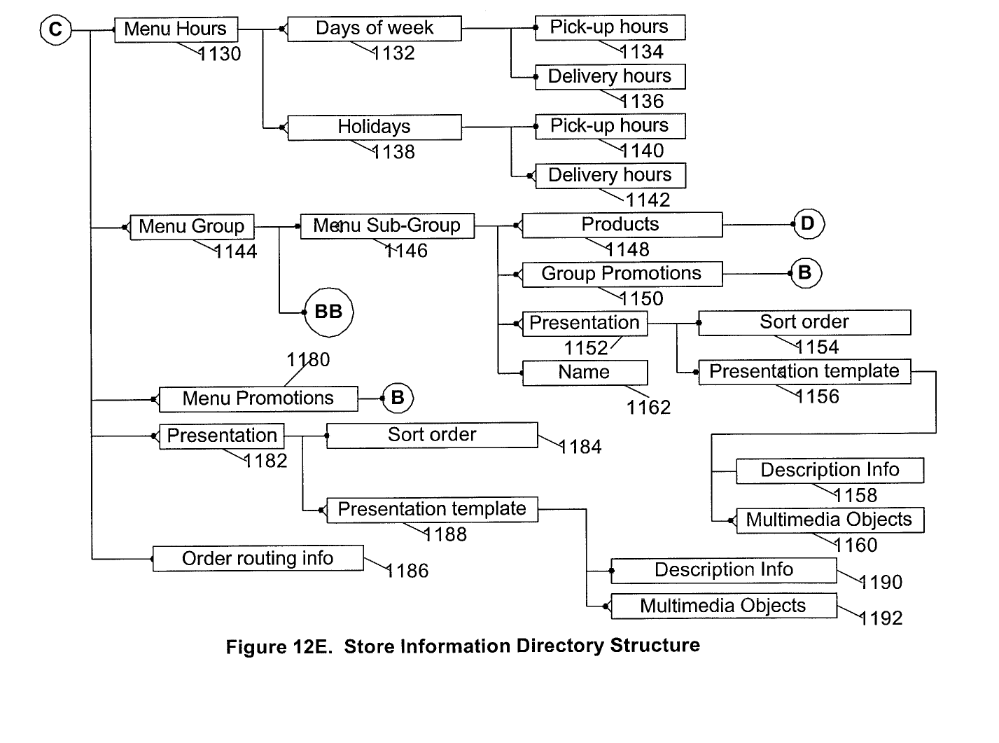

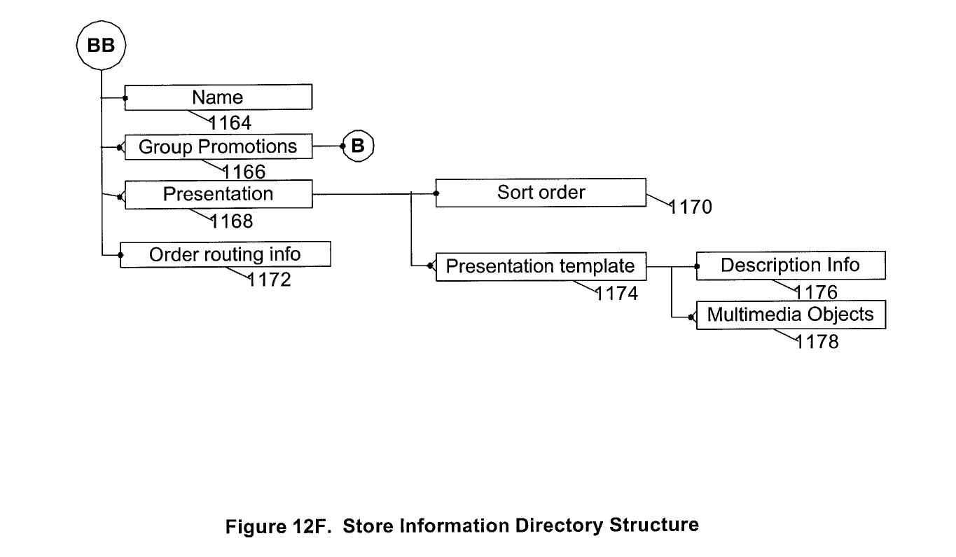

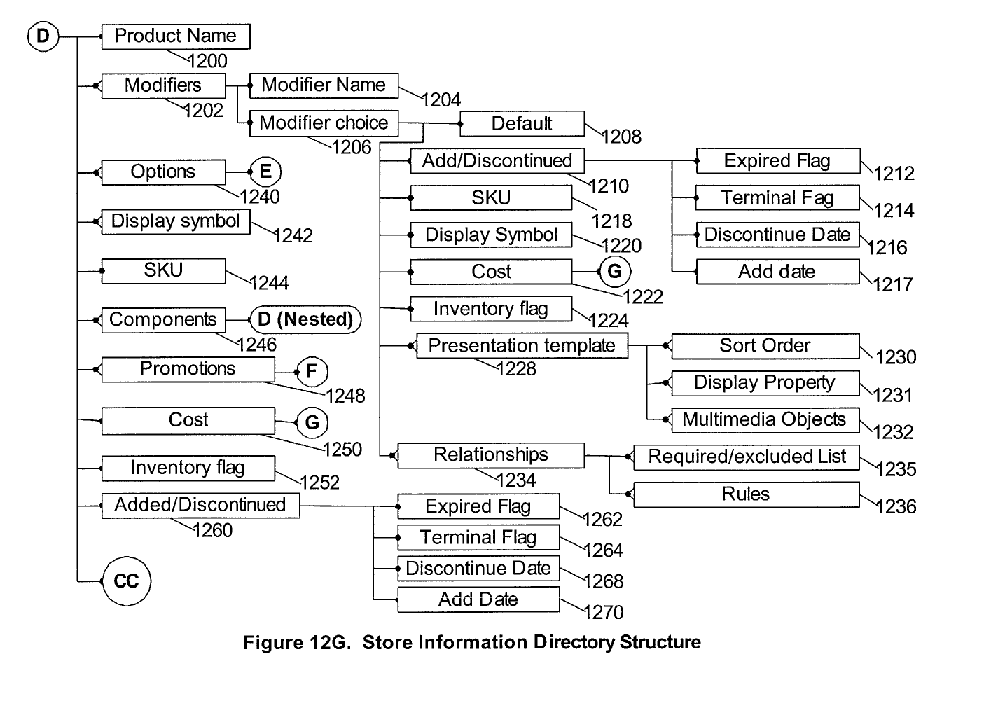

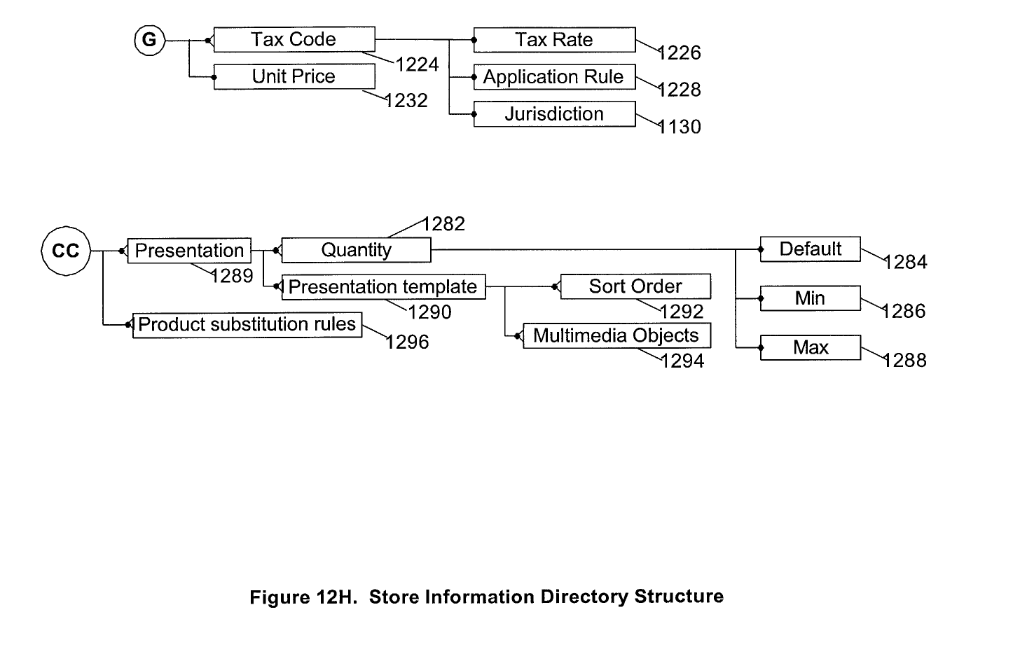

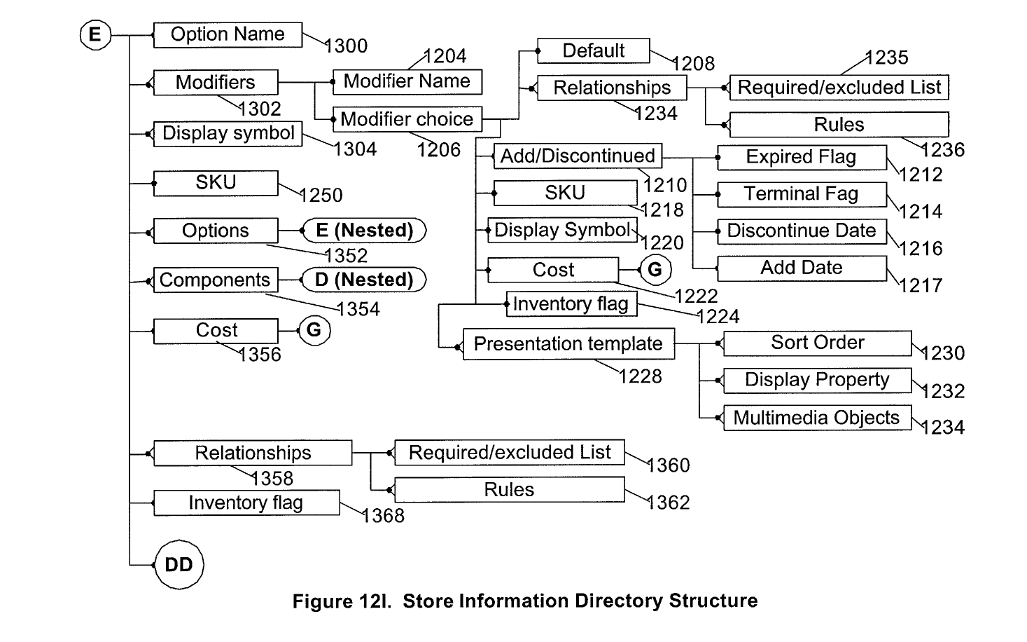

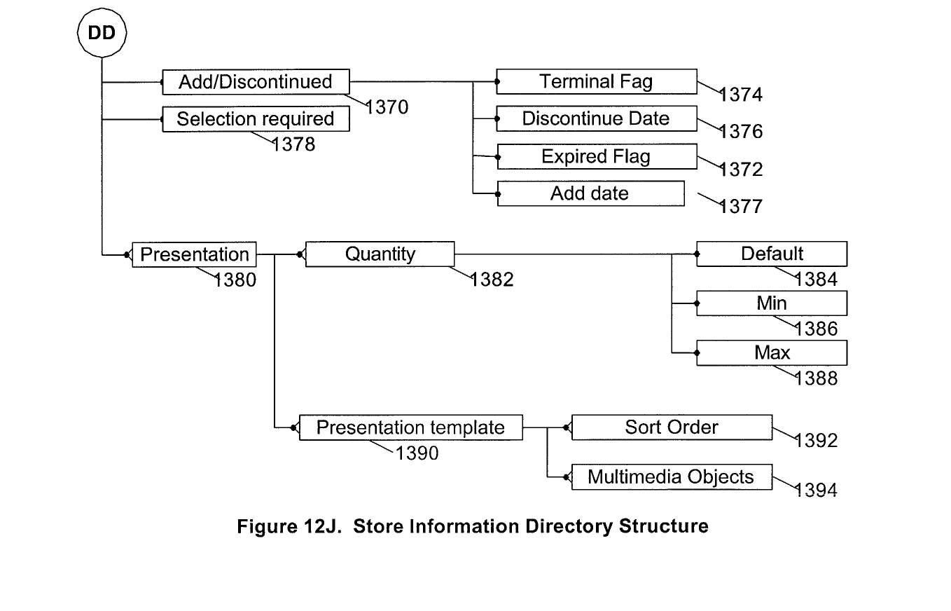

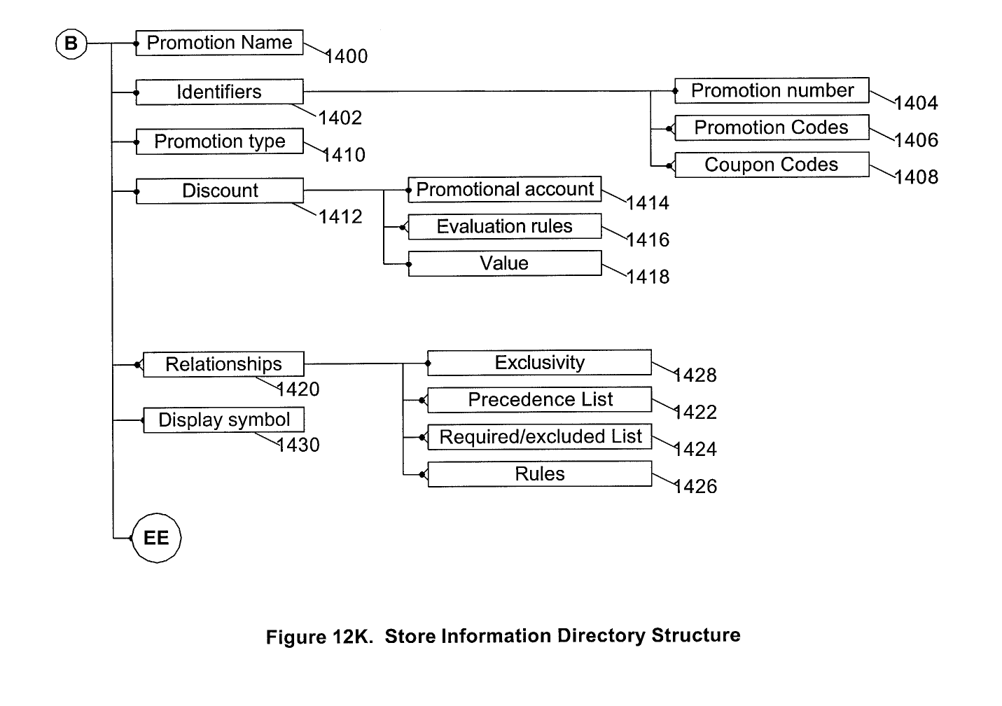

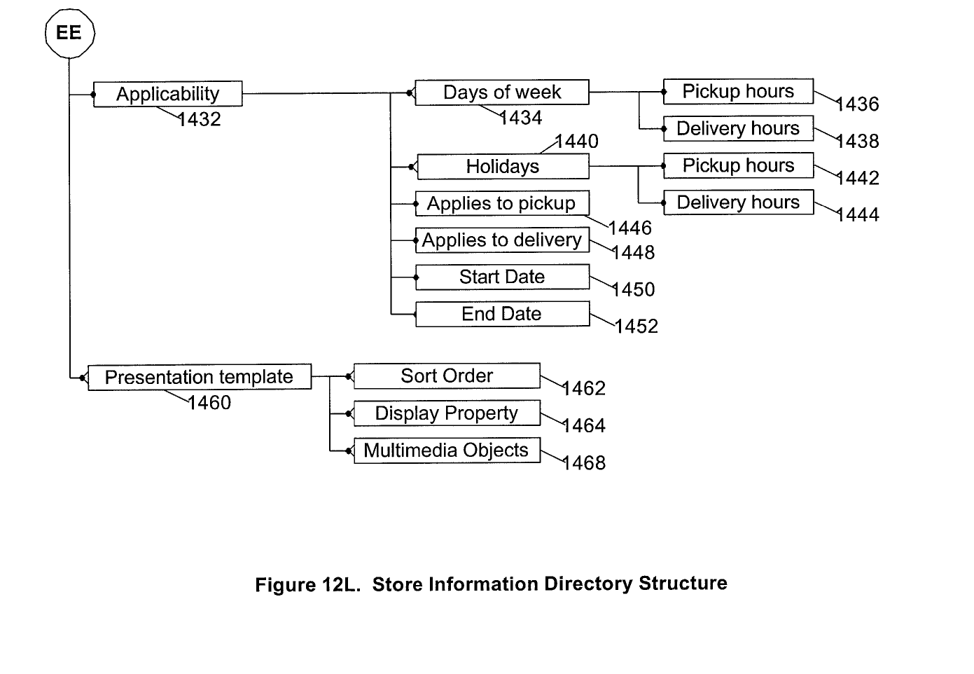

The preferred embodiment of the store information directory is shown in FIGS. 12A, 12B, 12C, 12D, 12E, 12F, 12G, 12H, 12I, 12J, 12K and 12L. It will be obvious to those skilled in the art that numerous schema structures could be used to achieve the same functionality. Relational, object-oriented and object-relational structures can all be used in the various embodiments. A variety of schema structures can be employed for this purpose and each particular structure will have advantages and disadvantages that will need to be optimized for the particular merchant application.

Several entities in the store information directory 36 contain both rules and parameters used when evaluating those entities. Examples of these entities include tax codes and promotions. The RO system is structured so that rules and parameters can easily be added at any time. Rules are coded in the Rule Markup Language (RuleML). In alternative embodiments rules can be coded in programming and scripting languages, including Java, Java Script, C, C++, Pearl, Visual Basic, TCL, etc. RuleML or scripting code is stored directly in tables or objects in the store information directory. In an alternative embodiment the store information directory includes links or pointers to the code or RuleML stored in files (including executable programs or plug-ins). Rules can include error conditions and links to descriptive messages indicating to the merchant personnel or customer what the error is.

Under the root (1000) of the store information directory are branches (1002) for each merchant brand. The merchant brands are themselves organized by geographic divisions (1004), subdivisions (1014), and ultimately locations (1070). The structure described here can easily support other types of corporate structures and need not be based on geography. Entities at each level in the hierarchy contain multiple attributes (or links to external tables or objects containing attributes). These attributes are used to display product and service information to customers and to correctly process orders within the RO system. These attributes are under the hierarchical control of the merchant personnel. The hierarchy of control is determined by the authority at the different levels of entities within the merchant's organization. It should be understood that this type of structure could have many levels beyond those described here.

Merchant brands (1002), geographic divisions (1004) and subdivisions (1014) contain master menus (1006) or submenus (1016, 1024). The use of these master menus simplifies the administration of the overall store information directory 36, by reflecting the authority or administration structure in the directory. Attributes and rules (required items, price ranges, item or category names, etc.) can be enforced from one level to the next as required. These master menus can contain information used in menus lower in the hierarchy. Using these master menus can thus speed directory administration at lower levels. Examples of global or regional attributes and rules include the following, a) the name of the chain or brand, b) brand or region wide promotions, c) logos or trademarks, d) policy statements, e) terms and conditions for customer use of the RO system, f) transaction or service fees, g) Frequently Asked Questions (FAQs), h) service fees, and i) display templates and objects for the brand or geographic region. To aid in administration and organizations levels in the hierarchical directory structure can be multiply linked to other levels beyond the ones immediately above and below. For example, attributes in a master menu can affect items at several levels:

1. The entire directory or menu,

2. A specific menu or sub-menu,

3. A type or category of items,

4. Required or non-required options for a type of category of items or compound items,

5. Specific items, and

6. Required or non-required options for a type of category of items or compound items.

In one embodiment keys linking relational tables can achieve this linkage. In another embodiment this linkage can be achieved by multiple inheritance between objects.

Merchant brands (1002), geographic divisions (1004) and subdivisions (1014) have brand promotions (1008, 1018, 1026) associated with them. These promotions apply to the entire brand, division, or subdivision. Transaction fees (1012, 1022, 1030, 1084) are stored and can be assessed at the merchant brand (1002), geographic division (1004), subdivision (1014) levels, and store location (1070). The merchant brand (1002), geographic divisions (1004), subdivisions (1014) and specific store locations (1096) can be associated with several multimedia objects (1010, 1020, 1028), which contain information of interest to customers. These multimedia objects contain logos and trademarks (1040), introductory and general information (1046), including frequently asked questions, terms and conditions (1052), and other information about the brand (1058) of interest to customers. Within each of these categories (1040, 1046, 1052, 1058) are templates (1042, 1048, 1054, 1060), used to present the multimedia object to customers using different types of wireless and fixed wired devices, and the multimedia objects (1044, 1050, 1056, 1062) holding the information. Each location (1070) contains one or more menus (1072) for goods and services available at that specific location. Menus can be invoked based on any set of rules. Examples of these rules include, time of day, day of week, season of the year, and customer order history or preferences. The store information directory 36 contains information required for customers to place remote orders to the specific store location (1070), which may include:

1. Hours for that store location (1074), with store hours (1078, 1088) and delivery service hours (1080, 1090) for each of the days of the week (1076) and holidays (1086),

2. The store identification number (1082),

3. The transaction fee (1084) for that store location,

4. Availability flags for the order delivery terminals (1092) at the store,

5. Information specific to the store (1094) possibly including,

a. multimedia objects (1096), which contain information of interest to customers and can include images, audio, video and text,

b. geographic information (1098) specific to the store of information of customers, which can include, the store address (1100), electronic maps (1102) showing the location of the store, driving directions (1104) to the store, service area (1106) covered by store location using several possible geo-coding methods, and delivery service area (1108) for the store location using several possible geo-coding methods,

c. Network information (1110) for the terminals in the store, which can include the network address (1112) for the terminals, device time (1113) information indicating the capabilities of the terminal and the data formats used by the terminal, the device ID (1114) of the terminal, and device security (1116) information of the terminal, and

d. contact information (1118), including alternative order transmission path information, for the store, which may include telephone number (1120), fax number (1122), and pager number (1124),

6. promotions specific to the store location (1126), and

7. The applicable tax jurisdictions (1128) for the store location.

Master menus (1006), master sub-menus (1016, 1024) and store specific menus (1070) may contain hour information for that specific menu (1130) by days of the week (1132) and holidays (1138) for pickup service from the menu (1134, 1140) and delivery service hours (1136, 1142). Master menus (1006), master sub-menus (1016, 1024) and store specific menus (1070) are comprised of one or more menu groups (1144), to aid customers in locating goods and services or interest, which can be comprised of;

1. One or more menu subgroups (1146), which may contain:

a. the individual products (1148) or services the customer can order,

b. promotions (1150) applicable to the menu subgroup,

c. a name (1162) designator for the menu subgroup, and

d. presentation (1152) information for the menu subgroup, which can include, the sort order (1154) for presentation of the menu group with respect to other menu groups, and templates (1156) to present the menu group to customers, including descriptive information (1158) for the menu group, and multimedia object (1160) to present information to customers on the menu group,

2. A name (1164) designator for the menu group,

3. order routing information (1172) indicating which terminal at the store that the order information is to be routed to

4. Promotions (1166) applicable to the menu group, and

5. Presentation (1168) information for the menu group, which call include:

a. the sort order (1170) for presentation of the menu group with respect to other menu groups, where sort order can be set by directory administrators or can be computed based on rules, such as frequency of use or promotional status, and

b. templates (1174) to present the menu group to customers, including descriptive information (1176) for the menu group, and multimedia object (1178) to present information to customer s on the menu group, which can include images, audio, video and text.

The one or more menu groups (1144) and subgroups (1146) contain one or more products (1148), which may have:

1. A product name (1200) used by the customer to identify the item,

2. A list of modifiers (1202) for that item,

3. A list of options (1240) for that item,

4. Display symbols (1242) used to present the item in orders to merchant employees,

5. The SKU (1244), UPC or other product code for the item,

6. Components (1246) of which the item is composed, which themselves can be items or parts of items in a recursive relationship to any depth,

7. Promotions (1248) applicable to the item,

8. Cost (1250) of the item,

9. An inventory flag (1252) indicating the availability of the item at the store location,

10. Indicator for when the item is added or discontinued (1260) to the menu, which may contain a flag (1262) indicating the item availability is expired, a flag indicating the modifier is in the terminal phase (1264) of its life, the date the item is or will be discontinued (1268), and the data on which the item is to become available (1270),

11. Information for the presentation (1280) of the item to customers, which may include:

a. the quantity (1282) information for the item in an order, which may include a default (1284) quantity, and minimum (1286) quantity in the order and a maximum quantity (1288) in the order.

b. templates (1290) to present the item, including the sort order (1292) for the item with respect to other items in the menu, where sort order can be set by directory administrators or can be computed based on rules, such as frequency of use or promotional status, and multimedia objects (1294) to present the item of information of interest on the item to customers, which can include images, audio, video and text, and

12. Rules for product substitution (1296) which tell the transaction manager.

Modifiers (1202) are customer selections that do not change the composition of an item but more completely specify it, such as color, flavor, and size. Modifiers can themselves have modifiers. A selection of a modifier may be required to make the specification of the product complete. Modifiers (1202) are referenced by customers by name (1204) and once selected the customer is presented with one or more modifier choices (1206), which may include:

1. A default choice (1208) used if customer selects no other modifier,

2. Indicator for when the modifier is added or discontinued (1210) to the menu, which may contain a flag (1212) indicating the item availability is expired, a flag indicating the modifier is in the terminal phase (1214) of its life, the date the modifier is or will be discontinued (1216), and the data on which the modifier is to become available (1217),

3. The SKU (1218), UPC or other product code for the modifier,

4. Display symbols (1220) used to present the modifier in orders to merchant employees,

5. Cost (1222) of the modifier, which may be zero or negative,

6. An inventory flag (1224) indicating that the modifier is available at the store location,

7. A set of presentation templates (1228) for the different types of wireless or fixed wired devices that may be used by customers, which may include a sort order (1230) for display of the modifier with respect to other modifiers, where sort order can be set by directory administrators or can be computed based on rules, such as frequency of use or promotional status, one or more display properties for the item (1231) and multimedia objects (1232) containing information of interest to customers about the modifier, and

8. A list of modifier relationships (1234) contain rules for application of modifiers, for example, an item cannot have two colors, or have more or less of an option.

Options (1240) are either components that have multiple choices or additions to the basic product. Options can themselves have options (1352). A selection of an option may be required to make the specification of the product complete. Customers identify options (1240) by using an option name (1300). Options (1240) can have modifiers (1302), which have essential have the same parameters already described (1204, 1206, 1208, 1210, 1212, 1214, 1216, 1217, 1218, 1220, 1222, 1224, 1228, 1230, 1231, 1232, 1234, 1235, 1236). Options may include attributes:

1. Display symbols (1304) used to present the options in orders to merchant employees,

2. The SKU (1250), UPC or other product code for the option,

3. Options (1240) themselves can have options (1352) which can be recursive or nested,

4. Options (1240) are composed of components (1354) of which the option is composed, which themselves can be items or parts of items in a recursive relationship to any depth,

5. The cost (1356) of the option,

6. Relationships (1358) for the option which include required or excluded (1360) items or options (i.e. some options preclude the use of other options) and rules (1362) to apply these relations,

7. An inventory flag (1368) indicating that the modifier is available at the store location at the time of the order,

8. Indicator for when the option is added or discontinued (1370) to the menu, which may contain a flag (1372) indicating the option availability is expired, a flag indicating the option is in the terminal phase (1374) of its life, the date the option is or will be discontinued (1376), and the data on which the option is to become available (1377),

9. An indicator that the customer is required (1378) to make a selection for an option from the option list (1240) or sub set of the list, and where a default option and quantity can be supplied, and

10. Information for the presentation (1380) of the option to customers, which may include:

a. the quantity (1382) information for the option in an order, which may include a default (1384) quantity, and minimum (1386) quantity in the order and a maximum quantity (1388) in the order.

b. templates (1390) to present the option, including the sort order (1392) for the option with respect to other options in the menu, where sort order can be set by directory administrators or can be computed based on rules, such as frequency of use or promotional status, and multimedia objects (1394) to present the item of information of interest on the item to customers, which can include images, audio, video and text.

Cost (1250, 1222, 1356) for each item in the menu consists of a unit price (1232) and an applicable tax codes (1224). Each tax code (1224) is comprised of a tax rate (1226) or tax table, a jurisdiction (1230) in which the tax is applicable, and to whom the tax is paid, and the rules (1228) for the application of the tax code. It will be understood that tax codes generally apply to broad classes of items (hardware, sandwiches, clothing, groceries, etc.) and thus can be administered efficiently by item category with links from the individual menu items to the tax codes. Rules applicable to tax codes may include:

1. Dates for which the tax code is applicable,

2. Quantity of the item being purchased,

3. Total cost of the order (both before or after promotional value),

4. treatment of promotional value applied to the item,

5. Rounding rules, including, ignore digits after the count defined with required precision, round up the last digit always, round down the last digit always, and round up or down based on the cost of the order or number of items ordered,

6. Presence of tax exempt numbers or codes for the customer, and

7. Limits (maximum or minimum) on the tax.

Promotions (1008, 1018, 1026, 1126, 1182 1166, 1150, 1248) can be associated with merchant brands (1002), geographic divisions (1004), geographic subdivision (1014), location (1070), a menu (1072), menu group (1144), menu subgroup (1146), and products (1148). Regardless of the level of application the promotions in the store information directory 36 the promotions may include:

1. A name (1400) which the customers use to identify the promotion,

2. Internal identifiers (1402) for the promotion, which may include a promotion number (1404), promotion codes (1406) for tracking the promotion usage, and coupon codes (1408) to tie electronic promotions to paper coupons and advertisements,

3. An indicator of the promotion type (1410),

4. a display symbol (1430) used to communicate to merchant employees that the promotion is applicable to the order and what the promotion is,

5. The discount (1412) applied for the promotion, which may include, the merchant's promotional account (1414) to which the value of the promotion is debited, evaluation rules (1416) used to determine the value and applicability of the promotion, and the value (1418) parameters of the promotion,

6. Relationships (1420) for application of the promotion, which may include:

a. exclusivity (1422) parameters of the application of the promotion to the order verses other promotions,

b. the precedence (1424) for this promotion with respect to the applicability of other promotions,

c. a list of items in the order that must be included or excluded (1426) for the promotion to be valid, and

d. rules (1428) for the application of the relationship parameters,

7. The applicability (1432) of the promotion, which may include:

a. applicable hours for the promotion by days of the week (1434) and holidays (1440) for service for pickup (1436, 1442) and delivery service (1438, 1444),

b. an indicator that the promotion applies to pickup (1446) orders,

c. an indication that the promotion applies to delivery (1448) orders,

d. the start date (1450) of the promotion,

e. and the end data (1452) of the promotion, and

8. A set of presentation templates (1460) for the different types of wireless or fixed wired devices that may be used by customers, which may include a sort order (1462) for display of the promotion with respect to other promotions, where sort order can be set by directory administrators or can be computed based on rules, such as frequency of use or priority, one or more display properties for the promotions (1231) and multimedia objects (1232) containing information of interest to customers about the promotions.

Distributed Store Information Directory

In an alternative embodiment, the store information directory can be distributed between a number of systems under the control of multiple entities. Some information is stored within the RO system, while other information is accessed in real-time through links from the RO system store information directory to external systems and data repositories. This embodiment has the advantages that specific items of information need only reside and be administered only in one location. As required, the information can be cached from the remote sources in the RO system store information directory as required by performance, network cost and reliability considerations.

For example, specific items, options, taxes and prices offered at each store location are obtained from the store POS system through the order delivery system 40. Other store information directory information is obtained from data stored directly within the RO system's store information directory 36 and which may not be available in external sources. Examples of information stored in the RO system's store information directory includes:

1. A master menu or store information directory for all locations or a geographic region (used for building ordering preferences),

2. Hours during with the menu or sub-menus is available for remote ordering at that store location (which can differ from normal store hours),

3. Special remote order promotional pricing and rules,

4. Service fees or surcharges applicable to that store location,

5. Store location information,

6. List of items not available for remote orders, and

7. List of items only available by remote order.

In this embodiment the distributed RO system store information directory 36 can have a relational, object oriented or object relational structure. In any case the distributed store information directory contains structures or objects that contain the data that are held within the RO system and references to data sources external to the RC) system. The leaves to the store information directory tree to contain the actual data values, a query string and network path to retrieve the data values, or the cached data value and query string and network path.

Automatic Store Information Directory Synchronization

To maintain agreement between the products offered in the each store and those available through the RO system the RO store information directory 36 must be synchronized with information used in the store. Synchronization can be achieved by automatic means between the RO system and the POS system at the store, using a manual online management tool, or a combination of both. In both cases changes and updates to the RO system can occur immediately or can be staged for later deployment or publication.

The schema used to store the elements of the RO system store information directory 36 need not be the same as the schema used in the product catalogs in merchant POS or other IT systems for synchronization to occur automatically. The schema used in the RO system uses a superset of the elements in each individual store POS system's catalog (to accommodate differences between locations) and the structure of the schema are likely different.

Numerous well known Information Technology (IT) techniques can be used to synchronize product information databases or product catalogs and it should be clear to those skilled in the art that numerous embodiments can be employed to achieve the required functionality. In one embodiment, a Simple Object Access Protocol (SOAP) client is resident on the POS system server and formats product catalog or inventory information into a schema based on the Extensible Markup Language (XML). The RO system initiates a query to the network address where the source of the information resides. The SOAP client reads the information needed to populate the XML. schema using either Open Database Connectivity (ODBC) or Java Database Connectivity (JDBC) connections which are supported by nearly all vendors of Database Management Systems (DBMS). An adaptor in the RO system receives product directory or product catalog data in the RO system and populates the RO system Store information directory 36. In an alternative embodiment, the POS system database produces a series of files (typically referred to as “flat files”), which contain product catalog information. Multiple files and possibly from several databases or systems, may need to be produced to gather all the information required to populate the RO system store information directory. These files are transmitted over a network to an adaptor in the RO system where they are assemble into a complete data set and used to populate the store information directory.

In yet another embodiment, the RO system store information directory 36 is populated from a number of data sources within the merchant group's IT infrastructure. These data sources can be under the control of various entities within the merchant's organization including corporate level, division or region level, group of stores or franchise group, and individual store level. These data sources are distributed based on levels of control and methods used to publish product information to POS and other IT systems at the store level. These data sources are integrated with the RO system store information directory, using known or emerging IT data integration methods, including those described above for POS integration above. The data from the various sources is assembled by the adaptors in the RO system and used to populate the store information directory on an individual store basis or regional basis. It should be clear to those skilled in the art that there are many possible embodiments for synchronizing a store information directory from distributed or disparate data sources that can all achieve the same results.

The RO system receives store information directory data from the various data sources over a data network. Conditions that can be used to initiate the transmission of store information directory data include, 1) the RO system periodically polls the data sources, 2) the data sources periodically transmit data to the RO system, and 3) the data sources “publish” to the RO system when there is a change. Data records sent by any of these methods can be limited to only that data which has changed since the last update or can be the complete data set. If partial or updates are transmitted the full data set is typically transmitted periodically to ensure accurate synchronization.

Occasionally, the store information directory data transmitted to the RO system will contain errors, corruption or will be incomplete. There exist known IT techniques for detecting and dealing with this these types of situations, and it should be understood that many embodiments would produce the desired results. In one embodiment, the RO system would request retransmission of the required data from the original data source. If this fails or is not possible, the RO system triggers an alarm to notify personnel of the situation. These personnel can either take corrective action to fix a technical problem or repair the data using the store information directory administration tools described below.

Store Information Directory Administration

The store information directory administrative tools can be used to update information (data and rules) provided during automatic data synchronization (described above), or to provide data or data relations that cannot be obtained automatically. All parameters and attributes in the store information directory 36 can be entered, or edited though the store information directory administration tools. The administration tools contain templates, wizards and other aids to allow inexperienced users to administer the directory.

For data obtained through automatic synchronization and subsequently updated through the administrative interface, a permanent manual override is put in place to prevent overwriting the data during the next automatic update. The override can be removed at a later time as required.

The security controller regulates access permission to the services of the store information directory administration tools. Store information directory administration tool permissions are organized hierarchically to reflect the authorities and responsibilities of the different levels within the merchant's organization including:

1. Corporate,

2. Regional or divisional,

3. Group of stores, or

4. Individual store.

As allowed by the security controller, store information directory attributes and parameters can be changed for geographically specific regions including:

1. All store locations,

2. Stores in a particular geographic region,

3. Stores under a specific company division,

4. Stores in the same ownership group or franchise, and

5. Individual stores.

Store information directory attributes and parameters can be controlled at a number levels in the directory including:

1. Globally for all sub-menus or menus,

2. Across a sub menus or menu,

3. For a category or type of item or promotion,

4. For a specific item, option, modifier or promotion.

The effective data and time of store information directory changes can be set through the store information directory administrative tools. These date and time parameters can apply to parameters and attributes that are input manually though the store information directory management tool or are updated automatically from external data sources. Updates can take effect instantaneously or can be staged to take effect at a later date and time. The effective date and time of store information directory changes can be for a limited period. A date and time can be set for the expiration of the change. Alternatively, a time period for the change effectiveness can be set. In either case the parameter or attribute will revert to the original value or a default value following the expiration of the change.

The RO system logs all changes to the Store information directory 36 for later reference, reporting and audit purposes. These logs include the following information:

1. The person making the change,

2. Corporate organization, department or level of the person making the change,

3. The items changed,

4. Values changed,

5. Time and date of the change,

6. Date and time the change become effective,

7. Date and time the change is no longer effective (if applicable).

The store information directory administration tool is used to add or delete a store from the merchant chain. The store information directory instance for that location can be created or destroyed. In addition, the store information directory administration tool can be used to add or delete the merchant account information. Using this tool, merchant personnel can add or delete store locations from the remote ordering service.

The administrative tool includes a textual and graphical interface showing the various data and rule sources and the data values contained within them. Choices for data, rules and sources are presented in an order required to ensure systematic and complete definition of the RO system store information directory. The administrator selects the sources and data or rules required to define each aspect of the store information directory using these tools.

Administration of Distributed Store Information Directory

In an alternative embodiment the store information directory administration tool is extended to include facilities for the management of the relationships in a distributed store information directory that may be in multiple systems and under the control of several entities. In this alternative embodiment the store information directory administration tools contain all of the facilities described in the first embodiment. This version of the administration tool operates under the supervision of the security manager 18 as in the first embodiment.

The additional features of this administration tool include, 1) the ability to insert one or more links or references to other data sources accessible over a network, 2) set precedence rules for the evaluation of possibly conflicting data in the various referenced internal and external sources, and 3) set overrides on data elements or groups of data elements that will use the RO system's own store information directory as its source. If the required data (or desired value of the required data) cannot be located in the external sources, it is entered by the administrator and stored in the RO system's own store information directory.

As with the first embodiment of the administration tool, store information directory changes can take effect immediately or can be staged to take effect at a later date and time. The effective date and time of store information directory changes can be for a limited period. A date and time can be set for the expiration of the change. Alternatively, a time period for the change effectiveness can be set. In either case the parameter or attribute will revert to the original value or a default value following the expiration of the change.

Directory Data Validation and Verification

When new attributes, parameters, links and rules are added to the product they must be verified or validated to ensure that they are correct and that (especially in the case of rules), they do not create conflicts or deadlocks with existing rules, parameters and attributes. Further, leaves of the directory can be inadvertently left empty or links for synchronization of directory information data can be incorrect. When changes are entered into the RO system store information directory, either automatically or manually, a series of automatic test scripts are triggered.

The scripts exercise the functions of the store information directory 36 and the order manager. The scripts can build specific test cases dynamically depending on the exact content of the store information directory 36. For example, the script will build test cases that test the combinations of menu rules, tax rules and promotion rules, etc. present in the directory. Outputs from the test cases are compared to pervious output and the exceptions noted. Output from the execution of the test cases is also displayed to the directory administrator. Exceptions are highlighted in graphical and textual format in this output. The administrator needs to either approve the change in behavior or change the rules, attributes or parameters if they are in error. If deadlocks or conflicts are detected, the test scripts provide diagnostic output to the administrator, who must then resolve the difficulty.

The test cases and test scripts themselves are managed through an administrative interface. Access to these services is under the control of the security manager 18. Using the administrative interface, test cases can be created, deleted and modified. The tool highlights using a textual and graphical UI store information directory data or rules that are not covered in any test script of test case and need to be included. The test case and script administrator must execute the scripts and cases and verify the results before changes can be made permanent (published to the system).

The test case and script administration tool includes textual and graphical indications or where data sources and rules sources reside. The tool highlights data or rules sources that are not covered in any test script of test case and need to be included. The administrator uses these tools to ensure that all queries evaluate correctly and unambiguously.

Distributed Directory Verification and Validation

In the alternative embodiment of a distributed store information directory 36, automatic test scripts and test cases are used to verify the store information directory. These scripts and cases include all of the functions described in the first embodiment. In addition these test scripts and cases include facilities to include the validation and verification of data and rules contained and under control of external data sources and systems.

Store Information Directory Presentation and Customer Interaction

Presentation of the store information directory is essential to customers being able to effectively use the RO system. Presentation services for the store information directory must be available in many formats, including, audio, text and graphics. For this reason the store information directory is presented using the services of the Customer Access Gateway with its adaptors. Using the store information directory presentation services, customers select goods and services to order directly (immediately) or create ordering preferences for later use by selecting them from the store information directory. It should be clear to those skilled in the art that various established and emerging User Interface (UI) technologies can be used to display and perform customer interaction.

At the customer's option the store information directory can be displayed for an individual store location of choice. Alternatively, a directory for a geographic region (a city, county, state or section of a country) can be displayed. Directories for individual stores would generally be used for direct ordering or creating ordering preferences for a specific store location. A directory display for a specific region is used for creating ordering preferences that can be used at a number of stores in that region.

For each geographic region or individual store, a number of sub menus or menus can be presented. The customer can choose the sub-menus or menu of interest or the RO system can display a default sub-menu or menu based on the time of day, day of week, date, presence of holidays, etc. Sub-menus and menus are organized and presented hierarchically. Categories or types of goods or services are presented at the top level of the hierarchy. Individual items or closely related groups of items are presented within these categories, with details, options, sizes, etc. presented at the lower levels. Depending on attributes in the Store information directory, the most popular items will be displayed on top of the menu or presented first in the speech dialog. In an alternative embodiment, promotional items, items new to the merchant, or items the merchant wishes to highlight are presented first. These promotions can apply to the entire merchant brand, a geographic region or a single store location. In either case, items with the same priority or precedence are presented in a default order (e.g. alphabetical, by brand, etc.). It is clearly possible to combine several algorithms for determining presentation order on a precedence basis.

Search tools and alphabetical indexes help the customer find specific items, or store locations of interest. Items indexed for reference or search include, 1) product name, 2) product category, 3) product type, 4) brand name or manufacturer name, and 5) product property. The search tools and indexes can be applied to all sub-menus or menus or a specific menu. Search tools and indexes can also be applied to product information to all stores, stores in a geographic region or an individual store.

Choices and options for compound items or items with choices are presented either on the same page or dialog or in a page or dialog presented once the item is chosen. In one embodiment, options are presented in a pop-up window. Special instructions for the item can be included using text or voice input.

For compound items, option choices may be enforced since the compound item is not completely specified without the enforced or required options. The RO system prevents the customer from completing the selection of the item for immediate order or an ordering preference until the required options have been specified. Selection of certain option choices will evoke the need to specify other option choices. Again, the RO system prevents the customer from completing the selection of the item for immediate order or an ordering preference until the required options have been specified.

When the customer selects certain items from a menu the RO system can suggest complementary items, which the customer may wish to order in addition (for example a drink with a sandwich). The RO system prevents these choices through a variety of UI formats, including, text, graphics and speech. Promotional pricing may be offered on the complementary items, depending on the promotional rules contained in the Store information directory 36.

The RO system may give the customer the option to select substitute items in the event that the merchant does not have stock of the selected items. Substitutions can be applied to an individual item, a compound items, or options for items or compound items. The RO system will present the available substitutions to the customer. Substitutions may be offered at the same price or another price.

The RO system notifies customers when items in ordering preferences are no longer available or have experienced a significant price change. Availability or price changes can apply to store locations, individual items, compound items, and options. The RO system notifies the customer in advance, if possible, or when the order is being placed. The notification can be sent through any of the UI adaptors of the customer access gateway. The notification can be sent while the customer is performing another transaction. Presentation formats, including, 1) a text or email message, 2) an instant message, and 3) a speech dialog. The customer is presented the option of either using a previously selected substitution item or of making a new selection from the store information directory.

1. A remote ordering system for use by at least one customer in placing an order for fulfillment at one of a plurality of affiliated merchants, said merchants operating a plurality of different merchant locations, comprising one or more servers for receiving and processing an order from said customer, said order identifying a specific one of said merchant locations for fulfillment of said order, and for transmitting said order to said specific one of said merchant locations for fulfillment by said specific merchant location.

2. The remote ordering system of claim 1 further comprising a database associated with said one or more servers, said database comprising information specific to each of said merchant locations.

3. The remote ordering system of claim 2 wherein said information is selected from the group comprising: product or service prices, order fulfillment capability criteria, payment criteria.

4. The remote ordering system of claim 2 wherein said information includes product or service prices.

5. The remote ordering system of claim 2 wherein said information includes order fulfillment capability criteria.

6. The remote ordering system of claim 5 wherein said order fulfillment capability criteria comprises times at which specific products are offered.

7. The remote ordering system of claim 5 wherein said order fulfillment capability criteria comprises an identification of times are which specific products are offered and an identification of specific products that are not offered at said merchant location.

8. The remote ordering system of claim 1 wherein:
said system includes information and parameters for operating said system;
each merchant location may modify certain of said information or parameters; and,
a database is associated with said one or more servers, said database comprising information specific to each of said merchant locations identifying levels of authority for personnel of said merchant location for effecting modifications to said information or parameters.

9. The remote ordering system of claim 8 wherein said database further comprises information identifying levels of authority for personnel administering said one or more servers for effecting modifications to said information or parameters.

10. The remote ordering system of claim 8 or claim 9 wherein said information and parameters are selected from the group comprising: product or service price, applicable taxes, promotions, identification of employees, times at which specific products are available, refund processing, payment information, financial information, types of reports.

11. The remote ordering system of claim 9 wherein said information identifying levels of authority is organized according to a schema corresponding to a schema of said merchants locations within said plurality of affiliated merchants.

12. The remote ordering system of claim 2 wherein said information is organized in a hierarchy corresponding to a hierarchy of said merchant locations within said plurality of merchant locations.

13. A remote ordering system comprising:
a plurality of affiliated merchants, said merchants operating a plurality of different merchant locations;
one or more servers for receiving and processing an order from a customer, said order identifying a specific one of said merchant locations for fulfillment of said order, and for transmitting said order to said specific one of said merchant locations for fulfillment by said specific merchant location;
a database associated with said one or more servers, said database comprising information specific to each of said merchant locations, said information being organized in a hierarchy corresponding to a hierarchy of said merchant locations within said plurality of merchant locations.

14. A method for processing a product or service order from a wireless device for fulfillment at a specific outlet location in a chain of associated outlets, comprising:
maintaining a database of products or services offered at each outlet in said chain, said database including information identifying items as being offered by several pluralities of said associated outlets, the characterization of said pluralities corresponding to the organizational structure of said chain of associated outlets; and,
communicating to said wireless device a list of items available at said specific outlet location.

15. The method of claim 14 wherein said database further comprises order fulfillment capability criteria referable to each of said associated outlets, said criteria being selected from the group comprising time of day, products offered.

16. The method of claim 14 or claim 15 wherein said wireless device is a mobile device.

17. A method for processing a product or service order from a wireless device for fulfillment at a specific outlet location in a chain of associated outlets, comprising:
maintaining a database of products or services offered at each outlet in said chain, said database including product or service availability criteria, said criteria being associated with said associated outlets according to each of said associated outlet's relationship with said chain; and,
communicating to said wireless device a list of items available at said specific outlet location.

18. The method of claim 17 wherein said database further comprises order fulfillment capability criteria associated with said associated outlets according to each of said associated outlet's relationship with said chain, said criteria being selected from the group comprising time of day, products offered.

19. The method of claim 17 or claim 18 wherein said wireless device is a mobile device.

20. The method of claim 17 or 18 wherein said criteria is associated in said database with said associated outlets according to a schema corresponding to a schema of said merchant locations within said plurality of merchant locations.

21. A method for processing a product or service order from a wireless device for fulfillment at a specific outlet location in a chain of associated outlets, comprising:
maintaining a centralized database of products or services offered at each outlet in said chain; and,
communicating to said wireless device a list of items available at said specific outlet location.

22. The method of claim 21 wherein said wireless device is a mobile device.

23. The method of claim 14, said database further comprising security information for selectively authorizing certain aspects of the processing of said order, said security information including criteria associated in said database with said associated outlets according to a schema corresponding to a schema of said outlets within said chain of associated outlets.

24. A method for a specific merchant outlet location in a chain of associated outlets to fulfill a product or service order from a mobile customer, comprising:
prior to receiving said order, communicating to a remote ordering system a plurality of criteria governing order fulfillment at said specific outlet location;
receiving said order;
fulfilling said order;
dispatching to said remote ordering system an acknowledgement of fulfillment of said order; and,
said specific outlet location not engaging in the delivery of order fulfillment capability information directly to said customer or in the processing of payment from said customer.
